(19) United States
(12) Patent Application Publication
(10) Pub. No.: US 2017/0182695 A1
(43) Pub. Date: Jun. 29, 2017

(54) APERTURED FILM AND METHOD OF MAKING THE SAME

(71) Applicant: 3M INNOVATIVE PROPERTIES COMPANY, St. Paul, MN (US)

(72) Inventors: Thomas P. Hanschen, Mendota Heights, MN (US); Ronald W. Ausen, St. Paul, MN (US); William J. Kopecky, Hudson, WI (US)

(21) Appl. No.: 15/301,452

(22) PCT Filed: Apr. 3, 2015
(86) PCT No.: PCT/US2015/024259

§ 371 Date: Oct. 3, 2016

Related U.S. Application Data
(60) Provisional application No. 61/974,877, filed on Apr. 3, 2014.
(60) Provisional application No. 61/974,870, filed on Apr. 3, 2014.
(60) Provisional application No. 62/032,246, filed on Aug. 1, 2014.

(51) Int. Cl. B29C 47/00; B01J 20/28; B29C 47/12; B32B 3/26; B32B 5/02; B32B 27/12; C08J 5/18; B01J 20/26

(52) U.S. Cl. CPC B29C 47/0021; C08J 5/18; B01J 20/28033; B01J 20/261; B32B 3/266; B32B 5/022; B32B 27/12; B29C 47/128; B32B 5/024; C08J 2353/02; C08J 2323/12; C08J 2323/14; C08J 2345/00; B32B 2307/4026; B32B 2307/51; B32B 2307/726; B29L 2009/00

(57) ABSTRACT

A film having first and second segments alternating across the film's width direction. The second segments are more elastic than the first segments, and a force required to stretch the second segments is less than a force required to stretch the first segments. At least some of the first segments have apertures through their thicknesses, and a percentage of area of the first segments occupied by the apertures is greater than a percentage of area occupied by any apertures that may extend through the second segments. Laminates and absorbent articles including such films are also disclosed. A method of making the film is also described.

### CROSS-REFERENCE TO RELATED APPLICATIONS

This application claims priority to U.S. Provisional Application Nos. 62/032,246, filed Aug. 1, 2014; 61/974,877, filed Apr. 3, 2014; and 61/974,870, filed Apr. 3, 2014; the disclosures of which are incorporated by reference in their entirety herein.

### BACKGROUND

Co-extrusion of multiple polymeric components into a single film is known in the art. For example, multiple polymeric flow streams have been combined in a die or feedblock in a layered fashion to provide a top to bottom multilayer film. It is also known to provide co-extruded film structures where the film is partitioned, not as coextensive layers in the thickness direction, but as stripes along the width dimension of the film. This has sometimes been called “side-by-side” co-extrusion. Extruded products with side-by-side oriented stripes are described, for example, in U.S. Pat. No. 4,435,141 (Weisner et al.), U.S. Pat. No. 6,159,544 (Liu et al.), U.S. Pat. No. 6,669,887 (Hilston et al.), and U.S. Pat. No. 7,678,316 (Ausen et al.) and Int. Pat. App. Pub. No. WO 2011/119323 (Ausen et al.). Films having multiple segmented flows within a matrix of another polymer are described, for example, in U.S. Pat. No. 5,773,374 (Wood et al.). In some cases, some of the stripes are elastic, and the resulting film is elastic in at least a direction transverse to the stripes.

In other technologies, apertured (e.g., macroporous) films are useful for a variety of applications. Macroporous, apertured films are commonly used for vapor and/or liquid permeable applications and have found use as components in personal hygiene articles (e.g., diapers and feminine hygiene products), filtering, and acoustic applications.

An example of a film having elastic segments side-by-side with inelastic segments, in which the elastic segments have apertures, is described in U.S. Pat. Appl. Pub. No. 2011/0160691 (Ng et al.).

### SUMMARY

Breathable elastic films having liquid barrier properties have long been a desire in the personal hygiene garment industry. Maintaining the liquid barrier properties upon stretching breathable elastic films has inherent difficulties since holes will also increase in area, degrading the barrier properties. The present disclosure provides a film having first and second segments along the film's width generally in a side-by-side fashion. The second segments are more elastic than the first segments and stretch at a lower force than the first segments. Apertures are preferentially formed through the first segments. As a result, when the film is stretched in the film's width direction, the apertures are not substantially stretched, and barrier properties can be maintained.

In one aspect, the present disclosure provides a film having first and second segments arranged along the film's width direction. The second segments are more elastic than the first segments, and a force required to stretch the second segments is less than a force required to stretch the first segments. At least some of the first segments have apertures through their thicknesses, and a percentage of area of the first segments occupied by the apertures is greater than a percentage of area occupied by any apertures that may extend through the second segments. Typically, across at least a portion of the film's width the first and second segments alternate.

In another aspect, the present disclosure provides a laminate including such a film joined to a fibrous carrier.

In another aspect, the present disclosure provides an absorbent article including any of the embodiments of the aforementioned film or laminate.

In another aspect, the present disclosure provides a method of making the film. The method includes providing the film having first and second segments arranged along the film's width direction, in which the second segments are more elastic than the first segments and a force required to stretch the second segments is less than a force required to stretch the first segments, and forming apertures in at least some of the first segments so that a percentage of area of the first segments occupied by the apertures is greater than a percentage of area occupied by any apertures that may extend through the second segments. In some embodiments, apertures are not formed through the second segments.

The film according to and/or made according to the present disclosure has a significant amount of material that is relatively inelastic in combination with elastic material. For example, in some embodiments of any of the aforementioned aspects, the first segments make up a higher volume percentage than the second segments of the film. However, the films still have useful elongations. Therefore, in the films according to the present disclosure, relatively expensive elastic materials are used efficiently, and the films and articles made from them can be lower in cost than other elastic films, which typically include higher amounts of elastic materials.

Furthermore, since a force required to stretch the second segments is less than a force required to stretch the first segments, the apertures typically do not substantially change in shape or size when the film is stretched in a direction transverse to the direction in which the first and second segments extend. Therefore, the difference in moisture vapor transmission rate between a stretched and unstretched film is limited to the difference caused by thinning of the second segments when stretched and is much smaller than the difference in moisture vapor transmission rate of a stretched and unstretched film that has apertures in the elastic segments. This feature allows for more consistent moisture barrier properties when the film is incorporated in an absorbent article, for example.

In this application, terms such as “a”, “an” and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated.

The term “alternating” as used herein refers to one first segment being disposed between any two adjacent second segments (i.e., the second segments have only one first segment between them) and one second segment being disposed between any two adjacent first segments.

The term “aperture” refers to a hole in the film. At least some portion of the aperture, however, typically forms a straight pathway through the entire thickness of the film, which distinguishes these apertures from the tortuous pathways provided in microporous films. Apertures can have a generally tubular shape although this is not a requirement. In some embodiments, apertures may have a dimension (e.g., diameter or largest dimension) in the x-y plane of the film of at least 20, 25, 30, 35, or 40 micrometers. The apertures may have a dimension in the x-y plane of the film as large as the width of the first segments in any of the embodiments described below.

The term “elastic” refers to any material (such as a film that is 0.002 mm to 0.5 mm thick) that exhibits recovery from stretching or deformation. A material, film, or composition that is more elastic than another material, film, or composition exhibits at least one of higher elongation or lower hysteresis (usually both) than another material, film, or composition. In some embodiments, a material may be considered to be elastic if, upon application of a stretching force, it can be stretched to a length that is at least about 25 (in some embodiments, 50) percent greater than its initial length and can recover at least 40 percent of its elongation upon release of the stretching force.

The term “inelastic” refers to any material (such as a film that is 0.002 mm to 0.5 mm thick) that does not exhibit recovery from stretching or deformation to a large extent. For example, an inelastic material that is stretched to a length that is at least about 50 percent greater than its initial length will recover less than about 40, 25, 20, or 10 percent of its elongation upon release of its stretching force. In some embodiments, an inelastic material may be considered to be a flexible plastic that is capable of undergoing permanent plastic deformation if it is stretched past its reversible stretching region.

“Elongation” in terms of percent refers to {(the extended length−the initial length)/the initial length} multiplied by 100. Unless otherwise defined, when a film or portion thereof is said herein to have an elongation of at least 100 percent, it is meant that the film has an elongation to break of at least 100 percent.

The term “extensible” refers to a material that can be extended or elongated in the direction of an applied stretching force without destroying the structure of the material or material fibers. An extensible material may or may not have recovery properties. For example, an elastic material is an extensible material that has recovery properties. In some embodiments, an extensible material may be stretched to a length that is at least about 5, 10, 15, 20, 25, or 50 percent greater than its relaxed length without destroying the structure of the material or material fibers.

The term “machine direction” (MD) as used above and below denotes the direction of a running, continuous web during the manufacturing of the film disclosed herein. When a portion is cut from the continuous web, the machine direction corresponds to the longitudinal direction of the film. Accordingly, the terms machine direction and longitudinal direction may be used herein interchangeably. The term “cross-direction” (CD) as used above and below denotes the direction that is essentially perpendicular to the machine direction. When a portion of the film disclosed herein is cut from the continuous web, the cross-direction corresponds to the width of the film.

The term “incremental stretching” refers to a process of stretching a film, a fibrous material, or a laminate including a film and a fibrous material where the film, fibrous material, or laminate is supported at plural spaced apart locations during elongation, which restricts the elongation to specifically controlled increments of elongation defined by the spacing between support locations.

The terms “first”, “second”, and “third” are used in this disclosure. It will be understood that, unless otherwise noted, those terms are used in their relative sense only. For these components, the designation of “first”, “second”, and “third” may be applied to the components merely as a matter of convenience in the description of one or more of the embodiments.

The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWINGS

The disclosure may be more completely understood in consideration of the following detailed description of various embodiments of the disclosure in connection with the accompanying drawings.

FIG. 1A is a top view of an embodiment of a film according to the present disclosure having apertures in the first segments, wherein the film is in its relaxed state;

FIG. 1B is a top view of the film shown in FIG. 1 while the film is being stretched in the “x” direction and held under tension;

FIG. 2 is an end view of one embodiment of the film having first segments and second segments arranged across the width of the film;

FIG. 3 is an end view of another embodiment of film having first segments and second segments arranged across the width of the film;

FIG. 4 is an end view of another embodiment of film having first segments and second segments arranged across the width of the film;

FIG. 5 is an end view of yet another embodiment of a film having first segments and second segments arranged across the width of the film;

FIG. 6 is an end view of yet another embodiment of a film having first segments and second segments arranged across the width of the film;

FIG. 7 is an end view of yet another embodiment of a film having first segments and second segments arranged across the width of the film;

FIG. 8 is an end view of yet another embodiment of a film having first segments and second segments arranged across the width of the film;

FIG. 9 is an end view of yet another embodiment of a film having first segments and second segments arranged across the width of the film;

FIG. 10A is a plan view of an embodiment of a shim suited to form a sequence of shims capable of forming a film, for example, as shown in the end views of FIGS. 4 to 7;

FIG. 10B is an expanded region near the dispensing surface of the shim shown in FIG. 10A;

FIG. 11A is a plan view of another embodiment of a shim suited to form a sequence of shims capable of forming a film, for example, as shown in the end views of FIGS. 4 to 7;

FIG. 11B is an expanded region near the dispensing surface of the shim shown in FIG. 11A;

FIG. 12A is a plan view of yet another embodiment of a shim suited to form a sequence of shims capable of forming a film, for example, as shown in the end views of FIGS. 4 to 7;

FIG. 12B is an expanded region near the dispensing surface of the shim shown in FIG. 12A;

FIG. 13A is a plan view of yet another embodiment of a shim suited to form a sequence of shims capable of forming a film, for example, as shown in the end views of FIGS. 4 to 7;

FIG. 13B is an expanded region near the dispensing surface of the shim shown in FIG. 13A;

FIG. 14A is a plan view of yet another embodiment of a shim suited to form a sequence of shims capable of forming a film, for example, as shown in the end views of FIGS. 4 to 7;

FIG. 14B is an expanded region near the dispensing surface of the shim shown in FIG. 14A;

FIG. 15 is a perspective assembly drawing of a sequence of shims employing the shims of FIGS. 10A-14A configured to form the film as depicted in FIG. 4;

FIG. 16 is a partially exploded perspective view where a subsequence of shims that forms the layered second segments in FIG. 4, which is shown together in FIG. 15, is shown separated to reveal the individual shims;

FIG. 17 is an exploded perspective view of an example of a mount suitable for an extrusion die composed of multiple repeats of the sequence of shims of FIGS. 15 and 16, FIG. 22A, or FIGS. 27 to 29;

FIG. 18 is a perspective view of the mount of FIG. 17 in an assembled state;

FIG. 19A is a plan view of an embodiment of a shim suited to form a sequence of shims useful for making a film according to the present disclosure in which both the first segments and second segments are layered segments;

FIG. 19B is an expanded region near the dispensing surface of the shim shown in FIG. 19A;

FIG. 20A is a plan view of another embodiment of a shim suited to form a sequence of shims useful for making a film according to the present disclosure in which both the first segments and second segments are layered segments;

FIG. 20B is an expanded region near the dispensing surface of the shim shown in FIG. 20A;

FIG. 21A is a plan view of yet another embodiment of a shim suited to form a sequence of shims useful for making a film according to the present disclosure in which both the first segments and second segments are layered segments;

FIG. 21B is an expanded region near the dispensing surface of the shim shown in FIG. 21A;

FIG. 22A is a perspective drawing of a sequence of shims employing the shims of FIGS. 19A-21A configured to form a portion of a film according to some embodiments of the present disclosure;

FIG. 22B is an expanded region near the dispensing surfaces of the shims shown in FIG. 22A;

FIG. 23A is a plan view of an exemplary shim suited to form a sequence of shims capable of forming a film including stripes in an alternating arrangement with strands having a sheath/core construction as shown in the embodiment of FIG. 8;

FIG. 24A is a plan view of another exemplary shim suited to form a sequence of shims capable of forming a film including stripes in an alternating arrangement with strands having a sheath/core construction as shown in the embodiment of FIG. 8;

FIG. 25A is a plan view of yet another exemplary shim suited to form a sequence of shims capable of forming a film including stripes in an alternating arrangement with strands having a sheath/core construction as shown in the embodiment of FIG. 8;

FIG. 26A is a plan view of yet another exemplary shim suited to form a sequence of shims capable of forming a film including stripes in an alternating arrangement with strands having a sheath/core construction as shown in the embodiment of FIG. 8;

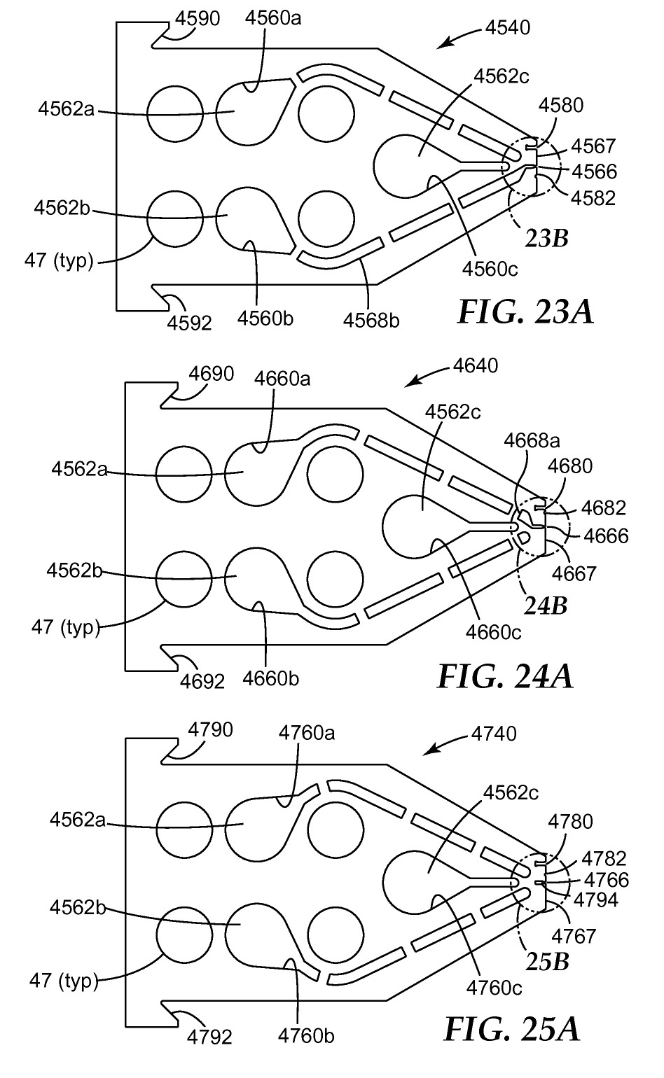

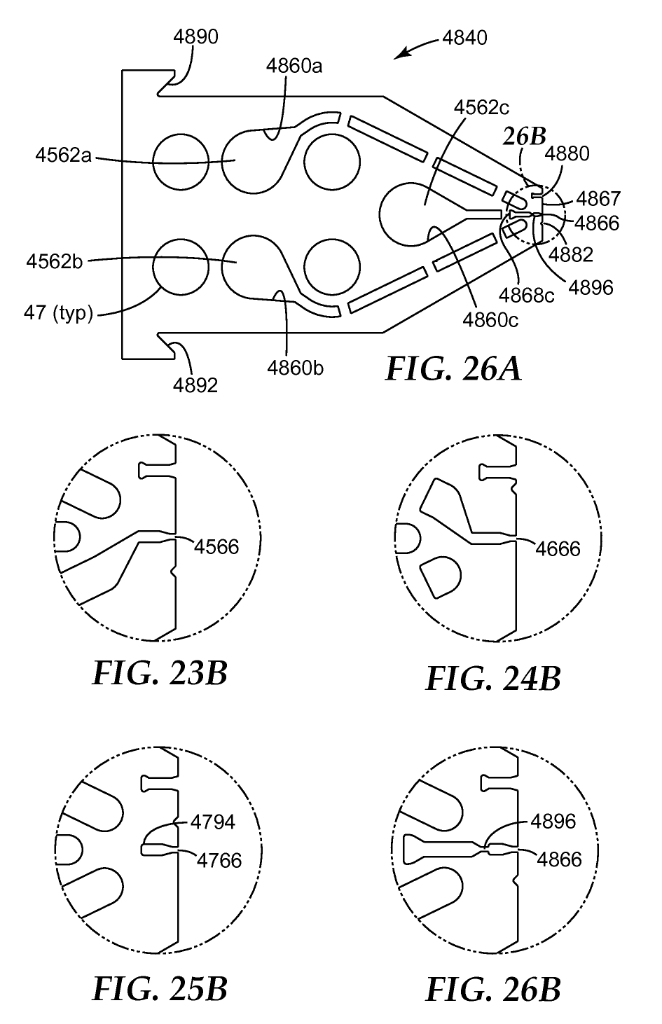

FIGS. 23B through 26B are expanded regions near the dispensing surfaces of exemplary shims shown in FIGS. 23A to 26A, respectively;

FIG. 27 is a perspective assembly drawing of several different sequences of shims employing the shims of FIGS. 23A to 26A so as to be able to produce the film including stripes in an alternating arrangement with strands having a sheath/core construction as shown in the embodiment of FIG. 8;

FIG. 28 is a partially exploded perspective view where the several different sequences of shims shown together in FIG. 27 are shown separated into the sequences that produce the several regions discussed in connection with the film portion of FIG. 8;

FIG. 29 is a perspective view of the some of the sequence of shims of FIG. 28, further exploded to reveal some individual shims; and FIG. 30 is a photomicrograph of an Example of the film according to the present disclosure.

### DETAILED DESCRIPTION

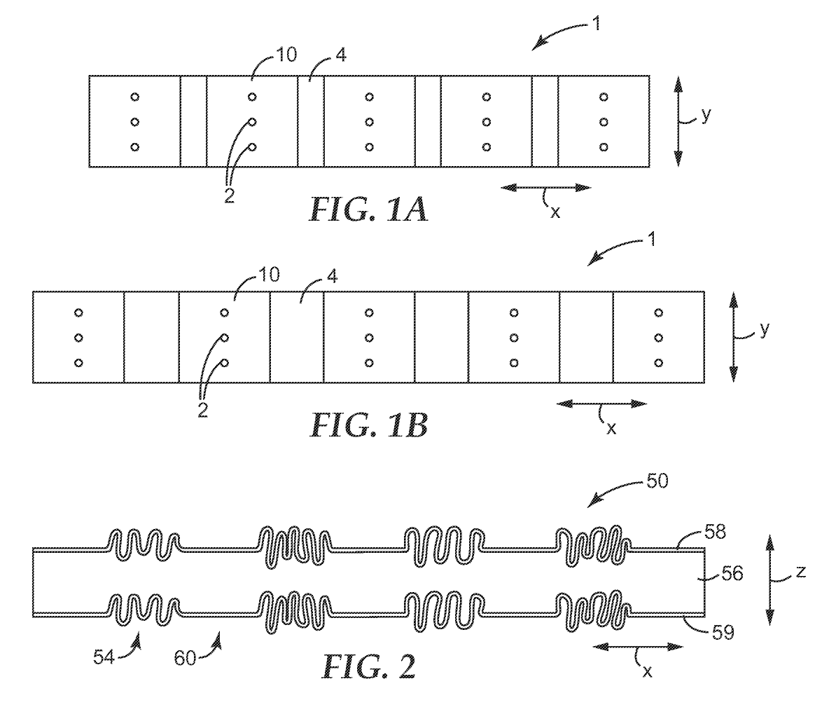

Referring now to FIG. 1, a schematic top view of an embodiment of the film according to the present disclosure is shown. The film 1 includes first segments 10 arranged side-by-side across the width “x” of the film with second segments 4. Typically, first segments 10 and second segments 4 extend in the “y” direction of the film, which is typically the machine direction. Also shown in FIG. 1 are apertures 2, which extend through the entire thickness (perpendicular to the plane of the drawing) of film 1.

The second segments 4 of the film 1 are more elastic than the first segments 10. Therefore, when the film 1 is stretched in the “x” direction as shown in FIG. 2, typically the second segments 4 can be elastically stretched without stretching the first segments 10. Since stretching of the first segments 10 can be minimized or avoided, apertures 2 in the first segments typically do not substantially stretch or change in size or shape.

In the film according to the present disclosure, the percentage of area of the first segments 10 occupied by the apertures therethrough (in other words, percent open area) is greater than the percent open area in the second segments 4. In some embodiments, the percentage of area of the first segments occupied by the apertures is at least 10, 20, 30, 40, 50, 60, 70, 80, 90, or 100 times greater than the percent open in the second segments. In some embodiments, the percentage of area of the second segments 4 occupied by apertures is not more than 1.0, 0.5, 0.25, or 0.1 percent. It is possible and typically desirable that the second segments 4 have no apertures and therefore have no open area.

Apertures can be made in the film by a variety of useful methods including needle-punching (e.g., using heated needles), vacuum forming, die cutting, laser techniques, or other methods to introduce apertures into the film after it is extruded. The film may also be provided with apertures by extruding onto a surface having upstanding structures to form the apertures. The film may also be provided with apertures during lamination as described in further detail, below.

To form apertures selectively in the first segments, the films can be measured to determine where the first segments and second segments are. Optical or manual techniques can be useful for scanning the film and registering the aperturing device with the first segments. In embodiments in which a laser is used, a suitable mask may also be used over the second segments to prevent laser exposure in those segments.

In some embodiments of the method of making the film according to the present disclosure, apertures are formed with a laser. The laser may be any suitable laser operating at an infrared (IR), visible, and/or ultraviolet (UV) output wavelength.

Advantageously, in some embodiments, apertures can be formed selectively in the first segments in films according to the present disclosure by designing the first polymeric composition included in the first segments to have a greater absorbance at a certain wavelength of light than the elastic polymeric composition in the second segments. This allows apertures to be made with a laser without having to identify or specifically target the first segments with the laser. A point cloud array or any laser pattern can be used, and the laser will preferentially form apertures in the first segments.

Matching of laser and material can also be advantageous, for example, when the film to be apertured is a layer with a multilayer construction. Heating with the laser can be adjusted to a location of the film having first segments and second segments with the multilayer construction (e.g., multilayer film) or laminate as described below. For example, it can be advantageous to form apertures in a film disclosed herein when a fibrous layer is positioned between the laser and the film. In these embodiments, the first segments may be designed to have a greater absorbance at the laser's wavelength than the fibrous layer, and the fibrous layer may be selected to be minimally impacted by laser exposure. In some embodiments, the film to be apertured may also be positioned outside of the focal plane of the laser to adjust the level of heating.

Examples of suitable lasers for forming apertures in the first segments of the film include gas lasers, excimer lasers, solid state lasers, and chemical lasers. Examples of gas lasers include: carbon dioxide lasers (for example, those which produce power up to 100 kW at 10.6 micrometers); argon-ion lasers (for example, those which emit light at 458 nanometers (nm), 488 nm or 514.5 nm); carbon-monoxide lasers (for example, those which can produce power of up to 500 kW); and metal ion lasers, which are gas lasers that generate deep ultraviolet wavelengths. Helium-silver (HeAg) 224 nm lasers and neon-copper (NeCu) 248 nm lasers are two examples. These lasers have particularly narrow oscillation linewidths of less than 3 GHz (0.5 picometers).

Chemical lasers are powered by a chemical reaction, and can achieve high powers in continuous operation. For example, in the hydrogen fluoride laser (2700-2900 nm) and the deuterium fluoride laser (3800 nm), the reaction is the combination of hydrogen or deuterium gas with combustion products of ethylene in nitrogen trifluoride.

Excimer lasers are powered by a chemical reaction involving an excited dimer (that is, an “excimer”) which is a short-lived dimeric or heterodimeric molecule formed from two species (atoms), at least one of which is in an excited electronic state. They typically produce ultraviolet light. Commonly used excimer molecules include F₂ (fluorine, emitting at 157 nm), and noble gas compounds (ArF (193 nm), KrCl (222 nm), KrF (248 nm), XeCl (308 nm), and XeF (351 nm)).

Solid state laser materials are commonly made by doping a crystalline solid host with ions that provide the required energy states. Examples include ruby lasers (for example, made from ruby or chromium-doped sapphire). Another useful type is made from neodymium-doped yttrium aluminum garnet (YAG), known as Nd:YAG. Nd:YAG lasers can produce high powers in the infrared spectrum at 1064 nm. Nd:YAG lasers are also commonly frequency doubled to produce 532 nm when a visible (green) coherent source is desired. Ytterbium, holmium, thulium, and erbium are other useful dopants in solid state lasers. Ytterbium is used in crystals such as Yb:YAG, Yb:KGW, Yb:KYW, Yb:SYS, Yb:BOYS, Yb:CaF₂, typically operating around 1020 nm-1050 nm. They are potentially very efficient and high powered due to a small quantum defect. Extremely high powers in ultrashort pulses can be achieved with Yb:YAG. Holmium-doped YAG crystals emit at 2097 nm and form an efficient laser operating at infrared wavelengths strongly absorbed by water-bearing tissues. The Ho-YAG is usually operated in a pulsed mode. Titanium-doped sapphire (Ti:sapphire) produces a highly tunable infrared laser, commonly used for spectroscopy as well as the most common ultrashort pulsed laser. Solid state lasers also include glass or optical fiber hosted lasers, for example, with erbium or ytterbium ions as the active species.

In the embodiments of the method according to the present disclosure in which a laser forms the apertures, the laser may be operated in pulsed and/or continuous wave mode. For example, the laser may operate at least partially in continuous wave mode and/or at least partially in pulsed mode. In some embodiments, the laser operates in pulsed mode. For a person skilled in the art, the suitable power for the laser, beam size on the material, and speed of the beam movement across the material can be adjusted to achieve the desired heating to form apertures.

In some embodiments of the film and method disclosed herein, the first segments absorb light at a selected wavelength to a greater extent than the second segments. The selected wavelength useful for the method and films according to the present disclosure can be any wavelength in a range from 180 nanometers (nm) to 1 millimeter (mm), in some embodiments, 200 nm to 100 micrometers or 200 nm to 11 micrometers. In some embodiments, the laser useful in the method disclosed herein is a UV laser, which, in some embodiments, produces light at one or more wavelengths in a range from 180 nm to 355 nm. In some embodiments, the laser is a 355 nm laser.

The first segments typically comprise a first polymeric composition, and the second segments comprise an elastic polymeric composition that is more elastic than the first polymeric composition. A number of useful additives can be included in the first polymeric composition so that it absorbs the selected wavelength to a greater extent than the elastic polymeric composition. Some useful additives include inorganic compounds such as oxides, hydroxides, sulfides, sulfates, and phosphates of metals such as copper, bismuth, tin, aluminum, zinc, silver, titanium, antimony, manganese, iron, nickel, and chromium and IR absorbing dyes.

In some embodiments, the selected wavelength at which the first segments have a higher absorbance than the second segments is in the UV range, for example, in a range from 180 nm to 355 nm. Examples of useful additives that absorb UV light, which can be added to the first polymeric composition, include titanium dioxide, zinc oxide, antimony trioxide, calcium carbonate, and carbon black. In some embodiments, the first polymeric composition includes at least one of titanium dioxide or calcium carbonate. In some embodiments, the first polymeric composition includes titanium dioxide.

In some embodiments, the selected wavelength at which the first segments have a higher absorbance than the second segments is in the infrared, in a range from about 700 nm to 1 mm, in some embodiments, about 700 nm to 20 micrometers or about 700 nm to 11 micrometers. Examples of useful additives that absorb IR light, which can be added to the first polymeric composition, include infrared-absorbing dyes from the classes of substances of the azo, azomethine, methine, anthraquinone, indanthrone, pyranthrone, flavanthrone, benzanthrone, phthalocyanine, perylene, dioxazine, thioindigo isoindoline, isoindolinone, quinacridone, pyrrolopyrrole or quinophthalone pigments and metal complexes of azo, azomethine or methine dyes or metal salts of azo compounds. Many of these dyes may be useful, for example, when the selected wavelength is about 1 micrometer.

In some embodiments, for example, when it is desirable to use a YAG laser, certain calcined powders of co-precipitated mixed oxides of antimony and tin (e.g., those described in U.S. Pat. No. 6,693,657 (Carroll, Jr., et al.) can be added to the first polymeric composition so that the first segments have a higher absorbance of the laser energy than the second segments.

The first polymeric composition may include any of the additives in any of these embodiments at a higher concentration than the elastic polymeric composition. Or, in some embodiments, the elastic polymeric composition is free of any of these additives. Useful concentrations may be selected such that the first segments have a sufficient absorbance of light at the selected wavelength to reach the damage threshold, and the second segments have an insufficient absorbance of light at the selected wavelength to reach the damage threshold. The damage threshold is the point at which enough energy per unit area in the film has been absorbed to cause damage to the film structure. In some embodiments, the second segments may transmit light at the selected wavelength.

In some embodiments, to provide a segmented film wherein the first segments absorb light at a selected wavelength to a greater extent than the second segments, the first segments can be marked with a substance that absorbs at the selected wavelength. For example, if a carbon dioxide laser is used, and the selected wavelength is in a range from 9 to 11 micrometers, black marker or ink can be applied to the first segments on one or both surfaces of the film.

In some embodiments, to provide a segmented film wherein the first polymeric composition absorbs light at a selected wavelength to a greater extent than the elastic polymeric composition, an additive that is reflective at the selected wavelength can be incorporated into at least a portion of the second segments. For example, if a carbon dioxide laser is used, and the selected wavelength is in a range from 9 to 11 micrometers, silver particles or copper particles can be added to at least a portion of the second segments (e.g., into the elastic polymeric composition or to a skin layer of the second segments which may or may not include the elastic polymeric composition). Reflective particles may be useful in the second segments, for example, whether or not an absorbing additive is included in the first polymeric composition and/or whether or not the first segments are marked with an absorbing substance as described in any of the aforementioned embodiments.

Information regarding forming apertures in the first segments of films having first and second segments can also be found in co-pending U.S. Pat. App. Ser. No. 61/974,870 (Hanschen et al.), filed on Apr. 3, 2014, and incorporated by reference herein in its entirety.

In films according to the present disclosure, a force required to stretch the second segments is less than a force required to stretch the first segments. The force required to stretch the first segments and the second segments can be compared, for example, by measuring the tensile modulus of the first polymeric composition and elastic polymeric composition, respectively. In some embodiments, the tensile modulus (i.e., the initial slope of the stress-strain curve) of the first segments is at least 2, 3, 5, 10, 20, 50, or 100 times the tensile modulus of the second segments. In some embodiments, it is readily visually determined whether the second segments can stretch more readily than the first segments. In some embodiments, the film disclosed herein has an elongation of at least 75 (in some embodiments, at least 100, 200, 250, or 300) percent and up to 1000 (in some embodiments, up to 750 or 500) percent) before plastic deformation of the first segments is observed.

In some embodiments, in films according to the present disclosure the apertures in the first segments do not substantially change in shape or size when the film is stretched in a direction transverse to the direction in which the first and second segments extend. In some embodiments, the phrase “do not substantially change” means that the apertures in the first segments have a first size (that is, a dimension in the x-y plane of the film in the direction of stretching) before stretching and a second size while stretching to 75% elongation, and the second size is less than 10, 9, 8, 7, 6, 5, 4, 3, 2, or 1 percent greater than the first size.

In some embodiments, films according to the present disclosure have a first moisture vapor transmission rate before stretching and a second moisture vapor transmission rate while stretching to 75% elongation, in which the second moisture vapor transmission rate is less than 50, 40, 30, 25, or 20 percent greater than the first moisture vapor transmission rate. When apertures are made in the second segments of the film, which typically stretch, the second moisture vapor transmission rate can be at least 100, 200, 300, 500, or 700 percent greater than the first moisture vapor transmission rate. The moisture vapor transmission rate in the film depends, among other things, the number of apertures that are formed in the film. In some embodiments, films according to the present disclosure have moisture vapor transmission rates of at least 100, 200, 400, 500, 800, or 1000 g/m²/day. Moisture vapor transmission rates can be measured according to the method provided in the Examples, below, or using ASTM E96-80.

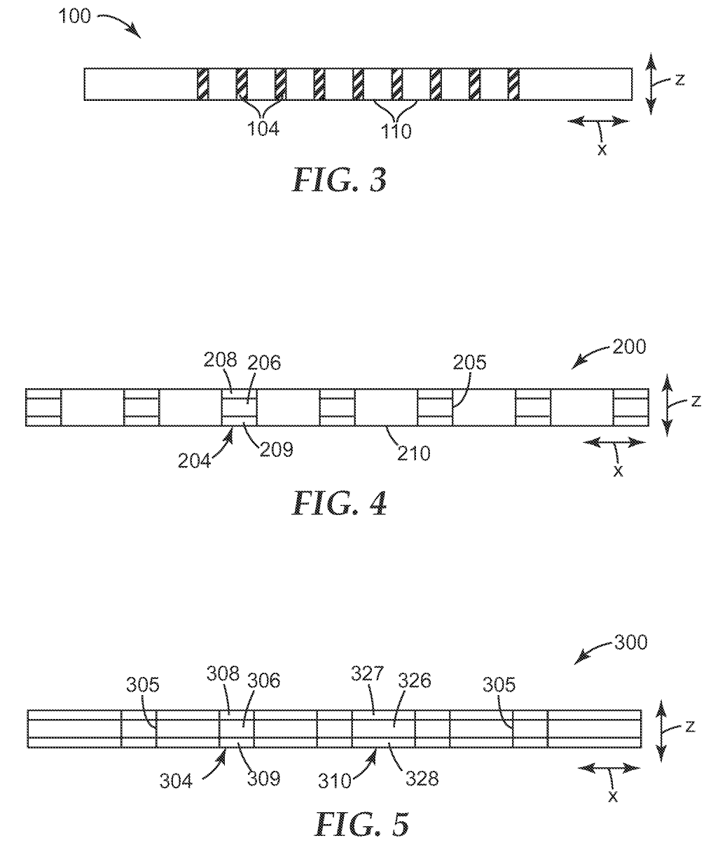

The first segments and second segments in the film according to the present disclosure can have a variety of different structures. An end view of an embodiment of a film 50 according to the present disclosure is shown in FIG. 2. In this view and in all the end views shown in FIGS. 3 to 9, the apertures through thickness “z” of the film are not shown. Film 50 includes elastic layer 56 of an elastic polymeric composition between two skin layers 58, 59 of a first polymeric composition. The elastic polymeric composition is more elastic than the first polymeric composition. Although two skin layers 58, 59 of the first polymeric composition are shown, one on each side of the elastic layer 56 of the elastic polymeric composition, this is not required. In other embodiments in which the film is a multi-layer laminate, the film includes one elastic layer and one relatively less elastic skin layer. Film 50 is incrementally stretched to make the second segments more elastic than the first segments. The incremental stretching process provides second segments 54, which more readily stretch when a force is applied to the ends of film 50, and first segments 60, which less readily stretch. The second segments 54 may appear in film 50 as areas of a greater degree of shining than first segments 60, and the skin layers 58, 59 in the second segments 60 may be thinner than the skin layers 58, 59 in the first segments.

An end view of another embodiment of a film according to the present disclosure is shown in FIG. 3. In this view, the apertures through thickness “z” of the film are not shown. Film 100 has first segments 110 and second segments 104 in the form of alternating side-by-side stripes of a first polymeric composition and elastic polymeric composition, respectively, wherein the elastic polymeric composition is more elastic than the first polymeric composition. In illustrated film 100, the first segments 110 and second segments 104 are each of generally uniform composition. In other words, the first polymeric composition in first segments 110 extends from the top major surface, through the thickness, and to the bottom major surface of the film, and the elastic polymeric composition in second segments 104 extends from the top major surface, through the thickness, and to the bottom major surface of the film. However, in other embodiments, there may be skin layers (not shown) on at least one of the top or bottom major surfaces (e.g., both top and bottom surfaces) of the film. The skin layers may be formed of the first or elastic polymeric compositions or another, different composition, for example.

FIG. 4 illustrates an end view of another embodiment of a film 200 having first and second segments across its width “x” direction. Film 200 includes first segments 210 arranged side-by-side across the width of the film with second segments 204. In the illustrated embodiment, every second segment is a layered second segment 204. However, this is not necessarily required. In other embodiments, only some (e.g., every other) second segments may be a layered second segment 204. The layered second segments 204 in film 200 include at least three layers in the film's thickness direction “z”. The first layer 206 is a middle layer of the elastic polymeric composition disposed between the second layer 208 and a third layer 209 at opposite surfaces of the film. In some embodiments, including the illustrated embodiment, the middle, first layer 206 does not form part of the surface of the film, and neither second 208 nor third layer 209 extends through the thickness “z” of a given layered second segment. The second layer 208 includes the third polymeric composition, and the third layer 209 includes a fourth polymeric composition. The third and fourth polymeric compositions are generally both different from the elastic polymeric composition, but they may be the same as or different from each other. In some embodiments, at least one of the third or fourth polymeric compositions is the same as the first polymeric composition. In some of these embodiments, both the third and fourth polymeric compositions are the same as the first polymeric composition in first segments 210. In other embodiments, the third polymeric composition in second layer 208 is the same as the first polymeric composition, but the fourth polymeric composition in third layer 209 is different from the first polymeric composition. In some embodiments, the third and fourth polymeric compositions in second and third layers 208 and 209 are the same as each other but different from the first polymeric composition. In other embodiments, each of the first, elastic, third, and fourth polymeric compositions in first segments 210 and first, second, and third layers 206, 208, and 209, respectively, is different.

In the embodiment illustrated in FIG. 4, the first polymeric composition extends throughout the thickness “z” of the first segments 210. In other words, the first polymeric composition extends from the first major surface of the film, through the thickness “z”, and to the second major surface of the film. It may be said that the first segments 210 are generally of uniform composition and that the first segments 210 are not layered segments or multi-layered in the thickness “z” direction.

FIG. 5 illustrates an end view of another embodiment of a film 300 having different segments across its width “x” direction. The embodiment shown in FIG. 5 is similar to the embodiment shown in FIG. 4 in that the second segments 304 include a middle first layer 306 and second and third layers 308 and 309 on opposing surfaces of the film. However, the first segments 310 in FIG. 5 are different from the first segments 210 shown in FIG. 4. At least some of the first segments 310 are layered first segments that include at least fourth and fifth layers 326 and 327, respectively, in the film's thickness “z” direction. One of the fourth or fifth layers 326 and 327 includes a fifth polymeric composition different from the first polymeric composition. In the illustrated embodiment, fourth layer 326 is a middle layer of the first polymeric composition disposed between fifth and sixth layers 327 and 328 on opposing surfaces of the film. In some embodiments, including the illustrated embodiment, the middle, fourth layer 326 does not form part of the surface of the film. The fifth layer 327 includes a fifth polymeric composition, and the sixth layer 328 includes a sixth polymeric composition. The fifth and sixth polymeric compositions are generally both different from the first polymeric composition, but they may be the same as or different from each other. The fifth polymeric composition in the fifth layer 327 is also different from the third polymeric composition in the second layer 308, and the sixth polymeric composition in the sixth layer 328 is different from the fourth polymeric composition in the third layer 309 in the illustrated embodiment. In some embodiments, each of the first, elastic, third, fourth, fifth, and sixth polymeric compositions in fourth, first, second, third, fifth, and sixth layers 326, 306, 308, 309, 327, and 328, respectively, is different. In the embodiment illustrated in FIG. 5, none of the first, fifth, or sixth polymeric composition, when present, extends through the thickness “z” of a given layered first segment.

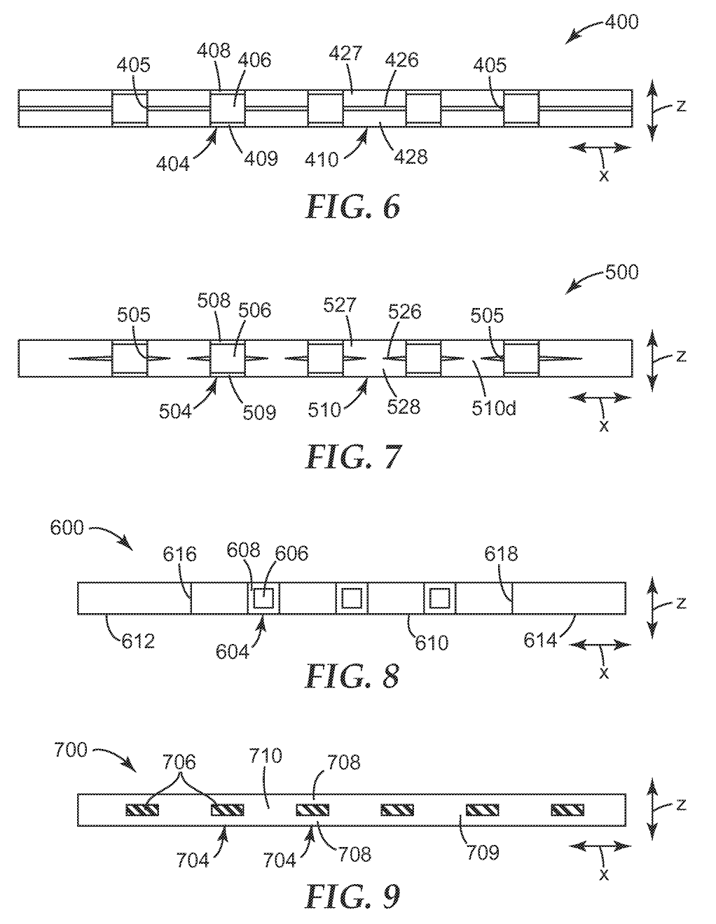

Other embodiments of films 400, 500 according to the present disclosure are shown in FIGS. 6 and 7. The embodiments shown in FIGS. 6 and 7 are similar to the embodiment shown in FIG. 5 in that at least some of the first segments 410, 510 are layered first segments that include fourth, fifth, and sixth layers 426; 526, 427; 527, 428; 528, respectively, in the film's thickness “z” direction. Fourth layer 426, 526 is a middle layer disposed between fifth and sixth layers 427, 527 and 428, 528 on opposing surfaces of the film. In the illustrated embodiments, the middle, fourth layer 426, 526 does not form part of the surface of the film. At least one of the fifth layer 427, 527 or the sixth layer 428, 528 includes the first polymeric composition, but they may have the same or different compositions. The polymeric composition in the fifth layer 427, 527 may be the same or different from the third polymeric composition in the second layer 408, 508, and the polymeric composition in the sixth layer 428, 528 may be the same or different from the fourth polymeric composition in the third layer 409, 509. The fourth layer 426, 526 has a smaller thickness than both fifth layer 427, 527 and the sixth layer 428, 528. For example, the fourth layer 426, 526 has thickness of up to 30 (in some embodiments, up to 25, 20, 15, or 10) percent of the thickness of either the fifth layer 427, 527 or the sixth layer 428, 428. Also, the fourth layer 426, 526 has a smaller thickness than the first layer 406, 506 and may have a thickness of up to 30 (in some embodiments, up to 25, 20, 15, or 10) percent of the thickness of the first layer 406, 506. In these embodiments, it may be useful for the polymeric composition in fourth layer 426, 526 to be the same as the elastic polymeric composition in first layer 406, 506, or it may be similar enough to the elastic polymeric composition to be highly compatible. In either of these embodiments, polymeric compositions in the first layer 406, 506 and fourth layer 426, 526 may be more elastic than any one of the first, third, or fourth polymeric compositions or any of the polymeric compositions in the second, third, fifth, and sixth layers: 408, 508, 409, 509, 427, 527, and 428, 528.

Typically, in the embodiments illustrated in FIGS. 4 to 7, the first and second segments are separated by polymer interfaces 205, 305, 405, and 505. In FIG. 4, even when the first polymeric composition in the first segments 210 is the same or very similar the third and fourth polymeric compositions in second and third layers 208, 209, there may still be a polymer interface separating the first segments 210 from the second or third layers 208, 209. Similarly, in FIGS. 6 and 7, even when the polymeric composition in the fourth layer is the same as or very similar to the elastic polymeric composition in the first layer, there still may be a polymer interface 405, 505 separating the second segments from the fourth layer. Such interfaces may be visible (e.g., either to the naked eye or under magnification), particularly upon stretching the film in the width direction, depending on the loading of pigment or other factors.

In the embodiments shown in FIGS. 6 and 7, the compatibility between first and fourth layers 406, 506 and 426, 526 can significantly improve (e.g., by up to an order of magnitude or more) the elastic elongation dwell time compared to a film that has first segments that are not layered segments (as shown in FIG. 4) when evaluated according to the following method. A strip of film is cut with a razor blade to measure 2.54 cm wide in the cross direction of the film and approximately 5 cm long. The first end of the film strip is attached to the lab bench using ordinary masking tape with the masking tape applied over the film and extending past the first end of the film. A second piece of masking tape is then applied over the second end of the film strip, parallel to the first tape, with 2.54 cm of exposed film between parallel strips of masking tape. The 2.54-cm exposed film is extended to 5 cm and then the masking tape is used to attach the second end of the film strip to the lab bench. The test time is started at 0. The test sample is monitored, and when the film strip breaks, the time is recorded. The time is the elastic elongation dwell time. The evaluation is performed at approximately 23° C.

The embodiments shown in FIGS. 6 and 7 differ in that in the embodiment shown in FIG. 6, the first segments 410 and second segments 404 alternate across the film's width, and the fourth layer 426 is continuous across the width of the first segments 410. There are also no non-layered segments across the width of the film. In the embodiment shown in FIG. 7, it may be considered that there is a region 510d that is not a layered segment. That is, it has the same composition extending from one major surface of the film to the other. Region 510d can be considered to be arranged within a first segment 510 to separate two layered portions of the first segment 510, or first segment 510 may be considered to be three segments: two layered segments separated by a non-layered segment. Film 500 may also be considered an arrangement of first and second segments 510, 504 that alternate across the film's width, wherein the fourth layers 526 are not continuous across the width of the first segments 510.

In the embodiments illustrated in FIGS. 4 to 7, none of the polymeric compositions in the second, third, fourth, fifth, and sixth layers separates the first and elastic polymeric compositions in the first and second segments.

Another embodiment of a film according to the present disclosure is shown as an end view in FIG. 8. Like the embodiments shown in FIGS. 3 to 7, film 600 has alternating first segments 610 and second segments 604. However, in film 600, the second segments 604 are strands comprising a core 606 and a sheath 608, wherein the core is more elastic than the sheath. In this embodiment and any other of the aforementioned embodiments of the film according to the present disclosure, optionally, ribbon regions 612 and 614 may be present on one or both edges of the film 600. When ribbon regions 612 and/or 614 are present, weld lines 616 and 618 may or may not be visible. In some embodiments, the ribbon region 612 and/or 614 can provide a large, non-stretchable area for laminating the film to the fibrous web or other components of a final article (e.g., an absorbent article) or for holding the laminate along its edges during a stretching process. In some embodiments in which second segments are strands comprising a core and a sheath, ribbon regions 612 and 614 and transition regions 616 and 618 are absent. In many embodiments, first segments 610 comprise the first polymeric composition, cores 606 comprise the elastic polymeric composition, and sheaths 608 comprise a third polymeric composition. However, in some embodiments, both the first segments 610 and the sheaths 608 may have the same polymeric composition. In some embodiments, the sheath 608 may serve as a tie layer between the core 606 and the first segments 610. In film 600, the first segments 610 are generally of uniform composition. In other words, the first polymeric composition in the first segments 610 extends from the top major surface, through the thickness, and to the bottom major surface of the film. However, in other embodiments, first segments 610 may also have a core/sheath structure.

In film 600 shown in FIG. 8, sheath 608 surrounds core 606. In other words, the sheath 608 extends around the entire outer surface of core 606, which, in the end view of FIG. 8, is represented by the perimeter of core 606. However, the sheath 608 need not completely surround core 606. In some embodiments, the sheath extends around at least 60, 75, or 80 percent of the outer surface of core 606, which, in the end view of FIG. 8, is represented by the perimeter of core 606. For example, the sheath 608 may separate core 606 and first segments 610 on either side of core 606 and extend around to partially cover the core 606 at the top and bottom surfaces of film 600 without completely covering the core 606 at the top and bottom surfaces of the film. In many embodiments, the sheath 608 forms part of at least one major surface of the film.

Another embodiment of film according to the present disclosure is shown as an end view in FIG. 9. Like the embodiments shown in FIGS. 3 to 8, film 700 has alternating first segments 710 and second segments 704. However, in laminate 700, the second segments 704 include strands 706 of the elastic polymeric composition embedded in a matrix 709. The matrix includes skin regions 708 and first segments 710 that are continuous and made from the first polymeric composition. The skin regions 708 are present on either side of the strand 706 and are typically stretched beyond their elastic limit when the laminate is extended in the cross direction CD. Therefore, skin regions 708 typically have a microstructure (not shown) in the form of peak and valley irregularities or folds, the details of which may not be able to be seen without magnification.

In many embodiments of the film according to the present disclosure, including the embodiments shown in FIGS. 4 to 9, the second segments 204, 304, 404, 504, 604, and 704 are not uniform throughout the thickness of the segments. They each have a layer (e.g., 208, 308, 408, 508), a sheath 608, or a skin region 708 that forms at least one surface of the second segments. This layer, sheath, or skin region may have the same or different polymeric composition as the first polymeric composition and is desirably less tacky than the elastic polymeric composition. If the layer, sheath, or skin region has the same composition as the first polymeric composition, and the first polymeric composition includes an additive that absorbs at the selected wavelength, it is possible that apertures will form through that layer, sheath, or skin upon exposure to the laser but not form through the entire second segments because of the lower absorbance of the elastic polymeric composition at the selected wavelength. Advantageously, in the embodiments shown in FIGS. 4 to 8, the layer (e.g., 208, 308, 408, 508) or sheath 608 can include a polymeric composition different from the first and elastic polymeric composition. The layer or sheath composition can be formulated to not include an additive that absorbs at the selected wavelength and/or to include an additive that reflects at the selected wavelength. The layer or sheath may optionally include a mixture of the first polymeric composition and the elastic polymeric composition and therefore would have a lower concentration of any absorbing additive that may be in the first polymeric composition but not in the elastic polymeric composition. The layer or sheath in the second segments may advantageously be less tacky than the elastic polymeric composition and softer than the first polymeric composition. When the layer or sheath that is softer than the first polymeric composition is exposed on at least one of the major surfaces of the film disclosed herein, the force required to initially stretch the film in the direction transverse to the direction in which the first and second segments extend may be less than when elastic strands are totally encompassed within a relatively inelastic matrix (e.g., as in the embodiment illustrated in FIG. 9).

For any of the films 1, 100, 200, 300, 400, 500, 600, 700, each of the first polymeric composition and elastic polymeric composition is monolithic (that is, having a generally uniform composition) and would not be considered fibrous. Also, the layers (e.g., 208, 308, 408, 508), sheaths 608, and skin regions 708 would not be considered nonwoven materials. Generally, the first and second segments are co-extruded and melt bonded together. Furthermore, in any of the embodiments of films disclosed herein, the first and second segments are in the same layer in the thickness direction. That is, the first and second segments may be considered to occupy the same plane, or any imaginary line drawn through the film from one longitudinal edge to the opposite longitudinal edge would touch both the first and second segments. The films themselves are typically extruded as single-layer in the thickness direction although this is not a requirement.

Films comprising alternating first and second segments useful as apertured films according to the present disclosure can be made in a variety of ways. For example, a multi-layer film laminate 50 such as that shown in FIG. 3 can be made by extrusion from a conventional multi-layer die using multilayer feedblocks or combining adapters as described in U.S. Pat. Nos. 4,152,387 and 4,197,069 (both to Cloeren). For example, an ABC three layer coextrusion feedblock available from Cloeren Co., Orange, Tex., can be useful for extruding the film shown in FIG. 3. Methods of incremental stretching to provide first and second segments 60, 54 are described in more detail below in connection with laminates of the films according to the present disclosure. Other methods for selective or preferential activation of certain zones in a multilayer film are described, for example, in U.S. Pat. No. 5,344,691 (Hanschen et al.).

A film 100 comprising alternating first and second segments useful for practicing the present disclosure such as that shown in FIG. 3 can be made by side-by-side co-extrusion using any one of a number of useful methods. For example, U.S. Pat. No. 4,435,141 (Weisner et al.) describes a die with die bars for making a multi-component film having alternating segments in the film cross-direction. A die bar, or bars, at the exit region of the die segments gives two polymer flows using channels formed on the two outer faces of the die bar. The two sets of segmented polymer flows within these channels converge at a tip of the die bar where the two die bar faces meet. The segmented polymer flows are arranged so that when the two segmented polymer flows converge at the bar tip, they form films that have alternating side-by-side zones of polymers. A similar process that further includes co-extruding a continuous outer skin layer on one or both outer faces of the side-by-side co-extruded film as described in U.S. Pat. No. 6,669,887 (Hilston et al.) may also be useful.

In some embodiments, management of the flow of different polymer compositions into side-by-side lanes to form a film such as film 100 can be carried out using a single manifold die with a distribution plate such as that described in, for example, in U.S. Pat. Appl. Pub. No. 2012/0308755 (Gorman et al.), incorporated by reference herein in its entirety. In some of these embodiments, the die comprises a first die cavity in a first die portion, a second die cavity in a second die portion, a distribution plate interposed between at least a portion (e.g., most or all) of the first die cavity and at least a portion (e.g., most or all) of the second die cavity. The distribution plate has a first side forming a boundary of the first die cavity, a second side forming a boundary of the second die cavity, a dispensing edge, a plurality of first extrusion channels, and a plurality of second extrusion channels. The first extrusion channels extend from entrance openings at the first die cavity to exit openings on the dispensing edge, and the second extrusion channels extend from entrance openings at the second die cavity to exit openings on the dispensing edge. The exit openings of the first extrusion channels and the exit openings of the second extrusion channels are disposed in alternating positions along the dispensing edge. Each of the first extrusion channels comprises two opposite side walls and a joining surface connecting the two opposite side walls, and the joining surface of at least some of the first extrusion channels is typically substantially parallel to the first side of the distribution plate.

Films comprising alternating first and second segments useful for practicing the present disclosure such as film 100 shown in FIG. 3 can also be made by other extrusion dies that comprise a plurality of shims and have two cavities for molten polymer, such as those dies described, for example, in Int. Pat. App. Pub. No. WO 2011/119323 (Ausen et al.), incorporated herein by reference in its entirety. The plurality of shims positioned adjacent to one another together define first cavity, a second cavity, and a die slot, wherein the die slot has a distal opening wherein each of the plurality of shims defines a portion of the distal opening. At least a first one of the shims provides a passageway between the first cavity and the die slot, and at least a second one of the shims provides a passageway between the second cavity and the die slot. Typically, at least one of the shims is a spacer shim providing no conduit between either the first or the second cavity and the die slot.

Other side-by-side coextrusion techniques that may be useful for providing a film 100 such as that shown in FIG. 3 include those described in U.S. Pat. No. 6,159,544 (Liu et al.) and U.S. Pat. No. 7,678,316 (Ausen et al.).

Films comprising alternating first and second segments useful as apertured films according to the present disclosure, such as the films illustrated in FIGS. 4 to 8, can be conveniently prepared by extrusion from a die having a variety of fluid passageways from cavities within the die to a dispensing slot. The dispensing slot has a width, which is the dimension that corresponds to the width “x” of the resulting extruded film, and a thickness, which is the dimension that corresponds to the thickness “z” of the resulting extruded film. The fluid passageways are capable of physically separating the polymers from the first and second cavities and optionally any further die cavities within the extrusion die until the fluid passageways enter the dispensing slot. The shape of the different passageways within the die may be identical or different. Examples of passageway cross-sectional shapes include round, square, and rectangular shapes.

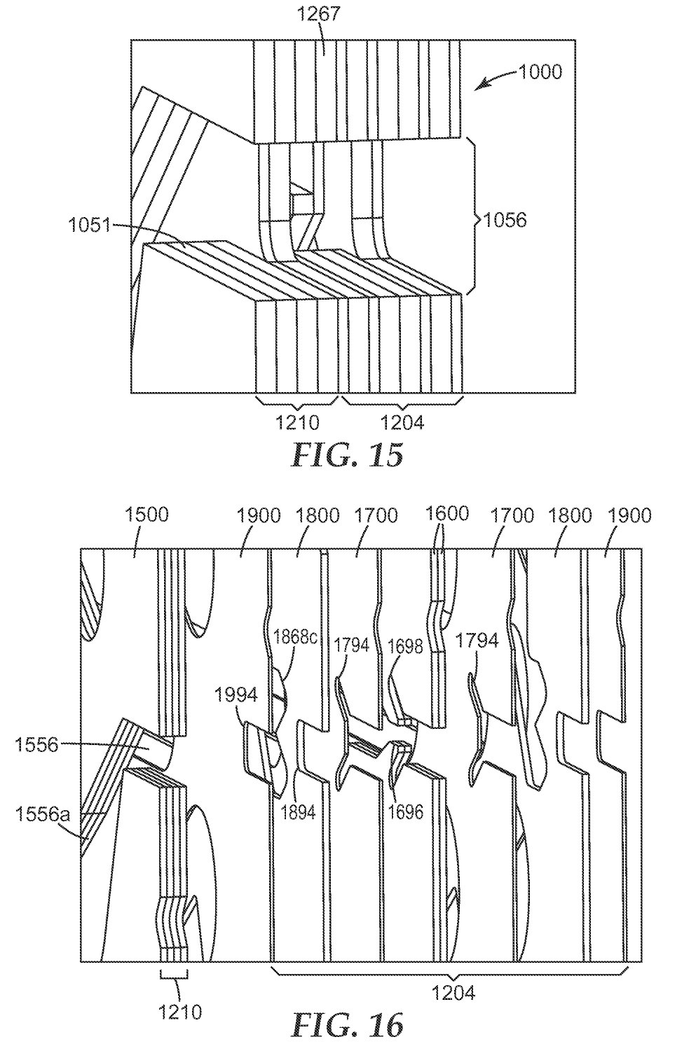

The die may conveniently be comprised of a plurality of shims. The shims can include at least one first shim that provides a first fluid passageway and at least one second shim that provides a second fluid passageway from cavities within the die to the dispensing slot. The shim that provides the second fluid passageway may also provide at least one third fluid passageway. Each of the shims in the plurality of shims typically defines a portion of the dispensing slot. In some embodiments, the plurality of shims comprises a plurality of sequences of shims that includes shims where each sequence provides at least first and second fluid passageways between a first and a second cavity and the dispensing slot. In some of these embodiments, there will be additional shims that provide a passageway between a third (fourth, fifth, sixth, etc.) cavity and the dispensing slot. A subsequence of shims can form a layered second segment, which is bonded to a first segment on one or both sides. Some examples of useful shim sequences and subsequences will be discussed with more particularity below in connection with FIGS. 15, 16, 22A, and 22B.

In some embodiments, the shims will be assembled according to a plan that provides a sequence of shims of diverse types. Since different applications may have different requirements, the sequences can have diverse numbers of shims. The sequence may be a repeating sequence that is not limited to a particular number of repeats in a particular zone. Or the sequence may not regularly repeat, but different sequences of shims may be used. In one embodiment, a twelve-shim sequence that when properly provided with molten polymer forms a segment of film of a single-material alternating with a layered segment such as film 200 illustrated in FIG. 4 is described below in connection with FIGS. 15 and 16.

In some embodiments, the shims that provide a passageway between one cavity and the dispensing slot might have a flow restriction compared to the shims that provide a passageway between another cavity and the dispensing slot. The width of the distal opening within, for example, different shims of the sequence of shims, may be identical or different. For example, the portion of the dispensing opening provided by the shims that provide a passageway between one cavity and the dispensing slot could be narrower than the portion of the dispensing opening provided by the shims that provide a passageway between another cavity and the dispensing slot.

In some embodiments, extrusion dies described herein include a pair of end blocks for supporting the plurality of shims. In these embodiments it may be convenient for one or all of the shims to each have one or more through-holes for the passage of connectors between the pair of end blocks. Bolts disposed within such through-holes are one convenient approach for assembling the shims to the end blocks although the ordinary artisan may perceive other alternatives for assembling the extrusion die. In some embodiments, the at least one end block has an inlet port for introduction of fluid material into one or more of the cavities.

In some embodiments, the assembled shims (conveniently bolted between the end blocks) further comprise a manifold body for supporting the shims. The manifold body has at least one (or more (e.g., two or three, four, or more)) manifold therein, the manifold having an outlet. An expansion seal (e.g., made of copper or alloys thereof) is disposed so as to seal the manifold body and the shims, such that the expansion seal defines a portion of at least one of the cavities (in some embodiments, a portion of the first, second, and third cavities), and such that the expansion seal allows a conduit between the manifold and the cavity.

In some embodiments, the shims for dies described herein have thicknesses (in the narrowest dimension of the shim) in the range from 50 micrometers to 500 micrometers. Typically, the fluid passageways have dimension in the width direction of the extrusion die in a range from 50 micrometers to 750 micrometers, and heights corresponding to the thickness dimension of the film of less than 5 mm (with generally a preference for smaller heights for decreasingly smaller passageway widths), although widths and heights outside of these ranges may also be useful. In some embodiments, the fluid passageways can have heights in a range from 10 micrometers to 1.5 millimeters. For fluid passageways with large widths or diameters, several smaller thickness shims may be stacked together, or single shims of the desired passageway width may be used. Widths of first and second slot segments (described below for making first and second film segments) can correspond to the widths of the fluid passageways described above. The first and second slot segments may have widths within 10 percent of the widths of the fluid passageways.

The shims are tightly compressed to prevent gaps between the shims and polymer leakage. For example, 12 mm (0.5 inch) diameter bolts are typically used and tightened, at the extrusion temperature, to their recommended torque rating. It may be desirable to press the shims together with force while tightening the bolts. Also, the shims are aligned to provide uniform extrusion out the dispensing slot, as misalignment can lead to first and second segments extruding at an angle out of the die which may inhibit bonding between these segments. To aid in alignment, an indexing groove can be cut into the shims to receive a key. Also, a vibrating table can be useful to provide a smooth surface alignment of the extrusion tip.

The size of the various segments and layers in the film can be adjusted, for example, by the composition of the extruded polymers (e.g., materials, melt viscosities, additives, and molecular weight), pressure in the cavities, flow rate of the polymer stream, and/or the dimensions of the passageways.

In preparing the films described herein, the polymeric compositions might be solidified simply by cooling. This can be conveniently accomplished by, for example, quenching the extruded film or article on a chilled surface (e.g., a chilled roll). In some embodiments, it is desirable to maximize the time to quenching to increase the weld line strength.

The extrusion die useful for making a film such as that shown in FIGS. 3 to 7, for example, includes a first fluid passageway that extends from a first cavity to a first slot segment of the dispensing slot and a second fluid passageway that extends from a second cavity to a second slot segment of the dispensing slot. The first and second slot segments are arranged side-by-side along the width of the dispensing slot and have a combined width. A third fluid passageway within the extrusion die extends from a die cavity within the extrusion die to the second slot segment and meets the second fluid passageway from an area above the second fluid passageway at a point where the second fluid passageway enters the dispensing slot. That is, at least a portion of the third fluid passageway is on top of the second fluid passageway in the thickness direction at the point where the second fluid passageway enters the dispensing slot. In some embodiments, upstream from the dispensing slot, the third fluid passageway is diverted into branches that meet the second fluid passageway at areas above and below the second fluid passageways at the point where the second fluid passageway enters the dispensing slot. The die cavity where the third fluid passageways begin may be the same cavity as the first cavity, or a third, different cavity may be useful depending on the desired construction of the film.

In many embodiments, there are multiple first slot segments and multiple second slot segments arranged along the width of the dispensing slot. In some of these embodiments, the first and second slot segments alternate such that one first slot segment is disposed between any two adjacent second slot segments. Similarly, one second slot segment can be disposed between any two adjacent first slot segments. It should be understood that for multiple first slot segments, each is fed by a first passageway that extends from the same first cavity. Likewise, for multiple second slot segments, each is fed by a second passageway that extends from the same second cavity and a third passageway that extends from the same die cavity within the extrusion die. Although the second slot segments allow for polymeric compositions, one from the second cavity and one from the die cavity to which the third fluid passageways are connected, to be layered in the thickness “z” direction, the second slot segments are not further divided in the width “x” direction. That is, multiple fluid passageways do not enter the second slot segments of the dispensing slot in a side-by-side arrangement. Accordingly, the layered second segments of the film extruded from the second slot segments are uniform in composition across their widths.

The combined width of the first and second slot segments should be understood to be the width of the first slot segment added to the width of the second slot segment. The width of the third fluid passageway at a point where it meets the second fluid passageway is less than the combined width of the first and second slot segments. The third fluid passageway is therefore generally distinguishable from a fluid passageway that extends across the width of the dispensing slot to provide, for example, a continuous skin layer of generally uniform composition on top of a side-by-side coextruded film. In some embodiments, the width of the third fluid passageway at a point where it meets the second fluid passageway is about the same as the width of the second slot segments.

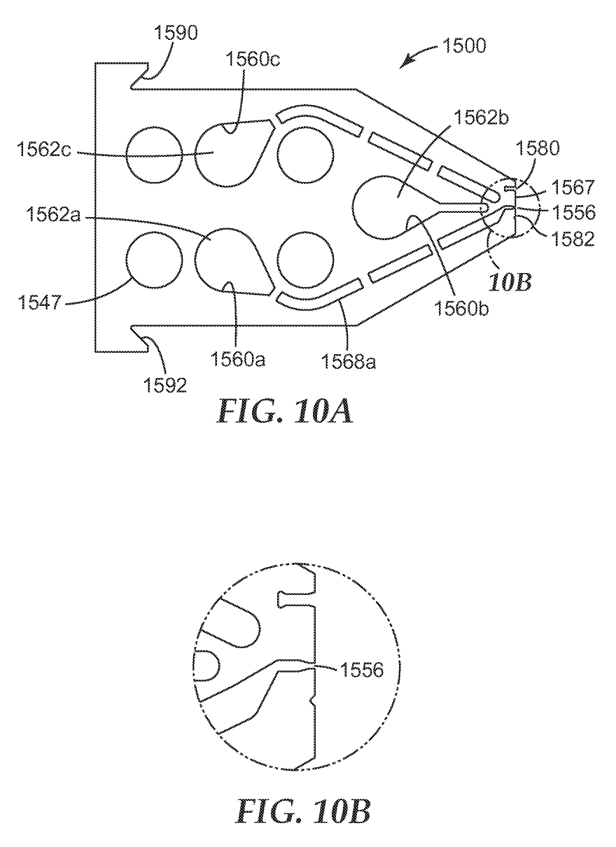

A plurality of shims that is useful for providing a layered second segment in which layers on the first and second major surfaces are fed from the same cavity is shown in FIGS. 10A to 14A. These shims are useful, for example, for providing a film 200 such as that shown in FIG. 4. Such sequences can include shims that provide a second fluid passageway between a second cavity and the dispensing slot, shims that provide a third fluid passageway extending from another cavity within the die along either longitudinal side of the second fluid passageway. In the illustrated embodiment, the polymer in the third fluid passageway does not enter the dispensing slot alongside the second fluid passageway. Instead, upstream from the dispensing slot, the third fluid passageway and the polymer within is diverted into branches that meet the second fluid passageway at areas above and below the second fluid passageway at the point where the second fluid passageway enters the dispensing slot. That is, the third fluid passageway turns in the cross-web or cross-die direction upstream from the dispensing slot. While flow of the polymeric composition from the third fluid passageway alongside the polymeric composition from the second fluid passageway is prevented in the dispensing slot, the branches redirect the polymeric composition from the third fluid passageway to above and below the polymeric composition entering the dispensing slot from the second passageway.

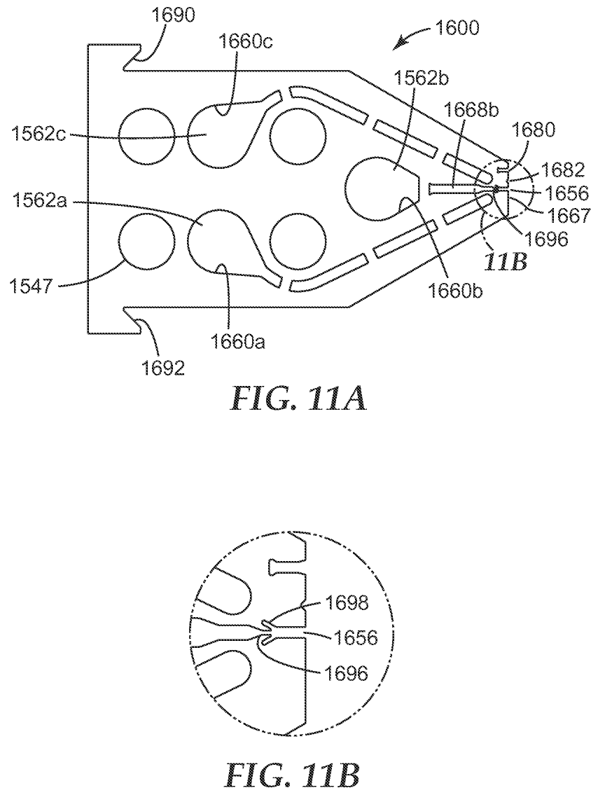

Referring now to FIG. 10A, a plan view of shim 1500 is illustrated. Shim 1500 is useful in a sequence of shims shown in FIGS. 15 and 16. Other shims useful in this sequence are shown in FIGS. 11A to 14A. Shim 1500 has first aperture, 1560a, second aperture 1560b, and third aperture 1560c. When shim 1500 is assembled with others as shown in FIGS. 15 and 16, aperture 1560a will help define first cavity 1562a, aperture 1560b will help define second cavity 1562b, and aperture 1560c will help define third cavity 1562c. As will be discussed with more particularity below, molten polymer in cavities 1562b and 1562c can be extruded in layered second segments, and molten polymer in cavity 1562a can be extruded as a first segment between those layered second segments so as to form a portion of the film, for example, illustrated in FIG. 4.

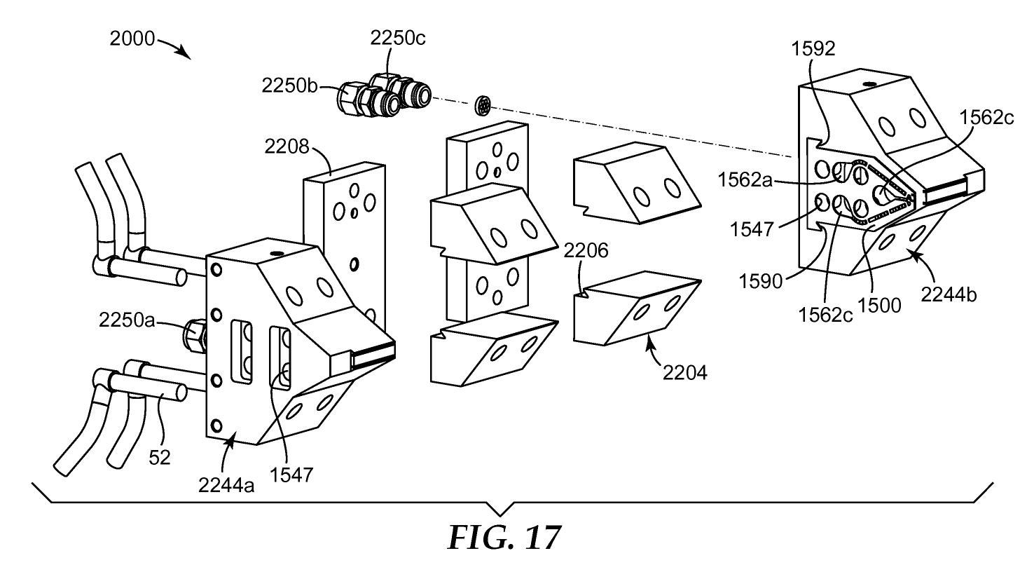

Shim 1500 has several holes 1547 to allow the passage of, for example, bolts to hold shim 1500 and others to be described below into an assembly. Shim 1500 has dispensing opening 1556 in dispensing surface 1567. Dispensing opening 1556 may be more clearly seen in the expanded view shown in FIG. 10B. It might appear that there is no path from cavity 1562a to dispensing opening 1556, via, for example, first passageway 1568a, but the flow has a route in the perpendicular-to-the-plane-of-the-drawing dimension when the sequence of FIGS. 15 and 16, for example, is completely assembled. In the illustrated embodiment, dispensing surface 1567 has indexing groove 1580 which can receive an appropriately shaped key to facilitate assembling diverse shims into a die. The shim may also have identification notch 1582 to help verify that the die has been assembled in the desired manner. This embodiment of the shim has shoulders 1590 and 1592, which can assist in mounting the assembled die in a manner which will be made clear below in connection with FIG. 17.

Referring now to FIG. 11A, a plan view of shim 1600 is illustrated. Shim 1600 has first aperture, 1660a, second aperture 1660b, and third aperture 1660c. When shim 1600 is assembled with others as shown in FIGS. 15 and 16, aperture 1660a will help define first cavity 1562a, aperture 1660b will help define second cavity 1562b, and aperture 1660c will help define third cavity 1562c. Analogous to shim 1500, shim 1600 has dispensing surface 1667, and in this particular embodiment, dispensing surface 1667 has indexing groove 1680 and identification notch 1682. Also analogous to shim 1500, shim 1600 has shoulders 1690 and 1692. It might appear that there is no path from cavity 1562b to dispensing opening 1656, via, for example, second passageway 1668b, but the flow has a route in the perpendicular-to-the-plane-of-the-drawing dimension when the sequence of FIGS. 15 and 16 is completely assembled. Second passageway 1668b includes branches 1698 that accept the flow of the third polymeric composition from the third fluid passageway as described in further detail below. It will be noted that second passageway 1668b includes constriction 1696 upstream from dispensing opening 1656, which may be more clearly seen in the expanded view of FIG. 11B. The constriction may allow for easier machining of the branches 1698.

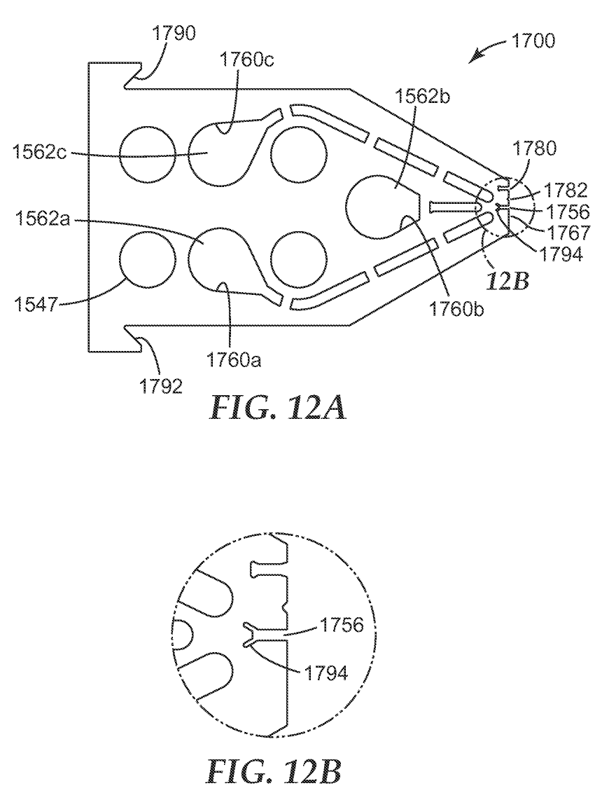

Referring now to FIG. 12A, a plan view of shim 1700 is illustrated. Shim 1700 has first aperture 1760a, second aperture 1760b, and third aperture 1760c. When shim 1700 is assembled with others as shown in FIGS. 15 and 16, aperture 1760a will help define first cavity 1562a, aperture 1760b will help define second cavity 1562b, and aperture 1760c will help define third cavity 1562c. Analogous to shim 1500, shim 1700 has dispensing surface 1767, and in this particular embodiment, dispensing surface 1767 has indexing groove 1780 and an identification notch 1782. Also analogous to shim 1500, shim 1700 has shoulders 1790 and 1792. Shim 1700 has dispensing opening 1756, but it will be noted that this shim has no connection between dispensing opening 1756 and any of the cavities 1562a, 1562b, or 1562c. As will be appreciated more completely in the discussion below in the discussion with shim 1800, blind recess 1794 behind dispensing openings 1756 provides a path that allows the change in the direction of the flow of material in the third fluid passageways so that it can meet the second fluid passageways. Blind recess 1794 is bifurcated to direct material from passageways 1868c into top and bottom layers on either side of the middle layer provided by the elastic polymeric composition emerging from second cavity 1562b. Blind recess 1794 and dispensing opening 1756 may be more clearly seen in the expanded view shown in FIG. 12B.

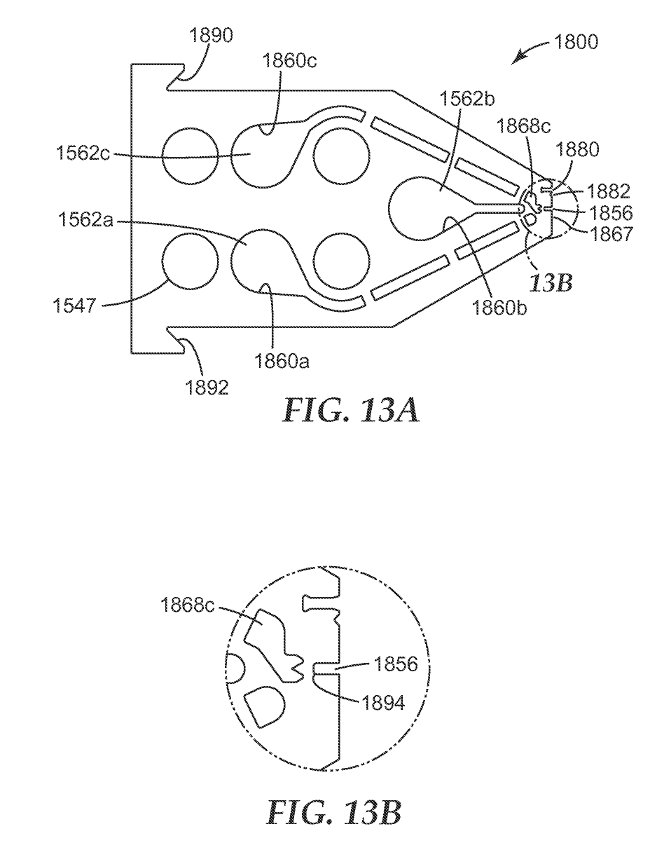

Referring now to FIG. 13A, a plan view of shim 1800 is illustrated. Shim 1800 has first aperture 1860a, second aperture 1860b, and third aperture 1860c. When shim 1800 is assembled with others as shown in FIGS. 15 and 16, aperture 1860a will help define first cavity 1562a, aperture 1860b will help define second cavity 1562b, and aperture 1860c will help define third cavity 1562c. Analogous to shim 1500, shim 1800 has dispensing surface 1867, and in this particular embodiment, dispensing surface 1867 has indexing groove 1880 and an identification notch 1882. Also analogous to shim 1500, shim 1800 has shoulders 1890 and 1892. Shim 1800 has dispensing opening 1856, but it will be noted that this shim has no connection between dispensing opening 1856 and any of the cavities 1562a, 1562b, or 1562c. There is no connection, for example, from cavity 1562c to dispensing opening 1856, via, for example, third passageway 1868c, but the flow has a route in the perpendicular-to-the-plane-of-the-drawing dimension when shim 1800 is assembled with shims 1700 and 1600. Third passageway 1868c in shim 1800 has a bifurcated terminus where material from cavity 1562c is redirected into the two branches of blind recess 1794 of shim 1700 and further to branches 1698 of fluid passageway 1668b of shim 1600 to provide top and bottom layers of the third polymeric composition emerging from third cavity 1562c above and below the middle layer provided by elastic polymeric composition emerging from second cavity 1562b. Because of the terminus of the third passageway upstream from the dispensing slot, flow from the third cavity is prevented alongside the elastic polymeric composition at the dispensing slot. Instead, flow is redirected above and below the elastic polymeric composition as it enters the dispensing slot. Passageway 1868c and dispensing opening 1856 may be more clearly seen in the expanded view shown in FIG. 13B.

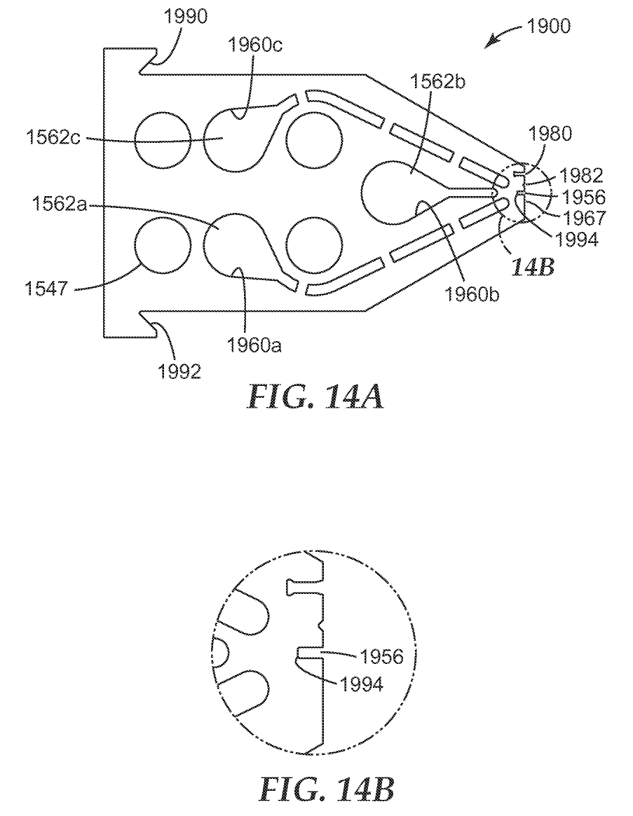

Referring now to FIG. 14A, a plan view of shim 1900 is illustrated. Shim 1900 has first aperture 1960a, second aperture 1960b, and third aperture 1960c. When shim 1900 is assembled with others as shown in FIGS. 15 and 16, aperture 1960a will help define first cavity 1562a, aperture 1960b will help define second cavity 1562b, and aperture 1960c will help define third cavity 1562c. Analogous to shim 1500, shim 1900 has dispensing surface 1967, and in this particular embodiment, dispensing surface 1967 has indexing groove 1980 and identification notch 1982. Also analogous to shim 1500, shim 1900 has shoulders 1990 and 1992. Shim 1900 has dispensing opening 1956, but it will be noted that this shim has no connection between dispensing opening 1956 and any of the cavities 1562a, 1562b, or 1562c. Blind recess 1994 allows the flows of molten polymer from dispensing openings in shims on either side of it to contact each other to form a coherent film. Blind recess 1994 and dispensing opening 1956 may be more clearly seen in the expanded view shown in FIG. 14B. In other positions where shim 1900 appears, it may serve to manipulate the resistance of the dispensing slot within a region to extruded flow. This will also be discussed in more detail below.

Referring now to FIG. 15, a perspective assembly drawing of a sequence of shims, collectively 1000, employing the shims of FIGS. 10A-14A so as to produce the first and second segments as shown in FIG. 4, is shown. It should be noted in FIG. 15 that the dispensing slot 1056, formed by the dispensing openings 1556, 1656, 1756, 1856, and 1956 collectively in the plurality of shims, is a continuous opening across the die. There are no shims without dispensing openings. Referring now to FIG. 16, one subsequence of shims from FIG. 15 is exploded to reveal some individual shims. Specifically, the sequence of shims that forms first, second, and third layers in the second segments is shown exploded. Proceeding left to right, die zone 1210 comprises a sequence of four shims 1500 that can extrude first segments 210. Die zone 1204 includes a sequence of eight shims that can extrude layered second segments 204. The first slot segment in the extrusion die corresponds to the portion of the dispensing slot 1056 in die zone 1210, and the second slot segment corresponds to the portion of the dispensing slot 1056 in die zone 1204. Die zone 1204 is shown to comprise one instance of shim 1900, one instance of shim 1800, one instance of shim 1700, two instances of shim 1600, one instance of shim 1700, one instance of shim 1800, and one instance of shim 1900, making eight shims total. In this view, it is easier to appreciate how the layered second segment 204 (seen in FIG. 4) is formed. A third polymeric composition flowing from two third passageways 1868c in the two instances of shim 1800 is prevented from reaching recess 1894. Instead, the third polymeric composition flows through branches in blind recesses 1794 in shims 1700 and then to the branches 1698 where it is directed above and below the flow of the elastic polymeric composition exiting from the constriction 1696 in the second fluid passageway. In the dispensing slot, the second segment 204 is bonded to first segments 210 (seen in FIG. 4), which emerges from dispensing openings 1556 in the four instances of shim 1500.

Extrusion dies according to the present disclosure, which are useful for extruding the films disclosed herein, have a dispensing slot. The embodiment of FIG. 15 illustrates an example of a dispensing slot in an extrusion die comprising a plurality of shims. In FIG. 15, dispensing slot 1056 is a cavity recessed back from dispensing surface 1267, formed from dispensing surfaces 1567, 1667, 1767, 1867, and 1967 of shims 1500, 1600, 1700, 1800, and 1900, respectively. Dispensing slot 1056 has a land 1051, where the confluence of the various extruded polymeric compositions is allowed to melt bond together. In the illustrated embodiment, the land 1051 is a flat surface, but this is not a requirement. The shims may be designed to have a textured surface, or the height of the dispensing openings of the different shims 1500-1900 may be different as desired for a particular film. Also in the illustrated embodiment, the land 1051 length is shorter at the position of the confluence of the second and third polymeric compositions from the second and third passageways than at the position formed by the dispensing openings 1556 in shims 1500, but this is also not a requirement. The length of land 1051 should typically be long enough to establish the flow of the polymer extrudate and allow melt-bonding between the various polymeric compositions, which typically requires that the length of the land over the height of the polymer is in a range from 1 to 10. If the length of the land 1051 is too long, for example, longitudinal segments at the edges of the polymer extrudate may become distorted. It can also be desirable to have the recessed cavity taper in width, for example, after the flowstreams combine.

Referring now to FIG. 17, an exploded perspective view of a mount 2000 suitable for an extrusion die composed of multiple repeats of the sequence of shims of FIGS. 15 and 16, for example, is illustrated. Mount 2000 is particularly adapted to use shims 1500, 1600, 1700, 1800, and 1900 as shown in FIGS. 10A through 14A. However for visual clarity, only a single instance of shim 1500 is shown in FIG. 17. The multiple repeats of the sequence of shims of FIGS. 15 and 16 are compressed between two end blocks 2244a and 2244b. Conveniently, through bolts can be used to assemble the shims to the end blocks 2244a and 2244b, passing through holes 1547 in shims 1500, 1600, 1700, 1800, and 1900, for example.

In this embodiment, inlet fittings 2250a, 2250b, and 2250c provide a flow path for three streams of molten polymer through end blocks 2244a and 2244b to cavities 1562a, 1562b, and 1562c. Compression blocks 2204 have a notch 2206 that conveniently engages the shoulders on the shims (e.g., 1590 and 1592 on 1500). When mount 2000 is completely assembled, compression blocks 2204 are attached by, e.g. machine bolts to backplates 2208. Holes are conveniently provided in the assembly for the insertion of cartridge heaters 52.

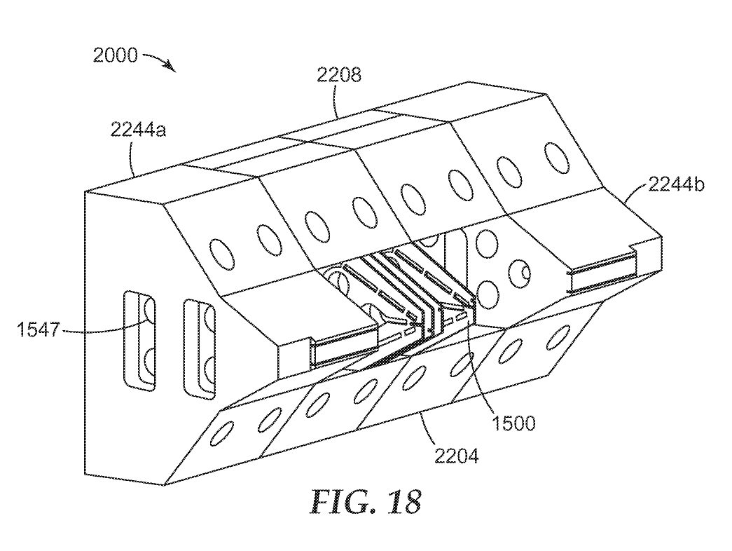

Referring now to FIG. 18, a perspective view of mount 2000 of FIG. 17 is illustrated in a partially assembled state. A few shims (e.g., 1500) are in their assembled positions to show how they fit within mount 2000, but most of the shims that would make up an assembled die have been omitted for visual clarity.

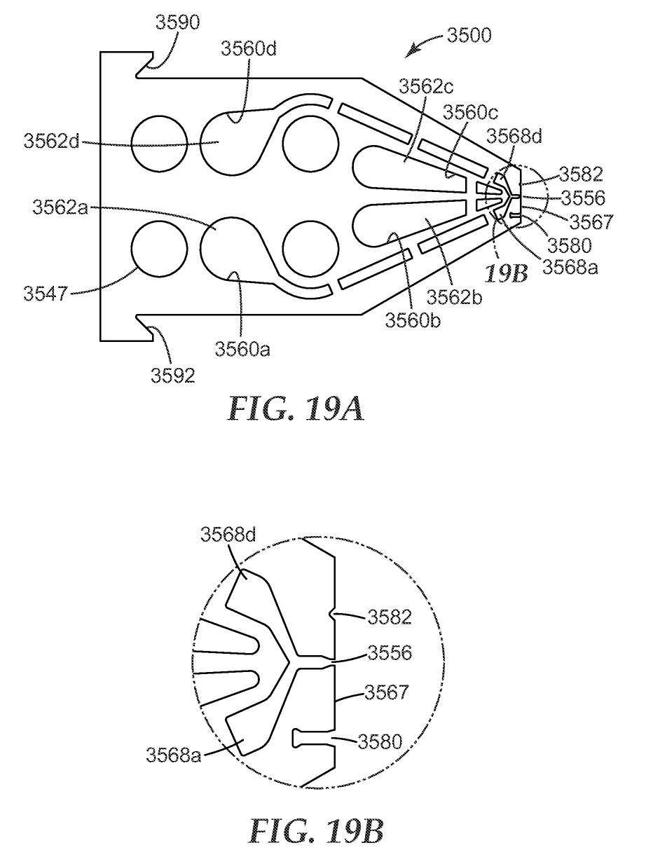

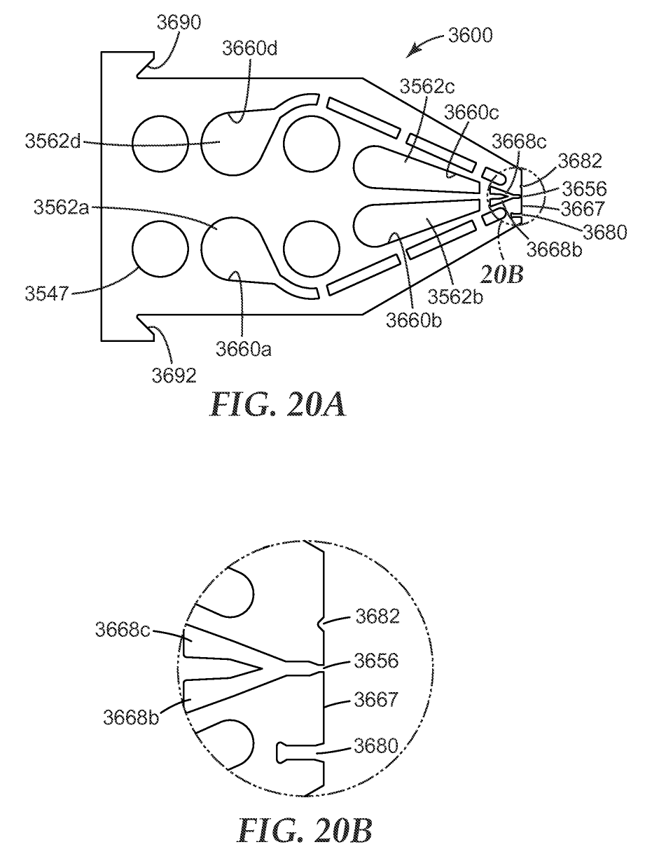

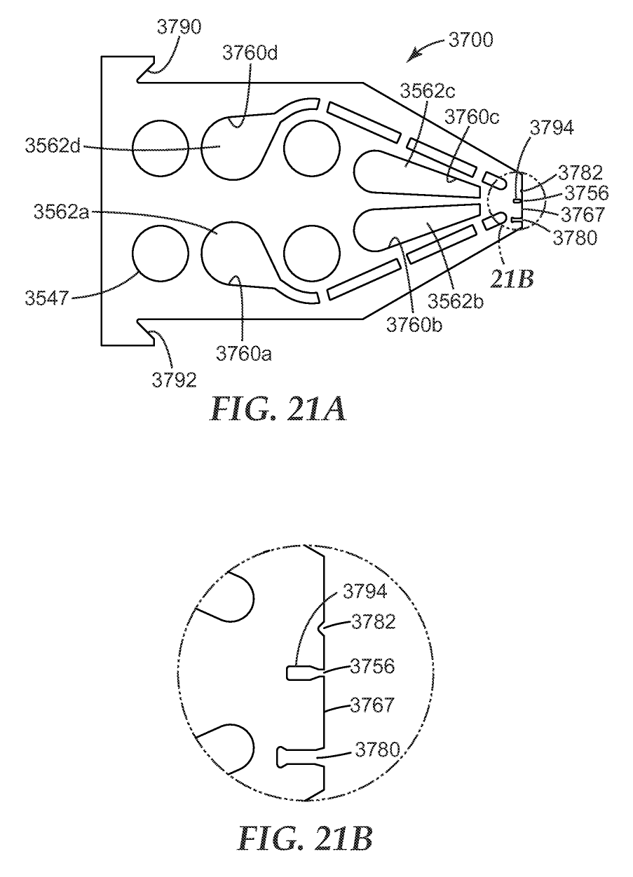

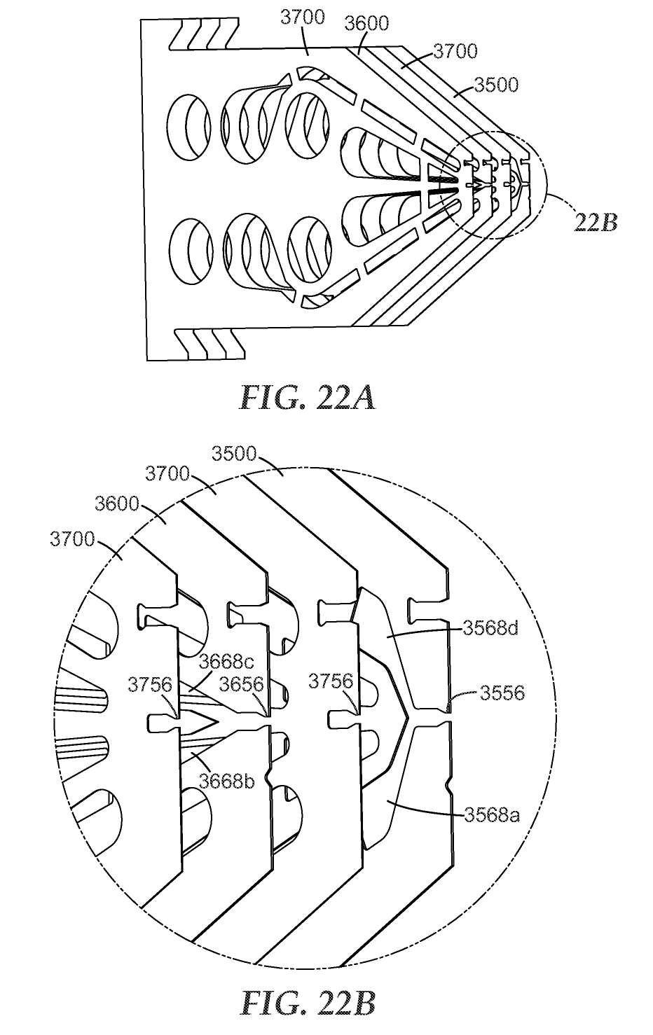

Another film that may be useful as an apertured film according to the present disclosure can have first segments and second segments each having first and second layers (e.g., with each layer in each of the first and second segments being of a different polymeric composition). Such a film can conveniently be extruded by the extrusion die shown in FIGS. 19A to 22A. Referring now to FIG. 19A, a plan view of shim 3500 is illustrated. Shim 3500 is useful in a sequence of shims shown in FIGS. 22A and 22B. Other shims useful in this sequence are shown in FIGS. 20A and 21A. Shim 3500 has first aperture, 3560a, second aperture 3560b, a third aperture 3560c, and a fourth aperture 3560d. When shim 3500 is assembled with others as shown in FIGS. 22A and 22B, first aperture 3560a will help define first cavity 3562a, second aperture 3560b will help define second cavity 3562b, third aperture 3560c will help define third cavity 3562c, and fourth aperture 3560d will help define fourth cavity 3562d. As will be discussed with more particularity below, molten polymer in cavities 3562a and 3562d can be extruded in layered first segments, and molten polymer in cavities 3562b and 3562c can be extruded in layered second segments between those layered first segments.

Shim 3500 has several holes 3547 to allow the passage of, for example, bolts to hold shim 3500 and others to be described below into an assembly. Shim 3500 has dispensing opening 3556 in dispensing surface 3567. Dispensing opening 3556 may be more clearly seen in the expanded view shown in FIG. 19B. It might appear that there are no paths from cavities 3562a and 3562d to dispensing opening 3556, via, for example, passageways 3568a and 3568d, but the flow has a route in the perpendicular-to-the-plane-of-the-drawing dimension when the sequence of FIGS. 22A and 22B, for example, is completely assembled. In the illustrated embodiment, dispensing surface 3567 has indexing groove 3580 which can receive an appropriately shaped key to facilitate assembling diverse shims into a die. The shim may also have identification notch 3582 to help verify that the die has been assembled in the desired manner. This embodiment of the shim has shoulders 3590 and 3592, which can assist in mounting the assembled die as described above in connection with FIG. 17.

Referring now to FIG. 20A, a plan view of shim 3600 is illustrated. Shim 3600 has first aperture, 3660a, second aperture 3660b, third aperture 3660c, and fourth aperture 3660d. When shim 3600 is assembled with others as shown in FIGS. 22A and 22B, first aperture 3660a will help define first cavity 3562a, second aperture 3660b will help define second cavity 3562b, third aperture 3660c will help define third cavity 3562c, and fourth aperture 3660d with help define fourth cavity 3562d. Analogous to shim 3500, shim 3600 has dispensing surface 3667, and in this particular embodiment, dispensing surface 3667 has indexing groove 3680 and identification notch 3682. Also analogous to shim 3500, shim 3600 has shoulders 3690 and 3692. It might appear that there are no paths from cavities 3562b and 3562c to dispensing opening 3656, via, for example, passageway 3668b and 3668c, respectively, but the flow has a route in the perpendicular-to-the-plane-of-the-drawing dimension when the sequence of FIGS. 22A and 22B, for example, is completely assembled. Dispensing opening 3656 may be more clearly seen in the expanded view shown in FIG. 20B.

Referring now to FIG. 21A, a plan view of shim 3700 is illustrated. Shim 3700 has first aperture 3760a, second aperture 3760b, third aperture 3760c, and fourth aperture 3760d. When shim 3700 is assembled with others as shown in FIGS. 22A and 22B, first aperture 3760a will help define first cavity 3562a, second aperture 3760b will help define second cavity 3562b, third aperture 3760c will help define third cavity 3562c, and fourth aperture 3760d with help define fourth cavity 3562d. Analogous to shim 3500, shim 3700 has dispensing surface 3767, and in this particular embodiment, dispensing surface 3767 has indexing groove 3780 and identification notch 3782. Also analogous to shim 3500, shim 3700 has shoulders 3790 and 3792. Shim 3700 has dispensing opening 3756, but it will be noted that this shim has no connection between dispensing opening 3756 and any of the cavities 3562a, 3562b, 3562c, or 3562d. Blind recess 3794 behind dispensing opening 3756 allows the flows of molten polymer from dispensing openings 3556 and 3656 to contact each other to form a coherent film. Blind recess 3794 and dispensing opening 3756 may be more clearly seen in the expanded view shown in FIG. 21B.

Referring now to FIG. 22A, a perspective assembly drawing of a sequence of shims employing the shims of FIGS. 19A-21A so as to produce layered first and second segments is shown. Shims 3500 and 3600 can be separated by shims 3700 to produce separate layered first and second segments. More particularly, proceeding from left to right in FIGS. 22A and 22B, a first die zone can include one instance of shim 3700 and one instance of a shim 3600, and a second die zone can include one instance of shim 3700 and one instance of a shim 3500. More than one of each of shims 3600 and 3500 may be used together in a sequence depending on the thickness of the shims and the desired width of the layered first and second segments. For example, one instance of shim 3700 can be followed by a number of shims 3600 in the first die zone, and one instance of shim 3700 can be followed by the same or different number of shims 3500 in the second die zone. It should be noted in FIGS. 22A and 22B that the dispensing slot formed by the dispensing openings 3556, 3656, and 3756 collectively in the plurality of shims is a continuous opening across width of the die. There are no shims without dispensing openings. The first slot segment in an extrusion die including the shims shown in FIGS. 22A and 22B can be considered to be the portion formed by dispensing opening 3556, and the second slot segment can be considered to be the portion formed by dispensing opening 3656.

Modifications of the shims shown in FIGS. 10A to 16 and 19A to 22A can be useful for making other embodiments of films according to the present disclosure. For example, the shims shown in FIGS. 10A to 16 can be modified to have only two cavities, and the first passageways 1568a and third passageways 1868c can be modified to extend from the same cavity. With this modification, a film having first segments 210 and second segments 204 as shown in FIG. 4, where the first segments 210 and second and third layers 208 and 209 all include the same polymeric composition, can be made. In another embodiment, the shims shown in FIGS. 10A to 16 can be modified to include four cavities and instances of shims 1800, 1700, and 1600 modified to make the first segments 310 having fifth and sixth layers 327 and 328 made from the same polymeric composition. Such a modification can be useful for making a film 300 (shown in FIG. 5) in which four different polymeric compositions are used to make fourth layers 326 of the first segments 310, first layers 306 of the second segments 304, second and third layers 308 and 309 of the second segments 304, and fifth and sixth layers 327 and 328 of the first segments 310, respectively. In another embodiment, the shims shown in FIGS. 10A to 16 can be modified to include instances of shims 1800, 1700, and 1600 modified to make the first segments 410, 510 having fifth and sixth layers 427, 527 and 428, 528 made from the same polymeric composition. The sizes of branches 1698, dispensing opening 1656, blind recess 1794, and passageway 1868c can be adjusted to make the center polymer flow thinner than the top and bottom polymer flows. Such a modification can be useful for making a film 400 or 500 (shown in FIGS. 6 and 7) in which fourth layer 426, 526 is smaller in thickness than fifth and sixth layers 427, 527 and 428, 528. The shim sequences including shims 1800, 1700, and 1600 and modified 1800, 1700, and 1600 can be useful for making fourth layers 426, 526 of the first segments 410, 510 and first layers 406, 506 of the second segments 404, 504 from a polymeric composition coming from the same cavity 1562b. In yet another embodiment, shims such as those shown FIGS. 10A to 16 can be modified to have six cavities and passageways to make 3-layer first and second segments 310 and 304, such as those shown in FIG. 5, 6, or 7, with each of the layers made from a different polymeric composition. In yet another embodiment, a modification of the shims shown in FIGS. 10A to 16 can be modified to have four cavities, for example, and modified versions of shims 1800 and 1700 having wider spaced branches in passageways such as 1868c and blind recesses such as 1794, respectively. Shim 1600 can be modified to have a second set of bifurcations like branches 1698 that are wider spaced and meet the main second passageway 1668b at a location closer to dispensing surface 1667. Such a modification may be useful, for example, for making a film similar to film 200 shown in FIG. 4, but having more than three layers (e.g., five layers) in the second segments.

The shims shown in FIGS. 19A to 22A can be useful for making a film having first segments 210 and second segments 204 as shown in FIG. 4, where the second segments 204 have only two layers: first layer 206 and second layer 208. Such a film can be made if cavities 3562a and 3562d include the same first polymeric composition. Or the shims shown in FIGS. 19A to 22A can be modified to include only three cavities, if each of the first segments 210 and the first and second layers 206 and 208 have different polymeric compositions, or two cavities if first segments 210 and second layer 208 include the first polymeric composition and the first layer 206 includes the elastic polymeric composition. Such a film construction can be useful, for example, if the film is laminated to one layer of fibrous web with the fibrous web in contact with first layers 206.

For more information regarding films including layered segments, see U.S. Pat. App. Pub. No. 2014/0248471 (Hanschen et al.), incorporated by reference herein in its entirety.

Dies useful for preparing film 600 as in the embodiment shown in FIG. 8 have a subsequence of shims in which a core/sheath strand is formed. Similarly to the embodiments shown in FIGS. 4 to 7, such films can be prepared from dies including a plurality of shims comprising a plurality of sequences of shims Such sequences can include shims that provide a third fluid passageway between the third cavity and the dispensing slot, shims that provide at least two second passageways extending from the second cavity to the dispensing slot, wherein each of the two second passageways are on opposite longitudinal sides of the third passageway, and each of the two second passageways has a dimension larger than the third passageway at the point where the third passageway enters the dispensing slot. This allows the flows of the sheath polymeric composition from the second passageways to encapsulate the core polymeric composition entering the dispensing slot from the third passageway. Obtaining good encapsulation of the core polymeric composition entering from the third passageway depends in part on the melt viscosity of the polymeric composition that forms the sheath. In general, lower melt viscosity of the sheath-forming polymeric composition improves the encapsulation of the core. Further, the encapsulation depends in part on the degree to which the at least two second passageways have a dimension larger than the third passageway at the point when they enter the dispensing slot. In general, increasing the degree by which that dimension is larger in the second passageways relative to the same dimension in the third passageway will improve the encapsulation of the core. Good results may be obtained when the dimensions of the passageways and pressures within the cavities are manipulated so that the flow speeds of the sheath polymeric composition and the core polymeric composition within the dispensing slot are close to one another.

Referring now to FIG. 23A, a plan view of shim 4540 is illustrated. Shim 4540 is useful in a plurality of sequences of shims shown in FIGS. 27 to 29, which are for making films having first and second segments, wherein the second segments are strands comprising a core and a sheath. Other shims useful in these sequences are shown in FIGS. 24A to 26A. Shim 4540 has first aperture, 4560a, second aperture 4560b, and third aperture 4560c. When shim 4540 is assembled with others in mount, for example, as shown in FIGS. 17 and 18, aperture 4560a will help define second cavity 4562a, aperture 4560b will help define first cavity 4562b, and aperture 4560c will help define third cavity 4562c. As will be discussed with more particularity below, molten polymer in cavities 4562a and 4562c can be extruded in a strand with a sheath/core arrangement, and molten polymer in cavity 4562b can be extruded as a stripe between those sheath/core strands.

Shim 4540 has several holes 47 to allow the passage of, for example, bolts to hold shim 4540 and others to be described below into an assembly. Shim 4540 has dispensing opening 4566 in dispensing surface 4567. Dispensing opening 4566 may be more clearly seen in the expanded view shown in FIG. 23B. It might seem that there is no path from cavity 4562b to dispensing opening 4566, via, for example, passageway 4568b, but the flow has a route in the perpendicular-to-the-plane-of-the-drawing dimension when the sequence of FIG. 27 is completely assembled. In the illustrated embodiment, dispensing surface 4567 has indexing groove 4580 which can receive an appropriately shaped key to facilitate assembling diverse shims into a die. The shim may also have identification notch 4582 to help verify that the die has been assembled in the desired manner. This embodiment of the shim has shoulders 4590 and 4592, which can assist in mounting the assembled die in a manner as described above in connection with FIG. 17.

Referring now to FIG. 24A, a plan view of shim 4640 is illustrated. Shim 4640 has first aperture 4660a, second aperture 4660b, and third aperture 4660c. When shim 4640 is assembled with others as shown in FIG. 27, aperture 4660a will help define second cavity 4562a, aperture 4660b will help define first cavity 4562b, and aperture 4660c will help define third cavity 4562c. Analogous to shim 4540, shim 4640 has dispensing surface 4667, and in this particular embodiment, dispensing surface 4667 has indexing groove 4680 and an identification notch 4682. Also analogous to shim 4540, shim 4640 shoulders 4690 and 4692. It might seem that there is no path from cavity 4562a to dispensing orifice 4666, via, for example, passageway 4668a, but the flow has a route in the perpendicular-to-the-plane-of-the-drawing dimension when the sequence of FIG. 27 is completely assembled. Dispensing opening 4666 may be more clearly seen in the expanded view shown in FIG. 24B.

Referring now to FIG. 25A, a plan view of shim 4740 is illustrated. Shim 4740 has first aperture 4760a, second aperture 4760b, and third aperture 4760c. When shim 4740 is assembled with others as shown in FIG. 27, aperture 4760a will help define second cavity 4562a, aperture 4760b will help define first cavity 4562b, and aperture 4760c will help define third cavity 4562c. Analogous to shim 4540, shim 4740 has dispensing surface 4767, and in this particular embodiment, dispensing surface 4767 has indexing groove 4780 and identification notch 4782. Also analogous to shim 4540, shim 4740 has shoulders 4790 and 4792. Shim 4740 has dispensing opening 4766, but it will be noted that this shim has no connection between dispensing opening 4766 and any of the cavities 4562a, 4562b, or 4562c. As will be appreciated more completely in the discussion below, in some of the positions where shim 4740 appears, blind recess 4794 behind dispensing opening 4766 helps shape the flow of material from cavity 4562a into a sheath around the core provided by the elastic polymeric composition emerging from shim 4840. Blind recess 4794 and dispensing opening 4766 may be more clearly seen in the expanded view shown in FIG. 25B. In other positions where shim 4740 appears, it serves to manipulate the resistance of the dispensing slot within a region to extruded flow. This will also be discussed in more detail below.

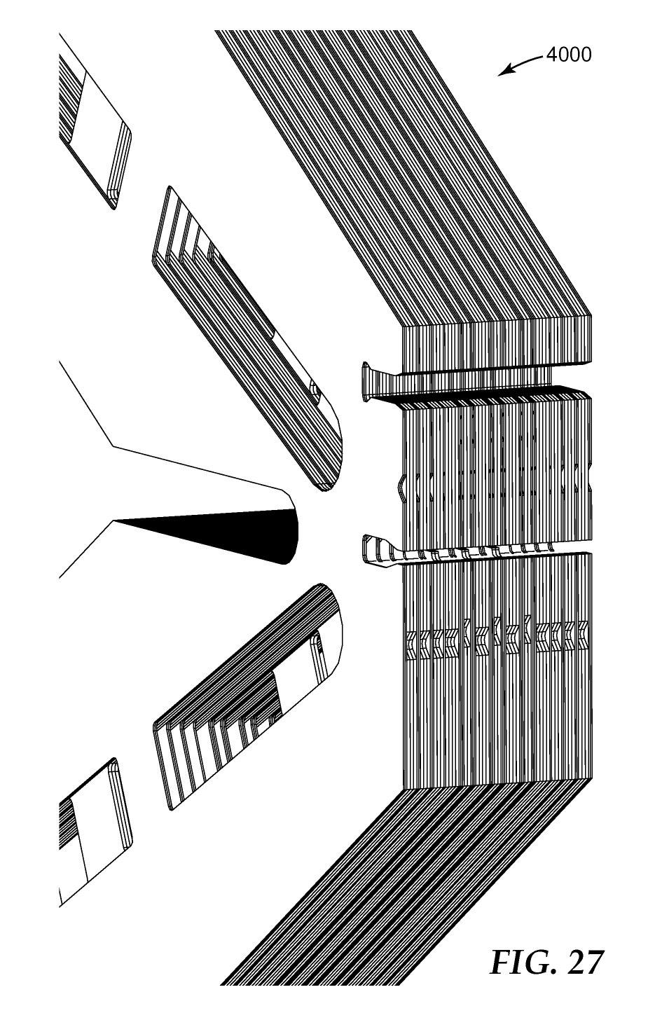

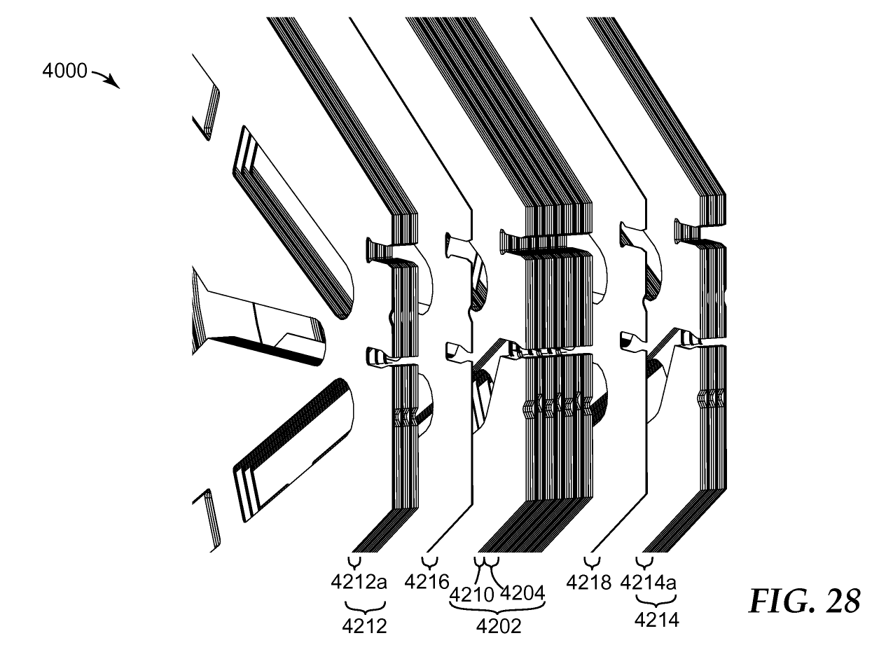

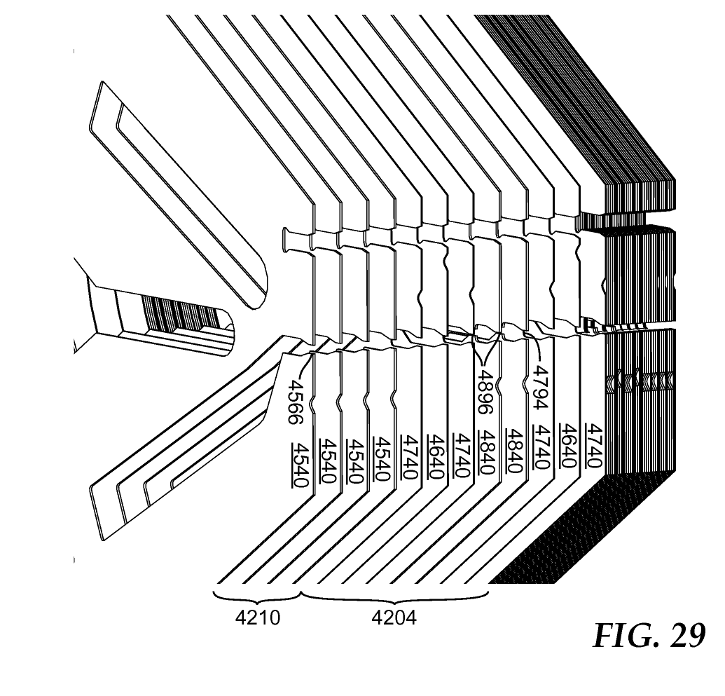

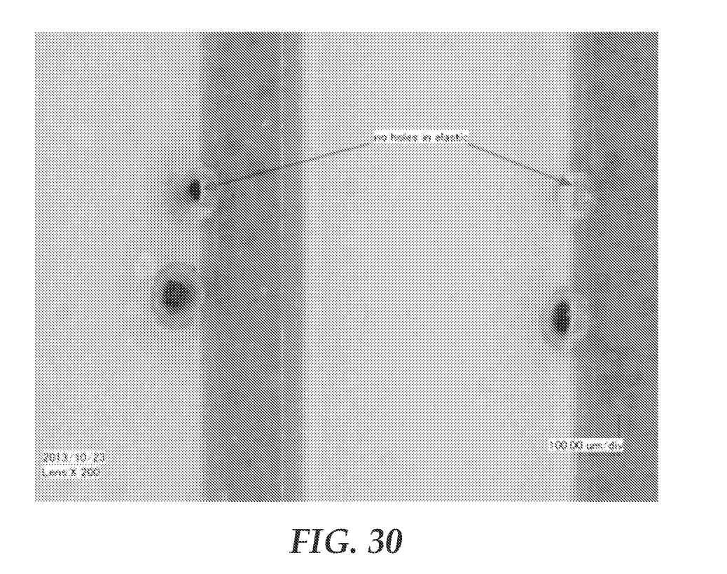

Referring now to FIG. 26A, a plan view of shim 4840 is illustrated. Shim 4840 has first aperture, 4860a, second aperture 4860b, and third aperture 4860c. When shim 4840 is assembled with others as shown in FIG. 27, aperture 4860a will help define second cavity 4562a, aperture 4860b will help define first cavity 4562b, and aperture 4860c will help define third cavity 4562c. Analogous to shim 4540, shim 4840 has dispensing surface 4867, and in this particular embodiment, dispensing surface 4867 has indexing groove 4880 and identification notch 4882. Also analogous to shim 4540, shim 4840 has shoulders 4890 and 4892. It might seem that there is no path from cavity 4562c to dispensing opening 4866, via, for example, passageway 4868c, but the flow has a route in the perpendicular-to-the-plane-of-the-drawing dimension when the sequence of FIG. 27 is completely assembled. It will be noted that passageway 4868c includes constriction 4896 upstream from dispensing opening 4866, which may be more clearly seen in the expanded view of FIG. 26B. It will be appreciated in connection with FIG. 29 that constriction 4896 helps the sheath to completely surround the core of the emerging strand.

Referring now to FIG. 27, a perspective assembly drawing of a several different repeating sequences of shims, collectively 4000, employing the shims of FIGS. 23A-26A so as to be able to produce a film having first and second segments, wherein the second segments are strands comprising a core and a sheath, is shown. It should be noted in FIG. 27 that the dispensing slot, formed by the dispensing openings 4566, 4666, 4766, and 4866 collectively in the plurality of shims, is a continuous opening across the die. There are no shims without dispensing openings, which would form breaks to cause the extruded polymeric compositions to form into separated strands. Referring now to FIG. 28, the several different repeating sequences of shims shown together in FIG. 27 are shown separated into the sequences that produce the several segments discussed above in connection with FIG. 8. More particularly, and proceeding left to right, die zone 4212 comprises three instances of a repeating sequence of four shims 4212a that can extrude ribbon region 612. Die zone 4216 includes one instance of one shim. Die zone 4202 includes four instances of a repeating sequence 4210 of four shims that can extrude stripes making up the first segments 610. Interspersed with repeating sequences 4210 of four shims are three instances of a repeating sequence 4204 of eight shims that can extrude strands 604. Die zone 4218 includes one instance of one shim. Finally die zone 4214 comprises three instances of a repeating sequence of four shims 4214a that can extrude ribbon region 614. Die zones 4212, 4216, 4218, and 4214 and consequently ribbon regions 612 and 614 and weld lines 616 and 618 are optional in the embodiments where second segments are strands comprising a core and a sheath and may also be useful in some embodiments of the films shown in FIGS. 4 to 7 made according to the method described above in connection with FIGS. 15, 16, 22A, and 22B.

Referring now to FIG. 29, a perspective view of sequences 4210 and 4204 of FIG. 28 is further exploded to reveal some individual shims More particularly, sequence 4210 is more clearly shown to comprise four instances of shim 4540. Further, sequence 4204 is more clearly shown to comprise one instance of shim 4740, one instance of shim 4640, one instance of shim 4740, two instances of shim 4840, one instance of shim 4740, one instance of shim 4640, and one instance of shim 4740, making eight shims total. In this view, it is easier to appreciate how the strand 604 (seen in FIG. 8) is formed. Referring again to FIGS. 26A and 26B, the presence of constriction 4896 on the two instances of shim 4840 allows the inflows along passageways 4668a to have a dimension larger than passageway 4868c at the point where passageway 4868c enters the dispensing slot. Referring again to FIGS. 24A, 24B, 25A, and 25B, blind recesses 4794 on the two instances of shim 4740 cooperate to allow the inflows from along passageways 4668a on the two instances of shim 4640 to envelop the inflow from the passageways 4868c on the two instances of shim 4840, resulting in a strand 604 with sheath 608 around core 606 (seen in FIG. 8). The strand 604, which includes relatively elastic core 606, is bonded to a relatively less elastic first segment 610 in the form of stripe (seen in FIG. 8), which emerges from dispensing openings 4566 in the four instances of shim 4540.

The extrusion die described above in connection with FIGS. 23A to 29 may be useful for making a variety of film constructions including, for example, three or more different polymeric compositions. In some embodiments, the stripes are made from the first polymeric composition, the sheath is made from a different polymeric composition, and the core is made from the elastic polymeric composition that is more elastic than either the first or sheath polymeric composition. In embodiments of the film disclosed herein that include a first polymeric composition, a sheath polymeric composition, and an elastic polymeric composition, blending may be useful for making a sheath polymeric composition that is relatively more elastic than the first polymeric composition but relatively less elastic than the elastic polymeric composition from which the cores are made. In some embodiments, the sheath polymeric composition comprises a blend of the first polymeric composition and the elastic polymeric composition. In these embodiments, the sheath polymeric composition generally has good compatibility with and good adhesion to both the first polymeric composition and the elastic polymeric composition. This allows the sheath polymeric composition to serve as an effective tie layer between the stripes and the strand cores without the use of other compatibilizers such as those described in U.S. Pat. No. 6,669,887 (Hilston et al.). However, in some embodiments, compatibilizers added to at least one of the core or sheath polymeric compositions may be useful. Examples of useful compatibilizers can be found in U.S. Pat. No. 4,787,897 (Torimae et al.) and U.S. Pat. No. 6,669,887 (Hilston et al.). The polymeric composition for making the sheath, for example, when it is different from the first polymeric composition, may be selected such that a film (e.g., 0.002 mm to 0.5 mm thick) of the sheath polymeric composition, which may be a blend of polymers, has an elongation of at least 5% at room temperature.

The extrusion die described above in connection with FIGS. 23A to 29 is also useful, for example, for making film constructions including two different polymeric compositions. In some embodiments, the same polymeric composition may be in two different cavities. For example, in the apparatus illustrated in FIGS. 23A to 29, the same polymeric composition may be used in both cavities 4562a and 4562b to provide a film as shown in FIG. 8 in which the cores 606 of strands 604 are made from one polymeric composition and the sheaths 608 of strands 604 and the first segments 610 are made from another polymeric composition. Using this die and method, a film may be made that has stripes of a first polymeric composition alternating with strands of, for example, the elastic polymeric composition, wherein the strands are encapsulated by the first polymeric composition such that the elastic polymeric composition is not exposed on at least one major surface (or both major surfaces) of the film. In these embodiments in which the stripes and the sheath are made from the same polymeric composition, it is typically still possible to detect a boundary between the sheath and the stripes because of the different flow velocities in the flow channels for the stripes and the sheath. The flow velocity for the sheath is typically much lower than that of the stripes because of the smaller size of the flow channels for the sheath (e.g., formed by shims 4640 and 4740 shown in FIG. 29) relative to the flow channels for the stripes (e.g., formed by shims 4540 shown in FIG. 29). The sheath material typically accelerates more at the dispensing opening causing it to have more molecular orientation, and as a result, a higher degree of birefringence as described above, than the stripes. Thus, there is typically a difference in molecular orientation between the sheath and the stripes that can be detected by measuring birefringence. Depending on the length of time the sheath and the stripes are allowed to remain in the molten state after they are merged, a weld line is formed between the sheath and the stripes. A weld line between the sheath and the stripes in the film 600 shown in FIG. 8 may be visible, for example, when the film is stretched in a direction transverse to the strands and stripes.

For more information regarding films including stripes alternating with strands having a core and a sheath, see U.S. Pat. App. Pub. No. 2014/0093716 (Hanschen et al.), incorporated by reference herein in its entirety.

While each of FIGS. 10A to 16, 19A to 22A, and 23A to 29 illustrate at least a portion of an apparatus for extrusion that includes a plurality of shims, it is also envisioned that an extrusion die could be machined to have the same passageways from various cavities within the extrusion without using a plurality of shims. The passageways may be machined into various regions of a die or into blocks, for example, that can be assembled to make a die. Such blocks can have a dimension in the width “x” direction of the extrusion die of up to about 5 centimeters or more. Any of these constructions may be useful for making the films disclosed herein.

Films comprising alternating first and second segments useful for practicing the present disclosure include films wherein the first segments are made from a first polymeric composition, and wherein the second segments comprise strands of the elastic polymeric composition embedded in a matrix of the first polymeric composition that is continuous with the first segments. An example of these films is shown in FIG. 9 as film 700. To make such films an elastic polymer melt stream can be segmented into multiple substreams and then extruded into the center of a melt stream of the first polymeric composition, which is then formed into a film. This co-extrusion method creates a film that has multiple segmented flows within a matrix of another polymer. Dies useful for making films of this type include inclusion co-extrusion dies (e.g., those shown in U.S. Pat. No. 6,767,492 (Norquist et al.) and U.S. Pat. No. 5,429,856 (Krueger et al.)) and other similar apparatuses.

In some embodiments of the film or the method of making the film according to the present disclosure, the film may be stretched in at least one direction. When the film or extruded article disclosed herein is a web of indefinite length, for example, monoaxial stretching in the machine direction, which is typically the direction parallel to the longitudinal direction of the first and second segments, can be performed by propelling the web over rolls of increasing speed. Means such as diverging rails and diverging disks are useful for cross-direction stretching, which is typically the film width “x” direction. A versatile stretching method that allows for monoaxial, sequential biaxial, or simultaneous biaxial stretching of a thermoplastic web employs a flat film tenter apparatus. Such an apparatus grasps the thermoplastic web using a plurality of clips, grippers, or other film edge-grasping means along opposing edges of the thermoplastic web in such a way that monoaxial, sequential biaxial, or simultaneous biaxial stretching in the desired direction is obtained by propelling the grasping means at varying speeds along divergent rails. Increasing clip speed in the machine direction generally results in machine-direction stretching. Monoaxial and biaxial stretching can be accomplished, for example, by the methods and apparatus disclosed in U.S. Pat. No. 7,897,078 (Petersen et al.) and the references cited therein. Flat film tenter stretching apparatuses are commercially available, for example, from Bruckner Maschinenbau GmbH, Siegsdorf, Germany. Other useful methods for stretching the films disclosed herein in one or more directions (e.g., “x” and “y” directions referring to FIG. 1) include incremental stretching methods such as ring-rolling, structural elastic film processing (SELFing), which may be differential or profiled, in which not all material is strained in the direction of stretching, and other means of incrementally stretching webs as known in the art. Methods of incremental stretching are described in more detail below in connection with laminates of the films according to the present disclosure.

In some embodiments of the method of making the film according to the present disclosure, it is useful to stretch the film in one or more directions (e.g., “x” and “y” directions referring to FIG. 1) to the point of plastic deformation of the first segments before forming apertures with the laser. In some embodiments, it is useful to stretch the film in the “x” direction to plastically deform the first segments before forming apertures with the laser. Such stretching can be useful to reduce the thickness of the first segments and make the penetration through the thickness of the first segments easier. In some embodiments, particularly when the first segments have been stretched to reduced their thicknesses, one pulse of the laser per hole may be sufficient to provide apertures in the first segments.

Films according to and/or made according to the present disclosure may have stretch-induced molecular orientation (e.g., in the first segments) after being stretched in at least one of the machine direction or cross-direction. Whether the first or second segments or other portions of the film have stretch-induced molecular orientation can be determined by standard spectrographic analysis of the birefringent properties of the oriented polymer forming the segments. The first or second segments or other portions of the film having stretch-induced molecular orientation may also be said to be birefringent, which means that the polymer in the oriented portion of the film has different effective indexes of refraction in different directions. In the present application, whether the first or second segments or other portions of the film have stretch-induced molecular orientation is measured with a retardance imaging system available from Lot-Oriel GmbH & Co., Darmstadt, Germany, under the trade designation “LC-PolScope” on a microscope available from Leica Microsystems GmbH, Wetzlar, Germany, under the trade designation “DMRXE” and a digital CCD color camera available from Qlmaging, Surrey, BC, Canada, under the trade designation “RETIGA EXi FAST 1394”. The microscope is equipped with a 546.5 nm interference filter obtained from Cambridge Research & Instrumentation, Inc., Hopkinton, Mass., and a 10×/0.25 objective. The degree of birefringence in an oriented film portion is typically observed to be higher in a film that has been stretched to the point of plastic deformation than in a film that only has melt-induced orientation in the machine direction. The difference in degree of birefringence between stretch-induced molecular orientation and melt-induced orientation would be understood by a person skilled in the art.

A variety of polymeric compositions are useful in any of the methods described above for making films comprising first and second segments. The mass flow (or volume flow) of the different polymeric compositions can be equal or unequal as they are respectively extruded. In some embodiments, it is desirable for the melt strengths of the different polymeric compositions to be similar. Polymeric compositions useful for the first and second segments (e.g., including core and sheath regions or various layers within the first and second segments) may be selected, for example, based on their compatibility and mutual adhesion properties.

In some embodiments, the polymeric compositions that may be extruded to make a film comprising first and second segments are thermoplastic polymeric compositions (e.g., polyolefins (e.g., polypropylene, polypropylene copolymers, polyethylene, and polyethylene copolymers), polyvinyl chloride, polystyrenes and polystyrene block copolymers, nylons, polyesters (e.g., polyethylene terephthalate), polyurethanes, polyacrylates, silicone polymers, and copolymers and blends thereof). However, polymeric materials that can be crosslinked (e.g., by heat or radiation) may also be useful for some embodiments. When a heat curable resin is used, a die described in any of the above methods can be heated to start the cure so as to adjust the viscosity of the polymeric material and/or the pressure in the corresponding die cavity.

The first segments in a film comprising alternating first and second segments are typically made from a first polymeric composition. The first polymeric composition can be relatively less elastic than the elastic polymeric composition in the second segments. The first polymeric composition can also be inelastic as defined above. The first polymeric composition can be formed, for example, of semicrystalline or amorphous polymers or blends. Inelastic polymers can be polyolefinic, formed predominantly of polymers such as polyethylene, polyethylene copolymers, polypropylene, polypropylene copolymers, polybutylene, or polyethylene-polypropylene copolymers. In some embodiments, the first polymeric composition comprises polypropylene, polyethylene, polypropylene-polyethylene copolymer, or blends thereof.

In the films comprising alternating first and second segments, second segments comprise an elastic polymeric composition that is more elastic than the first polymeric composition described above. The elastic polymeric composition is also selected so that the force required to stretch the second segments in the cross-machine direction is less than the force required to stretch the first segments. An elastic polymeric composition may be selected, for example, such that a film of the elastic polymeric composition (such as a film that is 0.002 mm to 0.5 mm thick) has an elongation of at least 200 percent at room temperature. Examples of useful elastic polymeric compositions include thermoplastic elastomers such as ABA block copolymers, polyurethane elastomers, polyolefin elastomers (e.g., metallocene polyolefin elastomers), olefin block copolymers, polyamide elastomers, ethylene vinyl acetate elastomers, and polyester elastomers. An ABA block copolymer elastomer generally is one where the A blocks are polystyrenic, and the B blocks are conjugated dienes (e.g., lower alkylene dienes). The A block is generally formed predominantly of substituted (e.g, alkylated) or unsubstituted styrenic moieties (e.g., polystyrene, poly(alphamethylstyrene), or poly(t-butylstyrene)), having an average molecular weight from about 4,000 to 50,000 grams per mole. The B block(s) is generally formed predominantly of conjugated dienes (e.g., isoprene, 1,3-butadiene, or ethylene-butylene monomers), which may be substituted or unsubstituted, and has an average molecular weight from about 5,000 to 500,000 grams per mole. The A and B blocks may be configured, for example, in linear, radial, or star configurations. An ABA block copolymer may contain multiple A and/or B blocks, which blocks may be made from the same or different monomers. A typical block copolymer is a linear ABA block copolymer, where the A blocks may be the same or different, or a block copolymer having more than three blocks, predominantly terminating with A blocks. Multi-block copolymers may contain, for example, a certain proportion of AB diblock copolymer, which tends to form a more tacky elastomeric film segment. Other elastic polymers can be blended with block copolymer elastomers, and various elastic polymers may be blended to have varying degrees of elastic properties.

The elastic polymeric composition can include many types of thermoplastic elastomers that are commercially available, including those from BASF, Florham Park, N.J., under the trade designation “STYROFLEX”, from Kraton Polymers, Houston, Tex., under the trade designation “KRATON”, from Dow Chemical, Midland, Mich., under the trade designation “PELLETHANE”, “INFUSE”, VERSIFY″, or “NORDEL”, from DSM, Heerlen, Netherlands, under the trade designation “ARNITEL”, from E. I. duPont de Nemours and Company, Wilmington, Del., under the trade designation “HYTREL”, from ExxonMobil, Irving, Tex. under the trade designation “VISTAMAXX”, and more.

The elastic polymeric composition can also include a blend of any of the elastomers described above and any of the polymers described above in the first polymeric composition. Similarly, the first polymeric composition may include a blend of relatively less elastic polymers and relatively more elastic polymers, as long as the elastic polymeric composition is more elastic than the first polymeric composition in the first segments. Generally, the first and elastic polymeric compositions should be selected so that the tensile modulus of the first segments is higher than the tensile modulus of the second segments. Less force will then be required to stretch the second segments, and as a result, the second segments will stretch first, allowing the apertures in the first segments to remain unstretched.

As described above, the first and elastic polymeric compositions can be selected based at least partially on their compatibility and mutual adhesion properties. Compatibility and adhesion between segments can be evaluated by a hang shear evaluation. The hang shear evaluation is carried out by hanging a 200-gram weight on a 2.54 cm long sample (measured in the longitudinal direction of the segments) having 3.8 cm exposed sample in the width direction. The evaluation is carried out at 100° F. (38° C.), and the time until the static load breaks the film is determined. The film is positioned so that the load is applied in the film width or cross-direction (that is, in a direction transverse to the longitudinal direction of the first and second segments). In some embodiments, the time to failure in a hang shear evaluation is at least 100 minutes, in some embodiments, at least 500 minutes, and in some embodiments, at least 1000 minutes. The time to failure in a hang shear evaluation may be influenced by a variety of factors. For example, for different first polymeric compositions, the elastic polymeric compositions that will provide the desired hang shear strength may be different. The presence of any plasticizers or compatibilizers may affect the hang shear strength. At least for these reasons, it is impractical to describe each composition that may provide a hang shear time of at least 100 minutes. A time to failure in a hang shear evaluation of at least 100 minutes (in some embodiments at least 500 or 1000 minutes) may be useful for evaluating, for example, films according to the present disclosure which are designed to be extended in the width or cross-direction of the film during use. However, lower time to failure may be useful in films, for example, which are designed to be extended in the longitudinal direction of the film after the film undergoes plastic deformation of relatively inelastic segments as described in further detail below.

For some embodiments, the first polymeric composition comprises polypropylene, and the elastic polymeric composition is selected such that it bonds well to polypropylene. In some of these embodiments, the elastic polymeric composition is a thermoplastic elastomer, for example, an ABA triblock copolymer elastomer or an ABAD tetrablock copolymer. In some embodiments, the elastic polymeric composition is an ABA triblock copolymer of styrene or substituted styrene as the A blocks and hydrogenated polybutadiene, hydrogenated polyisoprene, or a combination of hydrogenated polybutadiene and polyisoprene as the B block. The hydrogenated B block can therefore include polyethylene, polypropylene, and polybutylene moieties. Typically the time to failure in a hang shear evaluation of a film having second segments including such an elastic polymeric composition and first segments comprising polypropylene is at least 100 minutes (in some embodiments at least 500 or 1000 minutes). The polystyrene units in the ABA triblock copolymer may be present in a range from 20 to 60 percent or in a range from 25 to 45 percent by weight, based on the total weight of the ABA triblock copolymer. The hydrogenated conjugated diene units in the ABA triblock copolymer may be present in a range from 40 to 80 percent or in a range from 55 to 75 percent by weight, based on the total weight of the ABA triblock copolymer. The hydrogenated polyisoprene, when present, may be present in an amount up to 15, 10, or 5 percent by weight, based on the total weight of the ABA triblock copolymer. The weight average molecular weight of the ABA triblock copolymer may be in a range from 75,000 to 250,000 grams per mole, or 150,000 to 220,000 grams per mole. The number average molecular weight of the ABA triblock copolymer may be in a range from 50,000 to 200,000 grams per mole, or 120,000 to 200,000 grams per mole. Weight and number average molecular weights can be measured, for example, by gel permeation chromatography (i.e., size exclusion chromatography) using techniques known to one of skill in the art.

A third polymeric composition, which may be at one or both major surfaces of the second segments, may be the same as or different from the first polymeric composition. The third polymeric composition may be selected so that the elastic polymeric composition is also more elastic than the third polymeric composition. The third polymeric composition can be useful, for example, for protecting the elastic polymeric composition during manufacture or use and/or providing a less tacky surface on the elastic polymeric composition. If the third polymeric composition is selected such that it is softer than the first polymeric composition, the force required to initially stretch the film in the width “x” direction may be less than when the third polymeric compositions is a relatively more inelastic matrix.

In embodiments of the film or method disclosed herein that include a first polymeric composition, an elastic polymeric composition, and a third polymeric composition that is different from the first polymeric composition, blending may be useful for making a third polymeric composition that is relatively more elastic than the first polymeric composition but relatively less elastic than the elastic polymeric composition from which at least the first layers of the layered second segments are made. In some embodiments, the third polymeric composition comprises a blend of the first polymeric composition and the elastic polymeric composition. In these embodiments, the third polymeric composition generally has good compatibility with and good adhesion to both the first polymeric composition and the elastic polymeric composition. In some embodiments, the third polymeric composition may be a blend of an elastic resin and an inelastic resin but may not contain the resins in the first or elastic polymeric compositions.

In some embodiments, compatibilizers added to at least one of the second or third polymeric compositions may be useful. A compatibilizer may be useful, for example, for increasing the elongation of an elastic film, lowering the force required to stretch the film, and modifying the thicknesses of the second segments. Examples of suitable compatibilizers include hydrogenated cycloaliphatic resins, hydrogenated aromatic resins, and combinations thereof. For example, some compatibilizers are hydrogenated C9-type petroleum resins obtained by copolymerizing a C9 fraction produced by thermal decomposition of petroleum naphtha, hydrogenated C5-type petroleum resins obtained by copolymerizing a C5 fraction produced by thermal decomposition of petroleum naphtha, or hydrogenated C5/C9-type petroleum resins obtained by polymerizing a combination of a C5 fraction and C9 fraction produced by thermal decomposition of petroleum naphtha. The C9 fraction can include, for example, indene, vinyltoluene, alpha-methylstyrene, beta-methylstyrene, or a combination thereof. The C5 fraction can include, for example, pentane, isoprene, piperine, 1,3-pentadiene, or a combination thereof. Other compatibilizers include hydrogenated poly(cyclic olefin) polymers. Examples of hydrogenated poly(cyclic olefin) polymers include hydrogenated petroleum resins; hydrogenated terpene-based resins (for example, resins commercially available under the trade designation “CLEARON”, in grades P, M and K, from Yasuhara Chemical, Hiroshima, Japan); hydrogenated dicyclopentadiene-based resins (for example, those available from Kolon Industries, South Korea, under the trade designation “SUKOREZ”; a hydrogenated C5-type petroleum resin obtained by copolymerizing a C5 fraction such as pentene, isoprene, or piperine with 1,3-pentadiene produced through thermal decomposition of petroleum naphtha available, for example, from Exxon Chemical Co., Irving, Tex., under the trade designations “ESCOREZ 5300” or “ESCOREZ 5400”; and from Eastman Chemical Co., Kingsport, Tenn., under the trade designation “EASTOTAC H”); partially hydrogenated aromatic modified dicyclopentadiene-based resins commercially available, for example, from Exxon Chemical Co. under the trade designation “ESCOREZ 5600”; resins resulting from hydrogenation of a C9-type petroleum resin obtained by copolymerizing a C9 fraction such as indene, vinyltoluene and α- or β-methylstyrene produced by thermal decomposition of petroleum naphtha available, for example, from Arakawa Chemical Industries Co., Ltd. under the trade designations “ARCON P” or “ARCON M”; and resins resulting from hydrogenation of a copolymerized petroleum resin of the above-described C5 fraction and C9 fraction available, for example, from Idemitsu Petrochemical Co., Tokyo, Japan, under the trade designation “IMARV”. In some embodiments, the hydrogenated poly(cyclic olefin) is a hydrogenated poly(dicyclopentadiene). Other examples of useful compatibilizers can be found in U.S. Pat. No. 4,787,897 (Torimae et al.) and U.S. Pat. No. 6,669,887 (Hilston et al.). The compatibilizer is typically amorphous and has a weight average molecular weight up to 5000 grams per mole to preserve compatibility with the elastomeric resin. The molecular weight is often up to 4000 grams per mole, 2500 grams per mole, 2000 grams per mole, 1500 grams per mole, 1000 grams per mole, or up to 500 grams per mole. In some embodiments, the molecular weight is in the range of 200 to 5000 gram per mole, in the range of 200 to 4000 grams per mole, in the range of 200 to 2000 grams per mole, or in the range of 200 to 1000 gram per mole. When present, the compatibilizer may be in the second or third polymeric composition in a range from 15 percent to 30 percent by weight (in some embodiments, 15 to 25 percent by weight) based on the total weight of the second or third polymeric composition.

In some embodiments, polymeric materials used to make films useful for practicing the present disclosure may comprise a colorant (e.g., pigment and/or dye) for functional (e.g., optical effects) and/or aesthetic purposes (e.g., each has different color/shade). The pigment or die can also be useful as described above for absorbing light at a selected wavelength. Suitable colorants are those known in the art for use in various polymeric compositions. Examples of colors imparted by the colorant include white, black, red, pink, orange, yellow, green, aqua, purple, and blue. In some embodiments, it is desirable level to have a certain degree of opacity for one or more of the polymeric compositions. The amount of colorant(s) to be used in specific embodiments can be readily determined by those skilled in the art (e.g., to achieve desired color, tone, opacity, transmissivity, etc.).

In some embodiments, at least a portion of the film to be apertured according to the present disclosure include microvoids. In some embodiments, the first segments include microvoids. Microvoiding can be included in the film using a variety of methods. In some embodiments, microvoiding can be introduced into the first segments by beta-nucleation of semi-crystalline polyolefins. Certain heterogeneous nuclei, typically known as beta-nucleating agents, act as foreign bodies in a crystallizable polymer melt. When the polymer cools below its crystallization temperature (e.g., a temperature in a range from 60° C. to 120° C. or 90° C. to 120° C.), the loose coiled polymer chains orient themselves around the beta-nucleating agent to form beta-phase regions. The beta form of polypropylene is a meta-stable form, which can be converted to the more stable alpha form by thermal treatment and/or applying stress. Microvoids can be formed in various amounts when the beta-form of polypropylene is stretched under certain conditions; see, e.g., Chu et al., “Microvoid formation process during the plastic deformation of β-form polypropylene”, Polymer, Vol. 35, No. 16, pp. 3442-3448, 1994, and Chu et al., “Crystal transformation and micropore formation during uniaxial drawing of β-form polypropylene film”, Polymer, Vol. 36, No. 13, pp. 2523-2530, 1995. Typically the semi-crystalline polyolefin comprises polypropylene. It should be understood that a semi-crystalline polyolefin comprising polypropylene may be a polypropylene homopolymer or a copolymer containing propylene repeating units. The copolymer may be a copolymer of propylene and at least one other olefin (e.g., ethylene or an alpha-olefin having from 4 to 12 or 4 to 8 carbon atoms). Copolymers of ethylene, propylene and/or butylenes may be useful. In some embodiments, the copolymer contains up to 90, 80, 70, 60, or 50 percent by weight of polypropylene. In some embodiments, the copolymer contains up to 50, 40, 30, 20, or 10 percent by weight of at least one of polyethylene or an alpha-olefin. The semi-crystalline polyolefin may also be part of a blend of thermoplastic polymers that includes polypropylene. Suitable thermoplastic polymers include crystallizable polymers that are typically melt processable under conventional processing conditions. That is, on heating, they will typically soften and/or melt to permit processing in conventional equipment, such as an extruder, to form a sheet.

In some embodiments, the beta-nucleating agent is selected from the group consisting of gamma-quinacridone, a calcium salt of suberic acid, a calcium salt of pimelic acid and calcium and barium salts of polycarboxylic acids. In some embodiments, the beta-nucleating agent is quinacridone colorant Permanent Red E3B, which is also referred to as Q-dye. In some embodiments, the beta-nucleating agent is formed by mixing an organic dicarboxylic acid (e.g., pimelic acid, azelaic acid, o-phthalic acid, terephthalic acid, and isophthalic acid) and an oxide, hydroxide, or acid salt of a Group II metal (e.g., magnesium, calcium, strontium, and barium). So-called two component initiators include calcium carbonate combined with any of the organic dicarboxylic acids listed above and calcium stearate combined with pimelic acid. In some embodiments, the beta-nucleating agent is aromatic tri-carboxamide as described in U.S. Pat. No. 7,423,088 (Mäder et al.). A convenient way of incorporating beta-nucleating agents into a semi-crystalline polyolefin useful for making a microporous film disclosed herein is through the use of a concentrate. The level of beta-spherulites in the semi-crystalline polyolefin can be determined, for example, using X-ray crystallography and Differential Scanning Calorimetry (DSC). By DSC, melting points and heats of fusion of both the alpha phase and the beta phase can be determined in a microporous film useful for practicing the present disclosure. For semi-crystalline polypropylene, the melting point of the beta phase is lower than the melting point of the alpha phase (e.g., by about 10 to 15 degrees Celsius). The ratio of the heat of fusion of the beta phase to the total heat of fusion provides a percentage of the beta-spherulites in a sample. The level of beta-spherulites can be at least 10, 20, 25, 30, 40, or 50 percent, based on the total amount of alpha and beta phase crystals in the film. These levels of beta-spherulites may be found in the film before it is stretched.

In some embodiments, the film useful for practicing the present disclosure in any of its embodiments is formed using a thermally induced phase separation (TIPS) method. This method of making the microvoided film typically includes melt blending a crystallizable polymer and a diluent (e.g., mineral oil, mineral spirits, dioctylphthalate, liquid paraffins, paraffin wax, glycerin, petroleum jelly, polyethylene oxide, polypropylene oxide, polytetramethylene oxide, soft carbowax, and combinations thereof) to form a melt mixture. The melt mixture is then formed into a film and cooled to a temperature at which the polymer crystallizes, and phase separation occurs between the polymer and diluent, forming voids. The voided film may have some degree of opacity. A nucleating agent may be useful in the first polymeric composition to facilitate crystallization. In some embodiments, the nucleating agent is a beta-nucleating agent described above. The quantity of diluent is typically in a range from about 20 parts to 70 parts, 30 parts to 70 parts, or 50 parts to 65 parts by weight, based upon the total weight of the polymer and diluent. In this manner a film is formed that comprises an aggregate of crystallized polymer in the diluent compound. Accordingly, in some embodiments, the first segments comprise a first polymeric composition comprising a polymer and a diluent that is miscible with the polymer at a temperature above a melting temperature of the polymer but that phase separates from the polymer at a temperature below a crystallization temperature of the polymer. The term “melting temperature” refers to the temperature at which the polymer in a blend that contains polymer and diluent will melt. The term “crystallization temperature” refers to the temperature at which the polymer in the blend will crystallize. The melting and crystallization temperature of a thermoplastic polymer, in the presence of a diluent and other additives, is influenced by both a phase equilibrium and a dynamic effect. At equilibrium between liquid and crystalline polymer phases, thermodynamics require that the chemical potentials of the polymer repeating unit in the two phases be equal. The temperature at which this condition is satisfied is referred to as the melting temperature, which will depend upon the composition of the melt mixture. The crystallization temperature and melting temperature are typically equivalent at equilibrium. However, at non-equilibrium conditions, which are normally the case, the crystallization temperature and melting temperature depend on the external cooling rate and heating rate, respectively. Consequently, the terms “melting temperature” and “crystallization temperature,” when used herein, are intended to include the equilibrium effect (i.e., the polymer/diluent system melts and crystallizes at the same temperature) as well as the dynamic effect of the rate of heating or cooling. The term “equilibrium melting point” refers to the commonly accepted melting temperature of the pure polymer, as may be available in published references.

In some embodiments, following formation of the crystallized polymer, the porosity of the material is increased by at least one of stretching the film in at least one direction or removing at least some of the diluent. This step results in a network of interconnected micropores. This step also permanently attenuates the polymer to form fibrils connecting the plurality of particles, imparting strength and porosity to the film. Pore sizes achieved from this method can range from about 0.2 micron to about 5 microns. The diluent can be removed from the material either before or after stretching. In some embodiments, the diluent is not removed. In some of these embodiments, the diluent can be useful as a plasticizer for the elastic polymeric composition in the second segments. The presence of the diluent may eliminate the need for other plasticizers in the elastic polymeric compositions, described below.

In some embodiments, the film useful for aperturing has microvoids formed using particulate cavitating agents. Such cavitating agents are incompatible or immiscible with the polymeric matrix material and form a dispersed phase within the polymeric core matrix material before extrusion and orientation of the film. When such a polymer substrate is subjected to uniaxial or biaxial stretching, a void or cavity forms around the distributed, dispersed-phase moieties, providing a film having a matrix filled with numerous cavities that provide an opaque appearance due to the scattering of light within the matrix and cavities. The particulate cavitating agents may be inorganic or organic. Organic cavitating agents generally have a melting point that is higher than the melting point of the film matrix material. Useful organic cavitating agents include polyesters (e.g., polybutylene teraphthalate or nylon such as nylon-6), polycarbonate, acrylic resins, and ethylene norbornene copolymers. Useful inorganic cavitating agents include talc, calcium carbonate, titanium dioxide, barium sulfate, glass beads, glass bubbles (that is, hollow glass spheres), ceramic beads, ceramic bubbles, and metal particulates. The particle size of cavitating agents is such that at least a majority by weight of the particles comprise an overall mean particle diameter, for example, of from about 0.1 micron to about 5 microns, in some embodiments, from about 0.2 micron to about 2 microns. (The term “overall” refers to size in three dimensions; the term “mean” is the average.) The cavitating agent may be present in the first polymeric composition, for example, in an amount of from about 2 weight percent to about 40 weight percent, about 4 weight percent to about 30 weight percent, or about 4 weight percent to about 20 weight percent, based upon the total weight of the polymer and cavitating agent. Some of these cavitating agents are also useful for absorbing light at the selected wavelength.

Films useful for practicing the present disclosure are typically extensible in the cross-machine direction (which is typically transverse to the direction of the longitudinally extending first and second segments), and less extensible in the machine direction. In some embodiments, the film disclosed herein has an elongation of at least 75 (in some embodiments, at least 100, 200, 250, or 300) percent and up to 1000 (in some embodiments, up to 750 or 500) percent). In some embodiments, films disclosed herein will sustain only small permanent set following deformation and relaxation (in some embodiments, less than 25, 20, or even less than 10 percent) of the original length after 100% elongation at room temperature.

In films according to the present disclosure and/or made according to the method of the present disclosure, the first and second segments each have a length, width, and height, wherein the length is the longest dimension and the thickness is the smallest dimension. In some embodiments, the width of each of the first and second segments is up to five millimeters. The width of the first and second segments is typically at least 100 micrometers (in some embodiments, at least 150 micrometers or 200 micrometers). In some embodiments, the widths of the second segments, which may include an elastic polymeric composition, in films disclosed herein are less than 1 millimeter (mm) (in some embodiments, up to 750 micrometers, 650 micrometers, 500 micrometers, or 400 micrometers). For example, the second segments may be in a range from 100 micrometers to less than 1 mm, 100 micrometers to 750 micrometers, 150 micrometers to 750 micrometers, 150 micrometers to 500 micrometers, or 200 micrometers to 600 micrometers wide.

In some embodiments, the films disclosed herein have first segments with widths up to 2 mm (in some embodiments, up to 1.5 mm, 1 mm or 750 micrometers). In some embodiments, the first segments are at least 100 micrometers, 150 micrometers, 250 micrometers, 350 micrometers, 400 micrometers, or 500 micrometers wide. For example, the first segments may be in a range from 250 micrometers to 1.5 mm, 100 micrometers to 1 mm, or 350 micrometers to 1 mm wide. As used herein, the width of the first and second segments is the dimension measured in the film's width direction “x”.

While the apparatus and method of making films disclosed herein are capable of extruding segments with widths up to 2 mm or 1 mm, such films could not practically be achieved by extrusion from apparatuses having continuous width flow channels up to 2 mm or 1 mm wide and at least 5 cm or 7.5 cm in length such as those described in Int. Pat. App. Pub. No. WO 2010/099148 (Hoium et al.). The pressure drop at the dispensing edge would limit the extrusion rates to less than 0.1 meters per minute, at least ten times slower than the extrusion rates achievable from the apparatus and method disclosed herein.

In some embodiments of the film disclosed herein, the distance between midpoints of two first segment separated by one second segment is up to 3 mm, 2.5 mm, or 2 mm. In some embodiments, the distance between midpoints of two first segments separated by one second segment is at least 300 micrometers, 350 micrometers, 400 micrometers, 450 micrometers, or 500 micrometers. In some embodiments, the distance between midpoints of two first segments separated by one second segment is in a range from 300 micrometers to 3 mm, 400 micrometers to 3 mm, 500 micrometers to 3 mm, 400 micrometers to 2.5 mm, or 400 micrometers to 2 mm.

The films disclosed herein in any of its embodiments may have a variety of useful thicknesses, depending on the desired use. In some embodiments, the film may be up to about 250 micrometers, 200 micrometers, 150 micrometers, or 100 micrometers thick. In some embodiments, the film may be at least about 10 micrometers, 25 micrometers, or 50 micrometers thick. For example, the thickness of the film may be in a range from 10 micrometers to 250 micrometers, from 10 micrometers to 150 micrometers, or from 25 micrometers to 100 micrometers thick. In some embodiments, the thickness of the first segments is within about 20%, 10%, or 5% of the thickness of the second segments. In these cases, the first segments may be said to have substantially the same thickness as the second segments. This may be useful, for example, for lowering the force to initially stretch the film, to maximize the elongation, and to lower the hysteresis of the film. In other embodiments, the thickness of the elastic segments may be at least 50%, 100%, 150%, or more higher than the first segments. This may be useful, for example, to provide a pleasing tactile ribbed texture to the film surface or to promote bonding predominantly to the elastic segments. The melt viscosities and/or die swells of the selected resins influence the thicknesses of the first and second segments. Resins may be selected for their melt viscosities, or, in some embodiments, a tackifier or other viscosity-reducing additive may be useful to decrease the melt viscosity of the resin, for example, a third polymeric composition used in a layer or sheath as described above. Die designs may also produce varying thicknesses of the film (e.g., by having a dispensing orifice that varies in size).

In first or second segments including layers or sheaths as described above, the second, third, fifth, and sixth layers described above in connection with FIGS. 4 to 7 or the sheath described above in connection with FIG. 8, when present, may be in a range from 0.2 micrometers to 20 micrometers, from 1 micrometers to 15 micrometers, or from 3 micrometers to 10 micrometers thick. Layers and sheaths at the major surfaces of the second segments, for example, having these dimensions may be useful to allow facile elongation of the film according to the present disclosure. In some embodiments, the thicknesses of these layers are not uniform across the width of the layered segments.

In some embodiments of the films disclosed herein, the density of the second segments, which may include a relatively more elastic polymeric composition, can vary across the web. This can be accomplished, for example, if sequences of shims in the die described herein include varying frequency of shim sequences providing the second segments. In some embodiments, it may be desirable to have a higher density of such second segments toward the center of the film. In other words, the distance between midpoints of successive first segments may or may not be identical. Measuring the distance between midpoints between successive first segments is convenient; however, distance could also be measured between any point of one first segment to a corresponding point in the next first segment of the film. In some embodiments, across a film there is an average of distances between midpoints of two first segments separated by one second segment, and for any two given first segments separated by one second segment, the distance is within 20 (in some embodiments, 15, 10, or 5) percent of the average of these distances across the film.

Measurements of the widths and/or thicknesses of first and second segments (e.g., including the first, second, and optionally third layers) or distances between two corresponding points on successive first or second segments may be made, for example, by optical microscopy. Optical microscopy is also useful to determine volume percentage of the first and second segments. In some embodiments, the first segments make up a higher volume percentage than the second segments. In some embodiments, the first segments make up a range of about 51% to 85% of the volume of the film, and the second segments make up a range of about 15% to 49% of the volume of the film. In some embodiments, the first segments make up a range of about 55% to 80% of the volume of the film, and the second segments make up a range of about 20% to 45% of the volume of the film.

Films according to and/or prepared using the method according to the present disclosure can be made with a variety of basis weights. For example, the basis weight of the film as extruded may be in a range from 15 grams per square meter to 100 grams per square meter. In some embodiments, the basis weight of the film is in a range from 20 grams per square meter to 60 grams per square meter. After the film is stretched, it may have a basis weight lower than 15 grams per square meter. It is useful that in these films, elastomeric polymers can make a relatively low contribution to the basis weight and yet useful elastic properties are achieved in the films and film articles. In some embodiments, the elastomeric polymers contribute up to 25, 20, 15, or 10 grams per square meter to the basis weight of the film. In some embodiments, elastomeric polymers contribute in a range from 3 to 10 grams per square meter to the basis weight of the film. The typically low amount of elastomeric polymer in the films and film articles described herein provides a cost advantage over elastic films in which elastomeric polymers make a higher contribution to the basis weight of the films.

In some embodiments of the films disclosed herein, the first segments, which contain the first polymeric composition that is relatively less elastic than the elastic polymeric composition, have molecular orientation resulting from stretching. In some of these embodiments, the first segments have stretch-induced molecular orientation in a width direction “x” caused by permanent plastic deformation. To achieve the permanent deformation, the film may be stretched to at least 500 (in some embodiments, at least 600 or 750) percent, depending on the elongation of the film. In these embodiments, the films disclosed herein can provide a “dead-stop” elastic film, in which the force required for extension rises rapidly during the last portion of extension.

In some embodiments, the films disclosed herein are stretched-activated in the longitudinal direction of the first and second segments. In some of these embodiments, the first segments have stretch-induced molecular orientation in a longitudinal direction “y” caused by permanent plastic deformation. To achieve the permanent deformation, the film may be stretched to at least 200 (in some embodiments, at least 300, 400, or 500) percent or more. When the elastic second segments relax after stretching, the stretched first segments are shined to form a textured surface. Such texture may eliminate the need for laminating the elastic film to a fibrous (e.g., nonwoven) carrier, especially if soft-feeling resins are used to make the film. Accordingly, in some embodiments, the film disclosed herein is not joined to a carrier. Furthermore, after stretching in the “y” direction, the films are remarkably strong in this direction. The process of stretching the relatively inelastic first segments in the machine direction can orient or tensilize those segments, offering strength and robustness during manufacturing line processing and in the end-use applications of the films.

In some embodiments where the film disclosed herein is not joined to a carrier, particles may be applied to one or both major surfaces of the film to provide a matte finish. In some embodiments, the film disclosed herein may be flocked with a fibrous material, such as any of those described below, to give the film a soft feeling without joining it to a carrier. In other embodiments, pattern-embossing the film on one or both major surfaces can provide an appearance or feeling of a fibrous material.

In laminates according to the present disclosure, the film disclosed herein is joined to a carrier. One or both major surfaces of the film may be joined to a carrier. The method disclosed herein further comprises joining a surface of the film to a carrier or joining both major surfaces of the film to a carrier. The carrier on opposite sides of the film may be the same or different. The film may be joined to a carrier, for example, by lamination (e.g., extrusion lamination), adhesives (e.g., hot melt or pressure sensitive adhesives), or other bonding methods (e.g., ultrasonic bonding, thermal bonding, compression bonding, or surface bonding). The film may be provided with apertures before, during, or after lamination.

The film and the carrier may be substantially continuously bonded or intermittently bonded. “Substantially continuously bonded” refers to being bonded without interruption in space or pattern. Substantially continuously bonded laminates can be formed by laminating a carrier to a substantially continuous film upon extrusion of the film; passing the film and the fibrous web between a heated smooth surfaced roll nip if at least one of them is thermally bondable; or applying a substantially continuous adhesive coating or spray to one of the film or carrier before bringing it in contact with the other of the film or carrier. “Intermittently bonded” can mean not continuously bonded and refers to the film and the carrier being bonded to one another at discrete spaced apart locations or being substantially unbonded to one another in discrete, spaced apart areas. Intermittently bonded laminates can be formed, for example, by passing the film and the carrier through a heated patterned embossing roll nip if at least one of them is heat bondable, or by applying discrete, spaced apart areas of adhesive to one of the film or the carrier before bringing it into contact with the other of the film or the carrier. An intermittently bonded laminate can also be made by feeding an adhesively coated aperture ply or scrim between the film and the carrier.

In some embodiments, the chemical compositions in the first and second segments differ at the surface of the film. The ability to select different compositions for the second and third layers or sheath of the second segments, for example, and the first segments offers the ability to bond selectively to either the first or second segments as desired. For example, a hot melt adhesive in at least one of the second and third layers in the second segments or fifth and sixth layers of the first segments can offer selective bonding to the desired segments. In some embodiments, the carrier is bonded predominantly to the first segments, which are relatively less elastic than the second segments. When a carrier is said to bond predominantly to either the first or second segments, it means that greater than 50, 60, 75, or 90 percent of the bonded area of the film is found in one of these locations but not in the other. Bonding predominantly to the first segments can be achieved, for example, through the selected materials for the first and second segments, through the geometry (e.g., height) of the first and second segments, or a combination of these. The first polymeric composition may be selected, for example, to have a similar chemical composition and/or molecular weight as the carrier to be bonded. Matching chemical composition and/or molecular weight for the bonding of two materials may be useful, for example, for thermal bonding, ultrasonic bonding, and compression bonding methods among others. An additive to the second or third layers in the second segments could be used to make it less receptive to bonding. For example, extrudable release materials, or lower surface energy materials than in the first segments, could be employed. In some embodiments, the first segments include fifth and sixth layers comprising a hot melt adhesive, and the second segments include second and third layers comprising a material that may be a non-adhesive or a material resistant to bonding (e.g., a soft polypropylene). The ability to preferentially bond to either the first or second segments using selection of materials may be more difficult in films, for example, in which multiple strands of one polymer are embedded within a continuous matrix of another polymer.

In laminates according to the present disclosure, the carrier may comprise a variety of suitable materials including woven webs, non-woven webs (e.g., spunbond webs, spunlaced webs, airlaid webs, meltblown web, and bonded carded webs), textiles, nets, and combinations thereof. In some embodiments, the carrier is a fibrous material (e.g., a woven, nonwoven, or knit material). The term “nonwoven” when referring to a carrier or web means having a structure of individual fibers or threads which are interlaid, but not in an identifiable manner as in a knitted fabric. Nonwoven fabrics or webs can be formed from various processes such as meltblowing processes, spunbonding processes, spunlacing processes, and bonded carded web processes. In some embodiments, the carrier comprises multiple layers of nonwoven materials with, for example, at least one layer of a meltblown nonwoven and at least one layer of a spunbonded nonwoven, or any other suitable combination of nonwoven materials. For example, the carrier may be a spunbond-meltbond-spunbond, spunbond-spunbond, or spunbond-spunbond-spunbond multilayer material. Or, the carrier may be a composite web comprising a nonwoven layer and a dense film layer.

Fibrous materials that provide useful carriers may be made of natural fibers (e.g., wood or cotton fibers), synthetic fibers (e.g., thermoplastic fibers), or a combination of natural and synthetic fibers. Exemplary materials for forming thermoplastic fibers include polyolefins (e.g., polyethylene, polypropylene, polybutylene, ethylene copolymers, propylene copolymers, butylene copolymers, and copolymers and blends of these polymers), polyesters, and polyamides. The fibers may also be multi-component fibers, for example, having a core of one thermoplastic material and a sheath of another thermoplastic material.

Useful carriers may have any suitable basis weight or thickness that is desired for a particular application. For a fibrous carrier, the basis weight may range, e.g., from at least about 5, 8, 10, 20, 30, or 40 grams per square meter, up to about 400, 200, or 100 grams per square meter. The carrier may be up to about 5 mm, about 2 mm, or about 1 mm in thickness and/or at least about 0.1, about 0.2, or about 0.5 mm in thickness. In some embodiments in which both major surfaces of the film are bonded to a fibrous carrier, it is sometimes advantageous if one fibrous carrier has a higher basis weight than the other.

Lamination of a film disclosed herein to one or more carriers may be carried out while the film is being stretched in its width “x” direction, while the film is being stretched in its longitudinal “y” direction, while the film is being stretched in both its width “x” and longitudinal “y” direction, or while not being stretched. Stretching the film may be carried out according to any of the methods described above. In some embodiments, machine direction stretching is carried out with differential speed rolls operating at increasingly greater speeds the further downweb they are located. Any number of two or more rolls may be useful. The speed may increase linearly or nonlinearly from one roll to the next. In other embodiments, differential speed rolls may deliver pulsed stretching. For example, a center roll may operate at a slower speed than rolls upweb and downweb, causing the film to go through sequences of stretch and recovery. The distance between adjacent rolls can be the same or different although the horizontal gap between rolls must be greater than the thickness of the film. The diameters of differential speed rolls can be the same or different. Upon stretching, lamination can be used to join one or two fibrous layers. Stretching films with side-by-side elastic and relatively inelastic segments beyond a point of plastic deformation just before lamination has several advantages. It is only when such films are stretched beyond the plastic deformation limit of the inelastic segments that the film can become elastic. As long as the tension on the films disclosed herein on a manufacturing line is below that required to exceed the deformation limit, the film is not likely to prematurely stretch on the manufacturing line. Also, the process of stretching the relatively inelastic first segments in the machine direction can orient or tensilize those segments, offering strength and robustness during manufacturing line processing and in the end-use applications of the laminates.

In some embodiments, including those embodiments described above that include stretching before lamination, laminates according to the present disclosure are prepared by ultrasonic bonding. Ultrasonic bonding generally refers to a process performed, for example, by passing layers between a sonic horn and a patterned roll (e.g., anvil roll). Such bonding methods are well-known in the art. For instance, ultrasonic bonding through the use of a stationary horn and a rotating patterned anvil roll is described in U.S. Pat. No. 3,844,869 (Rust Jr.) and U.S. Pat. No. 4,259,399 (Hill). Ultrasonic bonding through the use of a rotary horn with a rotating patterned anvil roll is described, for example, in U.S. Pat. No. 5,096,532 (Neuwirth, et al.); U.S. Pat. No. 5,110,403 (Ehlert); and U.S. Pat. No. 5,817,199 (Brennecke, et al.). Other ultrasonic bonding techniques may also be useful. In embodiments in which the film is stretched using differential speed rolls as described above, the patterned roll and furthest downweb differential speed roll may operate at the same speed. Or, in other embodiments, the patterned roll acts as an extension of the differential speed rolls, for example, and operate at an increased speed than the differential speed rolls. Apertures can be formed in the first segments of the film during ultrasonic bonding.

In some embodiments, a single fibrous carrier is laminated to the film. In embodiments in which the film has side-by-side elastic and relatively inelastic segments and has been stretched in the machine direction beyond the point of plastic deformation, an extensible laminate having a fibrous carrier on one side and the shirred texture of the relaxed film on the other can be provided. The non-laminated surface can be non-tacky and soft to the touch if soft-feeling resins are used to make the film. In yet another embodiment, a single fibrous carrier is laminated to the films disclosed herein by any of the above-mentioned lamination processes where the films are colored, multi-colored and/or contain a print pattern. The films disclosed herein can be colored by the addition of pigments and/or dyes to one or more segments and layers. A print pattern can be added to the films disclosed herein using a variety of known printing processes.

In some embodiments of laminates disclosed herein, the film according to the present disclosure is joined to a fibrous web carrier using surface bonding or loft-retaining bonding techniques. The term “surface-bonded” when referring to the bonding of fibrous materials means that parts of fiber surfaces of at least portions of fibers are melt-bonded to a surface of the film in such a manner as to substantially preserve the original (pre-bonded) shape of the film surface, and to substantially preserve at least some portions of the film surface in an exposed condition, in the surface-bonded area. Quantitatively, surface-bonded fibers may be distinguished from embedded fibers in that at least about 65% of the surface area of the surface-bonded fiber is visible above the film surface in the bonded portion of the fiber. Inspection from more than one angle may be necessary to visualize the entirety of the surface area of the fiber. The term “loft-retaining bond” when referring to the bonding of fibrous materials means a bonded fibrous material comprises a loft that is at least 80% of the loft exhibited by the material prior to, or in the absence of, the bonding process. The loft of a fibrous material as used herein is the ratio of the total volume occupied by the web (including fibers as well as interstitial spaces of the material that are not occupied by fibers) to the volume occupied by the material of the fibers alone. If only a portion of a fibrous web has the film surface bonded thereto, the retained loft can be easily ascertained by comparing the loft of the fibrous web in the bonded area to that of the web in an unbonded area. It may be convenient in some circumstances to compare the loft of the bonded web to that of a sample of the same web before being bonded, for example, if the entirety of fibrous web has the film surface bonded thereto. In some of these embodiments, the joining comprises impinging heated gaseous fluid (e.g., ambient air, dehumidified air, nitrogen, an inert gas, or other gas mixture) onto a first surface of the fibrous web carrier while it is moving; impinging heated fluid onto the film surface while the continuous web is moving; and contacting the first surface of the fibrous web with the film surface so that the first surface of the fibrous web is melt-bonded (e.g., surface-bonded or bonded with a loft-retaining bond) to the film surface. Impinging heated gaseous fluid onto the first surface of the fibrous web and impinging heated gaseous fluid on the film surface may be carried out sequentially or simultaneously. Further methods and apparatus for joining a continuous web to a fibrous carrier web using heated gaseous fluid may be found in U.S. Pat. Appl. Pub. Nos. 2011/0151171 (Biegler et al.) and 2011/0147475 (Biegler et al.).

In some embodiments of the laminates according to the present disclosure, the carrier is a fibrous web activated by mechanical activation. Mechanical activation processes include stretching with diverging disks or incremental stretching methods such as ring-rolling, structural elastic film processing (SELFing), which may be differential or profiled, in which not all material is strained in the direction of stretching, and other means of incrementally stretching webs as known in the art. An example of a suitable mechanical activation process is the ring-rolling process, described in U.S. Pat. No. 5,366,782 (Curro). Specifically, a ring-rolling apparatus includes opposing rolls having intermeshing teeth that incrementally stretch and thereby plastically deform the fibrous web or a portion thereof forming the outer cover, thereby rendering the outer cover stretchable in the ring-rolled regions. Activation performed in a single direction (for example the cross direction) yields an outer cover that is uniaxially stretchable. Activation performed in two directions (for example the machine and cross directions or any two other directions maintaining symmetry around the outer cover centerline) yields an outer cover that is biaxially stretchable.

In some embodiments of the laminates according to the present disclosure, where the laminate includes a film disclosed herein in any of the aforementioned embodiments and an incrementally activated fibrous web, the distance between the midpoints between two first segments separated by one second segment is smaller than the pitch of the activation of the fibrous web. Activation pitch of the incrementally activated fibrous web is defined as the distance between the midpoints of two adjacent areas of higher deformation the fibrous web. Areas of higher deformation may be observed as areas of higher breakage, thinning, or higher elongation in the fibrous web. In some embodiments, areas of higher deformation may be observed as areas of a greater degree of shirring of the fibrous web. The activation pitch is typically equivalent to the pitch of the intermeshing surfaces in the apparatus used for incremental stretching. The pitch of the intermeshing surfaces is defined as the distance between two peaks of one of the intermeshing surfaces separated by one valley. The peaks can be defined as the apexes of outward pointing ridges of corrugated rolls (e.g., as described in U.S. Pat. No. 5,366,782 (Curro)) when such apparatuses are used. The peaks can also be defined as the peripheral surfaces (or center portion thereof) of discs used for incremental stretching such as those shown, for example, in U.S. Pat. No. 4,087,226 (Mercer). In other incremental stretching apparatuses, the peaks of one of the intermeshing surfaces would be readily identifiable to a person skilled in the art. In some embodiments of incrementally activated laminates according to the present disclosure, advantageously the first segments of the film, which include a first polymeric composition that is relatively less elastic than the elastic polymeric composition, are not plastically deformed in the laminate. Plastic deformation of the first segments can occur when the distance between the midpoints of two first segments separated by one second segment is larger than the activation pitch since the first segments can bridge between two peaks on one of the intermeshing surfaces. The plastically deformed regions can appear non-uniform resulting in a less aesthetically pleasing laminate, or the plastic deformation can result in breakage. In contrast, in embodiments of the laminate disclosed herein in which the distance between the midpoints between two first segments separated by one second segment is smaller than the pitch of the activation, the position and size of the first and second segments allow the second segments to stretch during incremental stretching of the laminate to take up the activation displacement without plastically deforming the first segments.

In some embodiments of the laminates according to the present disclosure, one or more zones of the carrier or the entire carrier may comprise one or more elastically extensible materials extending in at least one direction when a force is applied and returning to approximately their original dimension after the force is removed. In some embodiments, the extensible carrier is a nonwoven web that can be made by any of the nonwoven processes described above. The fibers for the nonwoven web may be made from elastic polymers, for example, any of those described above in connection with the second segments of the film disclosed herein. In some embodiments, the carrier may be extensible but inelastic. In other words, the carrier may have an elongation of at least 5, 10, 15, 20, 25, 30, 40, or 50 percent but may not recover to a large extent from the elongation (e.g., up to 40, 25, 20, 10 or 5 percent recovery). Suitable extensible carriers may include nonwovens (e.g., spunbond, spunbond meltblown spunbond, spunlace, or carded nonwovens). In some embodiments, the nonwoven may be a high elongation carded nonwoven (e.g., HEC). In some embodiments, the carrier may form pleats after it is extended. In some embodiments, the carrier is not pleated.

In some embodiments in which the laminate includes a fibrous web (e.g., a nonwoven web) that is extensible, a film or film article disclosed herein can be selected such that it has a relative low force to initially stretch the film. As described above, such a film can have, for example, second and optionally third layers in the second segments that are made from a softer, lower modulus material than the first segments and can have a geometry in which the thicknesses of the first and second segments are similar (e.g., within about 20%, 10%, or 5%). In these embodiments, the laminates may be considered not to require “activation”, and the ease of initially stretching the laminate would be apparent to the user.

Laminates of an extensible fibrous web and a film according to the present disclosure can advantageously be made by bonding under pressure discontinuously at discrete bond locations. The bonding can be carried out by a patterned embossing roll in which the pattern (that is, raised area) of the embossing roll provides up to about 30%, 25%, or 20% of the surface of the embossing roll. It is possible, but not required, that the pattern may be aligned with at least some of the first segments of the film. We have unexpectedly found that patterned bonding can be carried out in a nip at a temperature of up to 60° C., 55° C., 50° C., 40° C., 30° C., or even 25° C. using a pressure of at least one megapascal (MPa) (in some embodiments, 1.1, 1.2, 1.3, or 1.35 MPa).

If desired, lamination of the film according to the present disclosure to one or two fibrous carriers can be carried out such that certain zones are subjected to high heat and high pressure sufficient to create a non-stretchable zone in the laminate.

After laminates according to the present disclosure are prepared according to any of the methods described above, the laminate can be stored in roll form for incorporation into an article (e.g., those described below) in a separate process. In embodiments in which the film is stretched in at least one direction during lamination, the laminate can be stored in roll form in the stretched state and recovered at a later time. It is also possible to combine the method of making a laminate with a downline process of manufacturing an article. In embodiments in which the film is stretched in at least one direction during lamination, the laminate may be maintained in a stretched state and incorporated into an article in a downline process before allowing the web laminate to recover.

In some embodiments of the laminates disclosed herein, wherein the carrier is an elastic or extensible fibrous web, a tensile elongation at maximum load of the film is up to 250 percent of the tensile elongation at maximum load of the extensible fibrous web. In embodiments in which the film undergoes plastic deformation before breaking, the tensile elongation at maximum load of the film is the elongation at the point where the film begins to undergo plastic deformation. This extension is readily recognizable as a shoulder in a stress strain curve. In embodiments in which the film does not undergo plastic deformation before breaking, the tensile elongation at maximum load is the tensile elongation at break. The tensile elongation at maximum load of the fibrous web is generally the tensile elongation at break. In some embodiments, a tensile elongation at maximum load of the film is in a range from 25 percent to 250 percent, 50 percent to 225 percent, 75 percent to 200 percent, or 75 percent to 150 percent of the tensile elongation at maximum load of the extensible fibrous web. It is useful in laminates disclosed herein for the tensile elongation at maximum load of the film and the fibrous web to be comparable. In these laminates, there is not a large amount of unused elasticity in the film. For example, if an elastic film made completely of elastic polymers as described above has tensile elongation at maximum load of 800%, but an extensible fibrous web to which it is bonded only has a tensile elongation of about 200%, there is a large amount of elasticity in the film that is unused. Since more elastic polymers are typically more expensive than less elastic polymers, the unused elasticity translates to unnecessary expense. In the laminates according to the present disclosure, the first and second segments in the film allow for a lower amount of elastic polymers to be used while maintaining elongations that are comparable to extensible fibrous webs. On the other hand, the distribution of first and second segments across the film allow for more uniform extension than, for example, if only one segment of elasticity was used in the film. This distribution of first and second segments better utilizes the extensible potential of the extensible fibrous web. Furthermore, when the tensile elongation of the extensible fibrous web and the film are this similar, delamination of the extensible fibrous web and the film is less likely to occur than when, for example, the elastic film is much more extensible than the fibrous web.

In some embodiments of the laminates disclosed herein, a recoverable elongation of the laminate is at least 50% of the recoverable elongation of a comparative film after elongation of 100%. The laminate may be made from an extensible fibrous web, or the laminate may be incrementally activated as described above. The recoverable elongation can be understood to be the maximum elongation that provides the film or laminate with a permanent set of up to 20%, in some embodiments, up to 15% or 10%. The comparative film is the same as the film comprising first and second segments except that it is not laminated to a carrier. The comparative film may be a film that is removed from the laminate, for example, by submerging the laminate in liquid nitrogen and peeling apart the carrier and the film. Or the comparative film may be a sample made identically to the film comprising first and second segments but never laminated to a carrier. In some embodiments, a recoverable elongation of the laminate is at least 75%, 80%, 85%, 90% or 95% of the recoverable elongation of a comparative film at after elongation of 100%. Again, in any of these embodiments, there is not a large amount of unused elasticity in the elastic film. Also, in embodiments in which the carrier is an extensible fibrous web, the distribution of first and second segments better utilizes the recoverable elongation of the extensible fibrous web as described above. Also, where the comparative film is a sample made identically to the film comprising first and second segments but never laminated to an extensible fibrous web and subsequently incrementally stretched, when the recoverable elongation of the laminate is at least 50% (in some embodiments, 75%, 80%, 85%, 90%, or 95%) of the recoverable elongation of a comparative film after elongation of 100%, it is an indication that the incremental stretching did not plastically deform the first segments of the film.

Films disclosed herein have a variety of uses, including wound care and other medical applications (e.g., elastic bandage-like material, surface layer for surgical drapes and gowns, and cast padding), booties, tapes (including for medical applications), and absorbent articles (e.g., diapers, training pants, adult incontinence devices, and feminine hygiene products).

In absorbent articles, the film according to the present disclosure may be useful as a layer(s) within the articles and/or as part of an attachment system for the articles or elastic components. In some embodiments, a non-extensible region attached to the extensible region of the film can be used to attach the film article to the absorbent article or provide a fingerlift. In some embodiments, the non-extensible region can be formed with molded hooks to provide attachment to a loop. However, in some embodiments, the first segments or segments made from a relatively less elastic polymeric composition are not formed with male fastening elements (e.g., hooks) or upstanding posts or may not be formed with surface structure in general. Examples of disposable absorbent articles comprising films according to and/or made according to the present disclosure include disposable absorbent garments such as infant diapers or training pants, products for adult incontinence, and feminine hygiene products (e.g., sanitary napkins and panty liners). A typical disposable absorbent garment of this type is formed as a composite structure including an absorbent assembly (including, e.g., cellulosic fluff pulp, tissue layers, highly absorbent polymers (so called superabsorbents), absorbent foam materials, or absorbent nonwoven materials) disposed between a liquid permeable bodyside liner (e.g., nonwoven layers, porous foams, apertured plastic films) and a liquid impermeable outer cover (e.g, a thin plastic film, a nonwoven coated with a liquid impervious material, a hydrophobic nonwoven material which resists liquid penetration, or laminates of plastic films and nonwoven materials). These components can be combined with films disclosed herein and other materials and features such as further elastic components or containment structures to form the absorbent article.

In some embodiments, the film according to the present disclosure may be laminated to a fibrous (e.g., nonwoven) web. in some of these embodiments, the resulting laminate may be a fastening tab, for example, for an absorbent article. In some embodiments, the resulting laminate may be an extensible ear, for example, for an absorbent article. In some of these embodiments, the laminate may be in the shape of a trapezium.

### Some Embodiments of the Disclosure

In a first embodiment, the present disclosure provides a film comprising first and second segments arranged along the film's width direction, wherein the second segments are more elastic than the first segments, wherein a force required to stretch the second segments is less than a force required to stretch the first segments, wherein at least some of the first segments comprise apertures through their thicknesses, and wherein a percentage of area of the first segments occupied by the apertures is greater than a percentage of area occupied by any apertures that may extend through the second segments.

In a second embodiment, the present disclosure provides the film of the first embodiment, wherein the percentage of area of the first segments occupied by the apertures is at least 10 times greater than the percentage of area of the second segments occupied by apertures.

In a third embodiment, the present disclosure provides the film of the first or second embodiment, wherein the percentage of area of the second segments occupied by apertures is not more than one percent.

In a fourth embodiment, the present disclosure provides the film of any one of the first to third embodiments, wherein the second segments do not have apertures therethrough.

In a fifth embodiment, the present disclosure provides the film of any one of the first to fourth embodiments, wherein the first and second segments are alternating side-by-side stripes comprising a first polymeric composition and an elastic polymeric composition, respectively, and wherein the elastic polymeric composition is more elastic than the first polymeric composition.

In a sixth embodiment, the present disclosure provides the film of any one of the first to fifth embodiments, wherein the film comprises a skin layer that extends over at least portions of both the first and second segments.

In a seventh embodiment, the present disclosure provides the film of any one of the first to fifth embodiments, wherein at least some of the first segments or second segments are layered segments comprising first and second layers in the film's thickness direction, and wherein the first and second layers have different polymeric compositions.

In an eighth embodiment, the present disclosure provides the film of any one of the first to fourth embodiments, wherein the first segments comprise a first polymeric composition, and wherein the second segments comprise strands of an elastic polymeric composition that is more elastic than the first polymeric composition embedded in a matrix of the first polymeric composition that is continuous with the first segments.

In a ninth embodiment, the present disclosure provides the film of any one of the first to fifth or seventh embodiments, wherein the first segments comprise a first polymeric composition, wherein the second segments are strands comprising a core and a sheath, wherein the core comprises an elastic composition and is more elastic than the sheath and more elastic than the first polymeric composition.

In a tenth embodiment, the present disclosure provides the film of any one of the first to ninth embodiments, wherein the film is a multi-layer laminate comprising a layer of an elastic polymeric composition and at least one layer of the first polymeric composition, wherein the film is incrementally stretched to make the second segments more elastic than the first segments.

In an eleventh embodiment, the present disclosure provides the film of any one of the first to ninth embodiments, wherein the first segments absorb light at a selected wavelength to a greater extent than the second segments.

In a twelfth embodiment, the present disclosure provides the film of the eleventh embodiment, wherein the second segments transmit the light at the selected wavelength, or wherein the second segments comprise an elastic polymeric composition comprising an additive that reflects light at the selected wavelength.

In a thirteenth embodiment, the present disclosure provides the film of any one of the first to twelfth embodiment, wherein the first segments comprise a first polymeric composition that comprises at least one of an ultraviolet light absorbing additive, cavitating agent, dye, or pigment.

In a fourteenth embodiment, the present disclosure provides the film of any one of the first to thirteenth embodiments, wherein the first segments comprise a first polymeric composition comprising at least one of titanium dioxide or calcium carbonate.

In a fifteenth embodiment, the present disclosure provides the film of any one of the first to fourteenth embodiments, wherein the first segments are plastically deformed.

In a sixteenth embodiment, the present disclosure provides the film of any one of the first to fifteenth embodiments, wherein the first segments further comprise microvoids.

In a seventeenth embodiment, the present disclosure provides the film of any one of the first to sixteenth embodiments, wherein when the film has a first moisture vapor transmission rate before stretching and a second moisture vapor transmission rate while stretching to 75% elongation, and wherein the second moisture vapor transmission rate is less than 50% greater than the first moisture vapor transmission rate.

In an eighteenth embodiment, the present disclosure provides the film of any one of the first to seventeenth embodiments, wherein the first segments make up a higher volume percentage of the film than the second segments.

In a nineteenth embodiment, the present disclosure provides the film of any one of the first to eighteenth embodiments, wherein the film has an elastic recovery of at least 40 percent.

In a twentieth embodiment, the present disclosure provides the film of any one of the first to nineteenth embodiments, wherein the first and second segments each have a length, width, and height, wherein the length is the longest dimension and the thickness is the smallest dimension, and width of each of the first and second segments is up to five millimeters.

In a twenty-first embodiment, the present disclosure provides a laminate comprising the film of any one of the first to twentieth embodiments joined to a fibrous carrier.

In a twenty-second embodiment, the present disclosure provides an absorbent article comprising the film of any one of the first to twentieth embodiments or the laminate of the twenty-first embodiment.

In a twenty-third embodiment, the present disclosure provides a method of making a film according to any one of the first to twentieth embodiments, the method comprising:

providing the film comprising first and second segments arranged along the film's width direction, wherein the second segments are more elastic than the first segments, and wherein the force required to stretch the second segments is less than the force required to stretch the first segments; and

forming apertures in at least some of the first segments so that a percentage of area of the first segments occupied by the apertures is greater than a percentage of area occupied by any apertures that may extend through the second segments.

In a twenty-fourth embodiment, the present disclosure provides the method of the twenty-third embodiment, wherein apertures are not formed through the second segments.

In a twenty-fifth embodiment, the present disclosure provides the method of the twenty-third or twenty-fourth embodiment, wherein the apertures are formed in the first segments using a laser. The laser operates at a wavelength in a range from 180 nanometers to one millimeter.

In a twenty-sixth embodiment, the present disclosure provides the method of the twenty-fifth embodiment, wherein the laser is an ultraviolet laser having a wavelength in a range from 180 nanometers to 355 nanometers.

In a twenty-seventh embodiment, the present disclosure provides the method of the twenty-fifth embodiment, wherein the laser is a carbon dioxide laser having a wavelength in a range from 9 micrometers to 11 micrometers.

In a twenty-eighth embodiment, the present disclosure provides the method of the twenty-fifth embodiment, wherein the laser has a wavelength in a range from 800 nanometers to one micrometer.

In a twenty-ninth embodiment, the present disclosure provides the method of any one of the twenty-fifth to twenty-eighth embodiments, wherein the film is part of a multilayer construction, and wherein the laser is focused the film within the multilayer construction.

In a thirtieth embodiment, the present disclosure provides the method of the twenty-ninth embodiment, wherein a fibrous layer is positioned between the laser and the film.

In a thirty-first embodiment, the present disclosure provides the method of any one of the twenty-third to thirtieth embodiments, further comprising laminating the film to a fibrous substrate before forming the apertures.

In a thirty-second embodiment, the present disclosure provides the method of any one of the twenty-fifth to thirty-first embodiments, wherein forming the apertures comprises pulsing the laser.

In a thirty-third embodiment, the present disclosure provides the method of any one of the twenty-twenty-fifth to thirty-second embodiments, wherein the first segments absorb the laser's light to a greater extent than the second segments, and wherein the laser is not aligned with the first segments.

In a thirty-fourth embodiment, the present disclosure provides the method of the thirty-third embodiment, wherein forming the apertures comprises exposing the film to the a laser pattern capable of exposing the second segments to the selected wavelength, but wherein the second segments have an insufficient absorbance of the laser's light to form apertures therethrough.

In a thirty-fifth embodiment, the present disclosure provides the method of the twenty-third or twenty-fourth embodiment, wherein the apertures are formed in the first segments using heated needles, die cutting, or vacuum forming.

In a thirty-sixth embodiment, the present disclosure provides the method of any one of the twenty-third to thirty-fifth embodiments, further comprising stretching the film to plastically deform the first segments before forming the apertures.

In any of the above embodiments, across at least a portion of the film's width the first and second segments can alternate.

### EXAMPLES

In order that this disclosure can be more fully understood, the following examples are set forth. It should be understood that these examples are for illustrative purposes only, and are not to be construed as limiting this disclosure in any manner. All parts and percentages are by weight unless otherwise indicated.

The partially hydrogenated styrene triblock copolymer obtained under the trade designation “KRATON MD6843” used in some of the Examples, below, was analyzed by nuclear magnetic resonance (NMR) spectroscopy in solutions of unknown concentration in deuterated chloroform and deuterated 1,1,2,2-tetrachloroethane (TCE) using a 600 MHz NMR spectrometer obtained from Varian (Palo Alto, Calif.) under the trade designation “INOVA”. The spectrometer was equipped with a conventional room temperature inverse probe head. One-dimensional ¹H-NMR and ¹³C-NMR spectra were collected followed by ¹H/¹³C-NMR gradient heteronuclear single quantum coherence (gHSQC) and homo-nuclear two-dimensional NMR to confirm spectral assignments. The residual proto-solvent resonances were used as secondary chemical shift references in the proton dimension. All of the NMR data were collected with the samples held at 25° C. After analysis, it was concluded that hydrogenated butadiene moieties dominate the mid-block of the triblock copolymer, but minor amounts hydrogenated isoprene moieties were found in the mid-block as well. Integration of the ¹H-NMR data suggested that polystyrene made up about 24 mole percent (36 weight percent) of the triblock copolymer.

The weight average and number average molecular weights of the partially hydrogenated styrene-butadiene-styrene copolymer obtained under the trade designation “KRATON MD6843” were determined by comparison to linear polystyrene polymer standards using gel permeation chromatography (GPC). The GPC measurements were carried out using a combined autosampler, controller and pump (Alliance Model 2695 Separations Module and Empower 3 data acquisition software obtained from Waters Corporation, Milford, Mass.) controlled to 40° C. and using three 250 millimeter (mm) by 10 mm linear columns of divinylbenzene polymer particles (obtained from Jordi Associates, Inc., Bellingham, Mass., under the trade designation “Jordi GEL”) with two columns of pore sizes Mixed Bed and one column of 500 angstroms. A differential refractive index (RI) detector (Waters Model 2414, obtained from Waters Corporation) was used at 40° C. A 20-milligram (mg) sample of the “MD6843” copolymer was diluted with 10 mL of tetrahydrofuran (inhibited with 250 ppm of BHT) into a 20-mL glass vial, capped with a polyethylene-lined cap and slowly rotated until dissolved. The sample solution was filtered through a 0.45-micrometer pore size 13-mm diameter polytetrafluoroethylene (PTFE) syringe filter into a 1.8-mL glass autosampler vial capped with a PTFE/silicone septum cap and placed in the autosampler along with two vials of polystyrene standards and a vial of control solution. At the beginning of the analysis, the tetrahydrofuran (inhibited with 250 ppm of BHT) mobile phase was incrementally brought to a flow rate of 1 mL/minute over six minutes, the reference side of the RI detector was flushed for 10 minutes and was filled with fresh tetrahydrofuran from the mobile phase. The sample was analyzed after 48 minutes of column equilibration, two 55-microliters injections of polystyrene standards and one 99-microliters injection of a control sample, each of 48 minutes duration. A sample volume of 99 microliters was injected onto the column bank and data collected by the Empower 3 software. Molecular weight calibration was performed using 15 narrow dispersity polystyrene standards (obtained from Polymer Standards Service-USA, Inc) with peak molecular weights ranging from 2.13×10⁶ grams per mole to 266 grams per mole. The molecular weight distribution calculations were performed using Empower 3 GPC software using a third order polynomial fit and yielded an R value greater than 0.9995 for the molecular weight calibration curve. Duplicate injections were run and averaged. The weight average molecular weight of the triblock copolymer was found to be 181,600 grams per mole, and its number average molecular weight was found to be 159,000 grams per mole.

### Moisture Vapor Transmission Rate (MVTR)

MVTR was measured using a stainless steel chamber containing calcium chloride. A sample of the film was placed over the top of the container, which had an opening having a radius of 30 mm, and threaded posts for accepting a rubber washer and stainless steel washer. A rubber washer and stainless steel washer each having three holes aligned with the posts were then sequentially placed over the film, and the assembly was tightening using wing nuts. The area of the exposed film was 0.002826 m². The assembly was prepared in a room having a temperature of 20° C. and 50% humidity and weighed to provide the initial weight (W1). The assembly was then placed in an oven and heated at 50° C. and 75% humidity for five hours. The assembly was equilibrated for 30 minutes at 20° C. and 50% humidity and then weighed to provide the final weight (W2).

The MVTR in grams of water vapor transmitted per square meter (m²) of sample area per 24 hours was then calculated using the following formula:

MVTR=(W2−W1) g×(24 hours)/0.002826 m²×5 hours

When the MVTR was measured under tension, the method described above was repeated while the film was stretched to about 80% elongation and taped to the sides of the chamber.

### Films 1 and 2

A 6-inch (150-mm) co-extrusion die, Die 1, with three cavities, as generally depicted in FIGS. 10A to 16 was used for Examples 1 to 7 and Illustrative Example 1. Die 1 was assembled with a shim repeating pattern shown in Table 1. The shim designation (e.g., 1500, 1600, 1700, 1800, or 1900) refers to the shims depicted in FIGS. 10A through 14A. The shim thickness refers to the narrowest dimension of the shim. The Die Structural Element describes to which portion of the die according to the present disclosure the shim contributes. The Film Structural Element refers to the portion of the film according to the present disclosure extruded from the indicated shim. The designations 2× 1600 and 4× 1500 means that 2 of shims 1600 were placed next to each other and 4 of shims 1500 were placed next to each other. The sequence shown in Table 1 was repeated several times to achieve a width of 6 inches (150 mm). The dispensing openings of the shims were aligned in a collinear arrangement as shown in FIG. 15 to provide a dispensing slot with a height of 0.030 inches (760 micrometers). Shim 1500 had a land length of 0.100 inch (2.54 mm). Shims 1900 and 1800 had a land length of 0.070 inch (1.78 mm), and shims 1700 and 1600 had a land length of 0.080 inch (2.03 mm). The shim assembly was aligned with an alignment key and compressed between two end blocks using four ½ inch (12.7 mm) bolts. Different polymeric compositions were used for Film 1 and Film 2 as described below.

TABLE 1
Die Description

| | | | |
|---|---|---|---|
| | Die Structural | Thickness | Film Structural |
| Shim | Element | (micrometers) | Element Provided |

Die 1

| | | | |
|---|---|---|---|
| 1900 | spacer | 51 | |
| 1800 | 3^{rd} fluid | 102 | 3^{rd} polymeric |
| | passageway | | composition, 2^{nd} and |
| | | | 3^{rd} layers of 2^{nd} segment |
| 1700 | pathway from 3^{rd} | 51 | 3^{rd} polymeric |
| | to 2^{nd} passageway | | composition, 2^{nd} and |
| | | | 3^{rd} layers of 2^{nd} segment |
| 2 × 1600 | 2^{nd} fluid | 612 | elastic polymeric |
| | passageway | | composition, 1^{st} layer of |
| | | | 2^{nd} segment |
| 1700 | pathway from 3^{rd} | 51 | 3^{rd} polymeric |
| | to 2^{nd} passageway | | composition, 2^{nd} and |
| | | | 3^{rd} layers of 2^{nd} segment |
| 1800 | 3^{rd} fluid | 102 | 3^{rd} polymeric |
| | passageway | | composition, 2^{nd} and |
| | | | 3^{rd} layers of 2^{nd} segment |
| 1900 | spacer | 51 | |
| 4 × 1500 | 1st fluid | 1218 | 1^{st} polymeric |
| | passageway | | composition of |
| | | | 1^{st} segment |

The inlet fittings on the two end blocks were each connected to conventional single-screw extruders. Compositions of the polymer compositions feeding each extruder and flow rates for each of Films 1 and 2 are shown in Table 2. Extruder 1 feeding the first cavity leading to the first fluid passageways described in Table 1, above, was loaded with the first polymeric composition. Extruder 2 fed the second cavity leading to the second fluid passageways, and Extruder 3 fed the third cavity leading to the third fluid passageways described in Table 1, above. Extruder 2 was loaded with the elastic polymeric composition, and Extruder 3 was loaded with the third polymeric composition. The first, elastic, and third polymeric compositions for each of Films 1 and 2 are shown in Table 2.

For Film 1, the first polymeric composition fed from Extruder 1 was a polypropylene impact copolymer obtained from Total Petrochemicals, Houston, Tex., under the trade designation “TOTAL POLYPROPYLENE 5571” that included 3% by weight of a titanium dioxide masterbatch obtained from Clariant, Minneapolis, Minn. The elastic polymeric composition fed from Extruder 2 was a mixture of 81% by weight of a styrene triblock copolymer with hydrogenated midblock obtained from Kraton Polymers, Houston, Tex., under the trade designation “KRATON MD6843” and 19% of a hydrogenated dicyclopentadiene hydrocarbon resin obtained from Kolon Industries, South Korea, under the trade designation “SUKOREZ SU-210”. The third polymeric composition fed from Extruder 3 was a mixture of a polypropylene random copolymer obtained from Total Petrochemicals under the trade designation “TOTAL POLYPROPYLENE 8650” that included about 2% by weight of a red color concentrate in polypropylene obtained from Clariant.

For Film 2, the first polymeric composition fed from Extruder 1 was a 50:50 blend of polypropylene impact copolymer obtained from Total Petrochemicals under the trade designation “TOTAL POLYPROPYLENE 5571” and a propylene based elastomer obtained from ExxonMobil, Houston, Tex., under the trade designation “VISTAMAXX 3980” that included 3% by weight of a titanium dioxide masterbatch obtained from Clariant. The elastic polymeric composition fed from Extruder 2 was a mixture of 75% by weight of a styrene triblock copolymer with hydrogenated midblock obtained from Kraton Polymers under the trade designation “KRATON MD6843” and 25% of a hydrogenated dicyclopentadiene hydrocarbon resin obtained from Kolon Industries under the trade designation “SUKOREZ SU-210”. The third polymeric composition fed from Extruder 3 was a mixture of a polypropylene random copolymer obtained from Total Petrochemicals under the trade designation “TOTAL POLYPROPYLENE 8650” that included about 3% by weight of a blue color concentrate in polypropylene obtained from Clariant.

All extruders were set to 218° C. The polymeric compositions were extruded from the die at a rate of 1.2 meters per minute (m/min) and then drawn at the rate shown in Table 2, below. A chill roll was positioned adjacent to the dispensing slot of the co-extrusion die to receive the extruded material.

TABLE 2
Example Compositions and Extrusion Conditions

| | | | | | | | | Line |
|---|---|---|---|---|---|---|---|---|
| | | Extruder #3 | | Extruder #2 | | Extruder #1 | | Speed |
| Film | Die | Material | [kg/hr] | Material | [kg/hr] | Material | [kg/hr] | (m/min) |
| 1 | 1 | “8650” pp | 0.22 | 81% “MD6843”/ | 2.4 | “5571” pp | 4.9 | 19.8 |
| | | | | 19% “SU-210” | | | | |
| 2 | 1 | “8650” pp | 2.5 | 75% “MD6843”/ | 10.8 | 50% | 28.4 | 41.2 |
| | | | | 25% “SU-210” | | “5571” pp | | |
| | | | | | | 50% | | |
| | | | | | | “3980” | | |

### Example 1

A 100 cm by 200 cm area of Film 1 subjected to laser drilling. The sample was exposed to laser radiation at 355 nanometer wavelength from a 3-watt UV laser, “AVIA 355-3000” from Coherent Inc., Santa Clara, Calif. The laser energy was directed across the sample by a scanner Model HPLK 1330 from GSI Group, Billerica, Mass. The sample was positioned at a distance of approximately 300 mm from the scanner housing, which was in the focal plane of the scanner system. In the plane of the sample, the spot size for the laser beam was determined to be approximately 50 micrometers in width with a nearly Gaussian profile. The laser pattern was a point cloud array (5 mm by 5 mm) with each point given a drill duration of 4 to 50 milliseconds with a typical exposure of 5 milliseconds. The jump rate was 6 m/s with a trigger pulse of 4 microseconds. The laser was used at 70% of current to give approximately 40 millijoules per pulse. Apertures having an average diameter of about 100 micrometers spaced about 5 mm apart were formed in the first segments only.

### Examples 2 and 3

Examples 2 and 3 were prepared using the method of Example 1 with the modification that for Example 2, a point cloud array 5 mm by 2.5 mm was used, and for Example 3, a cloud point array 5 mm by 1 mm was used. For Example 2, apertures having an average diameter of about 100 micrometers spaced about 2.5 mm apart were formed in the first segments only. For Example 3, apertures having an average diameter of about 100 micrometers spaced about 1 mm apart were formed in the first segments only.

A photomicrograph for a film prepared as described in Example 3 is shown in FIG. 30. As shown in FIG. 30, the titanium dioxide acts as an absorber of the UV radiation and results in a hole. The elastic segments transmit the UV radiation without being apertured. When the laser hits the boundary, a smaller aperture is formed as shown in FIG. 30.

Moisture vapor transmission rate was measured for Examples 1 to 3 using the test method described above. The MVTR was measured for the film when it was in a relaxed state and when it was stretched to about 80% elongation and held under tension. The percent difference between the MVTR in the relaxed state and under tension was calculated. The results are shown in Table 3, below.

TABLE 3

| Example | MVTR (relaxed) | MVTR (under tension) | Percent difference |
|---|---|---|---|
| 1 | 431 | 455 | 6 |
| 2 | 265 | 299 | 13 |
| 3 | 601 | 664 | 10 |

### Example 4

Example 4 was prepared using the method of Example 1 with the modification that a point cloud array of 0.8 mm by 0.8 mm was used, and the laser beam was pulsed for 1 millisecond at a frequency of approximately 10 kHz, providing about ten pulses per hole. Apertures having an average diameter of about 50 micrometers spaced about 0.8 mm apart were formed in the first segments only.

### Example 5

Example 5 was prepared using the method of Example 4 except that Film 2 was used instead of Film 1.

### Examples 6 and 7 and Illustrative Example 1

A 100 cm by 200 cm area of Film 1 subjected to laser drilling. The sample was exposed to laser radiation at 10.6 micron wavelength from a CO₂ laser, E-400 from Coherent, Inc. The laser energy was directed across the sample by the Model HPLK 1330 scanner. The sample was positioned at a distance of approximately 600 mm from the scanner housing (whereas the focal plane of the scanner system was located at approximately 560 mm from the scanner housing). In the plane of the sample, the spot size for the laser beam was determined to be approximately 220 micrometers in width with a nearly Gaussian profile. A column of points spaced from 0.5 mm to 15 mm was set with the laser set to drill mode.

For Illustrative Example 1, a paper overlay was placed over the sample, and the laser beam was used at 10% of Current (40 Watts) at a Galvo speed of approximately 4 m/sec. This resulted in apertures in both the first segments and second segments with a spacing between apertures of about 4.4 mm.

For Example 6, the laser was used at 4% of current (10 Watts), and the target film was aligned manually and indexed for each of the first segments to produce the row of apertures in the first segments only. The spacing between apertures in the first segments was 4.4 mm. Three apertures were measured and found to have diameters of 0.202 mm, 0.192 mm, and 0.186 mm. The width of the first segment was measured to be 1.994 mm, and the width of the elastic lanes was measured at 0.729 mm and 0.717 mm. When the sample was stretched to 82% elongation, three apertures were measured and found to have diameters of 0.191 mm, 0.206 mm, and 0.206 mm. The width of the first segment was measured to be 2.028 mm, and the width of the elastic lanes was measured at 2.908 mm and 2.953 mm.

For Example 7, the laser was used at 5% of current (20 Watts), and the target film was aligned manually and indexed for each of the first segments to produce the row of apertures in the first segments only. The spacing between apertures in the first segments was 4.4 mm. Three apertures were measured and found to have areas about 3 times larger than those of Example 6.

Moisture vapor transmission rate was measured for Examples 6 and 7 (Ex. 6 and 7) and Illustrative Example 1 (Ill. Ex. 1) using the test method described above. The MVTR was measured for the film when it was in a relaxed state and when stretched to about 80% elongation and held under tension. The percent difference between the MVTR in the relaxed state and under tension was calculated. The results are shown in Table 4, below.

TABLE 4

| Example | MVTR (relaxed) | MVTR (under tension) | Percent difference |
|---|---|---|---|
| III. Ex. 1 | 108 | 947 | 777 |
| Ex. 6 | 546 | 614 | 12 |
| Ex. 7 | 788 | 898 | 14 |

Foreseeable modifications and alterations of this disclosure will be apparent to those skilled in the art without departing from the scope and spirit of this invention. This invention should not be restricted to the embodiments that are set forth in this application for illustrative purposes.

1. A film comprising first and second segments arranged along the film's width direction, wherein the second segments are more elastic than the first segments, wherein a force required to stretch the second segments is less than a force required to stretch the first segments, wherein at least some of the first segments comprise apertures through their thicknesses, and wherein a percentage of area of the first segments occupied by the apertures is greater than a percentage of area occupied by any apertures that may extend through the second segments.

2. The film of claim 1, wherein the first and second segments are alternating side-by-side stripes comprising a first polymeric composition and an elastic polymeric composition, respectively, wherein the elastic polymeric composition is more elastic than the first polymeric composition.

3. The film of claim 1, wherein at least some of the first segments or second segments are layered segments comprising first and second layers in the film's thickness direction, and wherein the first and second layers have different polymeric compositions.

4. The film of claim 1, wherein the first segments comprise a first polymeric composition, wherein the second segments are strands comprising a core and a sheath, and wherein the core comprises an elastic composition and is more elastic than the sheath and more elastic than the first composition.

5. The film of claim 1, wherein the first segments comprise a first polymeric composition, and wherein the second segments comprise strands of an elastic polymeric composition that is more elastic than the first polymeric composition embedded in a matrix of the first polymeric composition that is continuous with the first segments.

6. The film of claim 1, wherein the film is a multi-layer laminate comprising a layer of an elastic polymeric composition and at least one layer of the first polymeric composition, wherein the film is incrementally stretched to make the second segments more elastic than the first segments.

7. The film of claim 1, wherein the first segments comprise a first polymeric composition that comprises at least one of an ultraviolet light absorbing additive, cavitating agent, dye, or pigment.

8. The film of claim 1, wherein the first segments further comprise microvoids.

9. The film of claim 1, wherein the first and second segments each have a length, width, and height, wherein the length is the longest dimension and the thickness is the smallest dimension, and width of each of the first and second segments is up to five millimeters.

10. A laminate comprising the film of claim 1 joined to a fibrous carrier.

11. An absorbent article comprising the film of claim 1.

12. A method of making a film according to claim 1, the method comprising:
providing the film comprising first and second segments arranged along the film's width direction, wherein the second segments are more elastic than the first segments, and wherein the force required to stretch the second segments is less than the force required to stretch the first segments; and
forming apertures in at least some of the first segments so that a percentage of area of the first segments occupied by the apertures is greater than a percentage of area occupied by any apertures that may extend through the second segments.

13. The method of claim 12, wherein apertures are not formed through the second segments.

14. The method of claim 12, further comprising stretching the film to plastically deform the first segments before forming the apertures.

15. The method of claim 12, wherein the apertures are formed in the first segments using a laser, heated needles, die cutting, or vacuum forming.

16. The film of claim 1, wherein the percentage of area of the first segments occupied by the apertures is at least 10 times greater than the percentage of area of the second segments occupied by apertures.

17. The film of claim 1, wherein the percentage of area of the second segments occupied by apertures is not more than one percent.

18. The film of claim 1, wherein the second segments do not have apertures therethrough.

19. The film of claim 1, wherein the first segments are plastically deformed.

20. The film of claim 1, wherein when the film has a first moisture vapor transmission rate before stretching and a second moisture vapor transmission rate while stretching to 75% elongation, and wherein the second moisture vapor transmission rate is less than 50% greater than the first moisture vapor transmission rate.
